(19) United States
(12) Patent Application Publication
(10) Pub. No.: US 2016/0267490 A1
(43) Pub. Date: Sep. 15, 2016

(54) System and Method for Detecting Non-Negligible Election Fraud

(71) Applicant: James Johnson, Burlingame, CA (US)

(72) Inventor: James Johnson, Burlingame, CA (US)

(21) Appl. No.: 14/885,481

(22) Filed: Oct. 16, 2015

Related U.S. Application Data
(63) Continuation of application No. 14/870,457, filed on Sep. 30, 2015, now abandoned.
(60) Provisional application No. 62/130,693, filed on Mar. 10, 2015.

(51) Int. Cl. G06Q 30/00; G06Q 50/26; G07C 13/00

(52) U.S. Cl. CPC G06Q 30/018; G07C 13/00; G06Q 50/26

(57) ABSTRACT

A computer-implemented method for detecting non-negligible election fraud using a computer program product that includes a fraud detection server comprising a processor and a database. The method may include the steps of receiving election results data, aggregating the election results data into a plurality of subsets, calculating a respective hypergeometric cumulative distribution function (CDF) score to define an outlier impact magnitude for each of the plurality of subsets, and ranking the plurality of subsets using the respective hypergeometric CDF score for each of the plurality of subsets. The resultant ranking may define an audit priority for each of the precincts involved in an election of interest. An election report including the audit priority may be displayed to an election stakeholder.

### RELATED APPLICATIONS

This application is a continuation and claims the benefit under 35 U.S.C. §119(e) of U.S. Non-Provisional patent application Ser. No. 14/870,457 filed on Sep. 30, 2015 and titled System and Method for Detecting Non-Negligible Election Fraud, which, in turn, claims the benefit of U.S. Provisional Patent Application Ser. No. 62/130,693 filed on Mar. 10, 2015 and titled System and Method for Detecting Election Fraud, the entire contents of each of which are incorporated herein by reference.

### FIELD OF THE INVENTION

The present invention relates to systems and methods for analyzing election results and, more specifically, for performing outlier analysis of election results to detect potential sources of election fraud.

### BACKGROUND OF THE INVENTION

In recent years, advances in computer science have spurred many election divisions and political parties in the United States to publish precinct-level election results, voter registration, and party affiliation information to the public. This information is often available online in machine-readable format. Occasionally, on the Internet and on other mass media, instances of election fraud are reported. Typically, these instances are detected on an ad hoc basis after accidental discovery, rather than as a result of a systematic statistical methodology that proactively identifies such instances of election fraud.

Like any other crime, election fraud cannot be prevented in all cases. A more reasonable goal is to recognize if prevailing fraud is negligible or, to the contrary, if such fraud is significant enough to alter the ranking among election choices in a particular election. Auditing of election results may be used to determine significance, which may prove to be useful in keeping election fraud magnitude under control to assure that the degree of fraud does not cause election choices' ranks swaps. While full audit of large-scale (e.g., statewide) election results is virtually impossible, some form of “random” audit may be useful to verify that no statewide non-negligible fraud exists. In addition to the random audit, a need exists to identify suspicious election choices, counties, precincts, and individual voters that require prioritized attention for a targeted audit.

The background information is provided to reveal information believed by the applicant to be of possible relevance to the present invention. No admission is necessarily intended, nor should be construed, that any of the preceding information constitutes prior art against the present invention.

### SUMMARY OF THE INVENTION

With the above in mind, the present invention relates to computer-implemented systems and methods for mining election results data (e.g., a data set) for unknown instances of non-negligible election fraud. The computer-implemented system may rank precincts based on election choices that exhibit the largest magnitude of detectable outliers. Data sets for a small number of counties may present clusters of outlier precincts. Even if non-negligible election fraud is disbursed throughout the state, such artificial intrusion into the data set may cause changes not only in the means (and medians) of vote percent, but also in skewness and outliers. Because multiple factors may cause outliers, detection of outliers in a small subset of counties and precincts is merely a cause for suspicion that may merit further audit and more attention in the future, but is not necessarily proof of the presence of fraud. The variety of methods described in this document may advantageously provide sufficiently convincing arguments to justify the conduct of an audit in particular precincts and for specific individual voters.

Accordingly, this invention is directed to a computationally-intensive method of analyzing aggregated but granular election results with the objective to detect abnormal, unusual, and suspicious subsets in results. These subsets may become likely candidates for a subsequent audit. The methods described herein may advantageously detect the most suspicious election choices, counties, and precincts. More specifically, the methods may illustrate the magnitude of detected anomalies, as well as their impact on the ranking among election choices. The results may advantageously be presented in an intuitive format that may be suitable for a non-technical audience. The method may be advantageously robust and flexible because it may analyze even limited or incomplete data sets. The method may advantageously produce more accurate results when more data is input to the analysis (e.g., data with more categories or more granularity).

The present invention provides a systematic method of detecting and reporting anomalies in election results of interest, as well as of estimating the magnitude of these anomalies, identifying their sources, and gauging their impact on the ranking among election choices. The invention may be used by the election divisions of states for non-random audit, by candidates for post-election litigation decisions, by the voting integrity groups to focus verification efforts, and by the general public for increasing awareness of and trust in the electoral process.

In one embodiment of the solution presented by this invention, precinct level election results may be preprocessed and collected. Hypergeometric and Normal distributions may be applied for their cumulative distribution functions. Precincts may be sorted based on this criterion. Multiple benchmarks may be used for outcome comparisons. Cumulative charts may be generated for these ordered sequences of precincts. Sets of bar charts may also be created that lead analysis of the most suspicious election choices, counties and precincts. Tables may be generated of the most suspicious precincts. The system thereafter may produce presentation slides illustrating the analysis results, or the outcome of the analysis may be provided in some other output medium. Optionally, evidence uncovered through analysis may be combined with other election fraud evidence which may have been observed and disclosed by other sources. The system according to the present invention then may conduct a comparison of the results which may, in turn, prompt a non-random audit of the election (in addition to the random one).

The use of Hypergeometric distribution may allow for identification of sources of potential election fraud in the full election results data set. The present invention also advantageously may offer multiple benchmarks or dimensions that may be combined and analyzed thereacross, as well as using generic and unique ways of presenting such results after such an analysis has been performed. Furthermore, the present invention also may provide results that are intuitive to general non-technical persons, and which results may suggest various actions that may need to be addressed upon verification of potential election fraud.

In a preferred embodiment, the invention may be embodied in a software implementation. Such an implementation may be executed using the computing hardware of any election entity (i.e., federal, state, or local officials), as well as by party caucus organizer. Such an implementation may also be web-based, and analysis results generated by use of the system may be readily disclosed to the public after the election of interest in real time. Furthermore, the present invention may advantageously allow for disclosure of partial results as various precincts close (e.g., display results of an analysis of whether or not election fraud occurred as each of the various precincts close). In instances where partial results are provided, upon the completion of a full election, full results may also be provided. Even partial (or incomplete) results may be considered as a time dependent “statistical population” from a specific territorial unit (e.g. state, county), but not necessarily as a “statistical sample” from the same territorial unit. The present invention also advantageously may allow for election results to be readily analyzed for future election analysis and also may allow for customizable interaction of subscribers.

### BRIEF DESCRIPTION OF THE DRAWINGS

The patent or application file contains at least one drawing executed in color. Copies of this patent or patent application publication with color drawings will be provided by the Office upon request and payment of the necessary fee.

FIG. 1 is a schematic block diagram of an Election Fraud Detection (EFD) system according to an embodiment of the present invention.

FIG. 2 is a diagram illustrating exemplary data structures of the EFD system depicted in FIG. 1.

FIG. 3 is a flow chart illustrating a method for election fraud detection according to an embodiment of the present invention.

FIG. 4 is a flow chart illustrating a method of analyzing a data set for outliers as used in connection with an EFD system according to an embodiment of the present invention.

FIG. 5 is a flow chart illustrating a method of creating a user account as used in connection with an EFD system according to an embodiment of the present invention.

FIG. 6 (Graph 1) is a graph illustrating Probability Density Function Histogram for Vote Percentages.

FIG. 7 (Graph 2.1) is a graph illustrating Normal PP-plot for Vote Percentages.

FIG. 8 (Graph 2.2) is a graph illustrating Zoomed Normal PP-plot for Vote Percentages.

FIG. 9 (Graph 3.1.1) is a graph illustrating Cumulative Vote Percent Chart for Election Choices.

FIG. 10 (Graph 3.1.2) is a graph illustrating Cumulative Vote Percent Convergence Chart for Election Choices.

FIG. 11 (Graph 3.2.1) is a graph illustrating Cumulative Tally Percent Chart for Counties.

FIG. 12 (Graph 3.2.2) is a graph illustrating Cumulative Tally Percent Convergence Chart for Counties.

FIG. 13 (Graph 4.1.1) is a graph illustrating Absolute Contribution Percent Bar Chart. Categories: Election Choices. Series: Statewide. Title: Statewide.

FIG. 14 (Graph 4.1.2) is a graph illustrating Absolute Contribution Percent Bar Chart. Categories: Counties. Series: Statewide. Title: Statewide.

FIG. 15 (Graph 4.2.1) is a graph illustrating Absolute Contribution Percent Bar Chart. Categories: Election Choices. Series: Head/Tail. Title: Statewide.

FIG. 16 (Graph 4.2.2) is a graph illustrating Absolute Contribution Percent Bar Chart. Categories: Head/Tail. Series: Election Choices. Title: Statewide.

FIG. 17 (Graph 4.3.1) is a graph illustrating Absolute Contribution Percent Bar Chart. Categories: Counties. Series: Head/Tail. Title: Statewide.

FIG. 18 (Graph 4.3.2) is a graph illustrating Absolute Contribution Percent Bar Chart. Categories: Head/Tail. Series: Counties. Title: Statewide.

FIG. 19 (Graph 4.4.1) is a graph illustrating Absolute Contribution Percent Bar Chart. Categories: Election Choices. Series: Countywide. Title: County.

FIG. 20 (Graph 4.4.2) is a graph illustrating Absolute Contribution Percent Bar Chart. Categories: Election Choices. Series: Head/Tail. Title: County.

FIG. 21 (Graph 5.1.1) is a graph illustrating Marginal Contribution Percent Bar Chart. Categories: Election Choices. Series: Head/Tail. Title: Statewide.

FIG. 22 (Graph 5.1.2) is a graph illustrating Marginal Contribution Percent Bar Chart. Categories: Counties. Series: Head/Tail. Title: Statewide.

FIG. 23 (Graph 5.1.3) is a graph illustrating Marginal Contribution Percent Bar Chart. Categories: Head/Tail. Series: Counties. Title: Statewide.

FIG. 24 (Graph 5.1.4) is a graph illustrating Marginal Contribution Percent Bar Chart. Categories: Election Choices. Series: Counties. Title: Statewide.

FIG. 25 (Graph 5.2.1) is a graph illustrating Marginal Contribution Percent Bar Chart. Categories: Election Choices. Series: Counties. Title: Head/Tail.

FIG. 26 (Graph 5.2.2) is a graph illustrating Marginal Contribution Percent Bar Chart. Categories: Counties. Series: Head/Tail. Title: Election Choices.

FIG. 27 (Graph 5.2.3) is a graph illustrating Marginal Contribution Percent Bar Chart. Categories: Head/Tail. Series: Counties. Title: Election Choices.

FIG. 28 (Graph 5.2.4) is a graph illustrating Marginal Contribution Percent Bar Chart. Categories: Election Choices. Series: Head/Tail. Title: Counties.

FIG. 29 (Table 1) is a table illustrating Tail of the Tail.

FIG. 30 (Table 2) is a table illustrating Tail of the Tail by Election Choice.

FIG. 31 (Table 3) is a table illustrating Tail of the Tail by County.

FIG. 32 is a block diagram illustrating a diagrammatic representation of a machine in the example form of a computer system according to an embodiment of the present invention.

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Those of ordinary skill in the art realize that the following descriptions of the embodiments of the present invention are illustrative and are not intended to be limiting in any way. Other embodiments of the present invention will readily suggest themselves to such skilled persons having the benefit of this disclosure. Like numbers refer to like elements throughout.

Although the following detailed description contains many specifics for the purposes of illustration, anyone of ordinary skill in the art will appreciate that many variations and alterations to the following details are within the scope of the invention. Accordingly, the following embodiments of the invention are set forth without any loss of generality to, and without imposing limitations upon, the claimed invention.

In this detailed description of the present invention, a person skilled in the art should note that directional terms, such as “above,” “below,” “upper,” “lower,” and other like terms are used for the convenience of the reader in reference to the drawings. Also, a person skilled in the art should notice this description may contain other terminology to convey position, orientation, and direction without departing from the principles of the present invention.

Furthermore, in this detailed description, a person skilled in the art should note that quantitative qualifying terms such as “generally,” “substantially,” “mostly,” and other terms are used, in general, to mean that the referred to object, characteristic, or quality constitutes a majority of the subject of the reference. The meaning of any of these terms is dependent upon the context within which it is used, and the meaning may be expressly modified.

An embodiment of the invention, as shown and described by the various figures and accompanying text, provides systems and methods for election results data analysis. For example, and without limitation, the systems and methods described herein may advantageously provide non-negligible election fraud detection support to the following classes of users:

Participants: Election candidates or political groups who lost an election, but suspect that the result of the election was altered by voting fraud of such a magnitude that it changed the ranking among the election choices. Election participants may use this analysis in their decision-making regarding litigation over the results, and filing of a lawsuit before statute-driven deadlines.

Officials: State election divisions desiring to perform not only random, but also targeted audit of suspicious election choices, counties, precincts, and individual voters. Limited resources may require that audit projects be prioritized by the degree of suspiciousness found.

Watchdogs: Media and/or voting Integrity non-profit groups desiring to re-allocate their focus and resources to those areas where the election fraud is very likely and, if found to be fraud, has a significant impact on the election results by changing the rank of election choices.

Public: Any citizen and/or stakeholder desiring transparency in election results. Democracy depends not only on the right to vote, but also on confidence that election results can be trusted and understood.

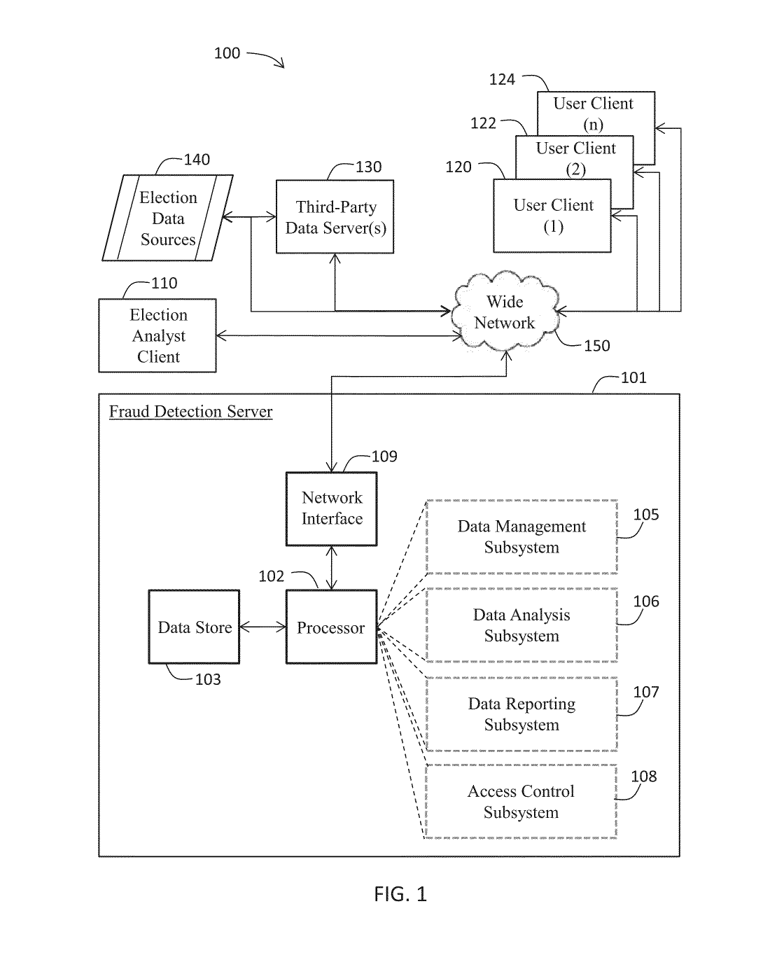

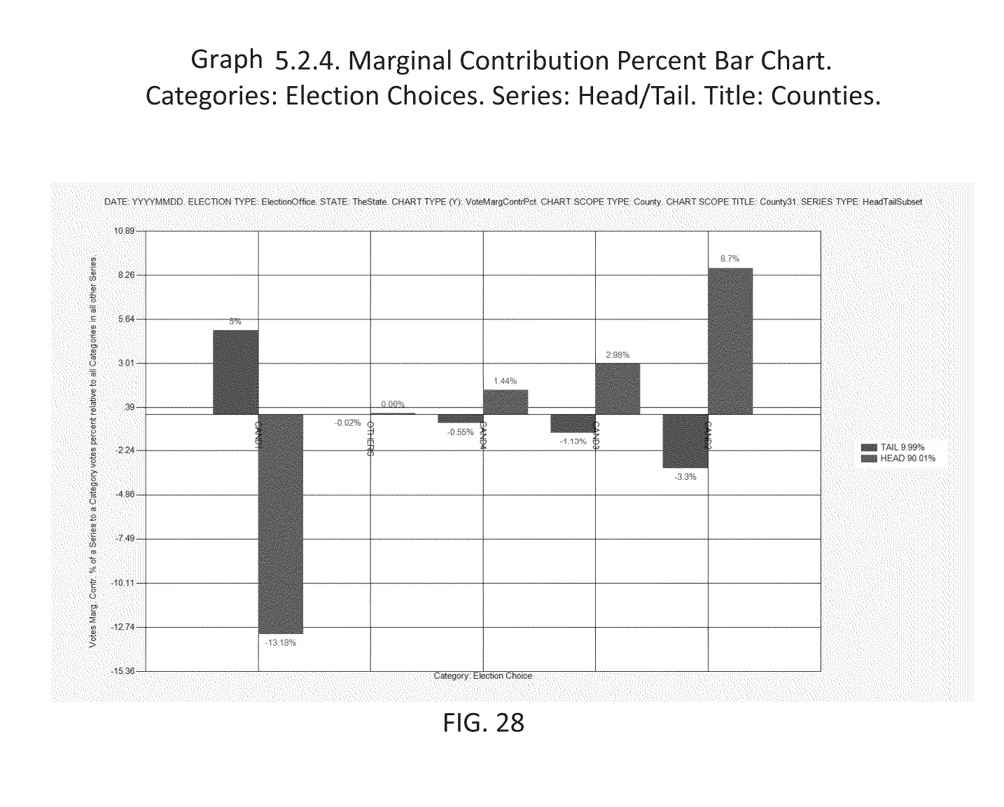

Referring to FIGS. 1-32, an election fraud detection (EFD) system according to an embodiment of the present invention is now described in detail. Throughout this disclosure, the present invention may be referred to as a fraud detection (FD) system, an election auditing system, an election verification system, a computer-based audit system, an election system, an audit system, a computer program product, a computer program, a product, a system, a device, and a method. Furthermore, the present invention may be referred to as relating to application of data mining to detect instances of election fraud. Those skilled in the art will appreciate that this terminology does not affect the scope of the invention. For instance, the present invention may just as easily relate to the implementation of prediction systems, expert systems, and behavior modeling systems.

Example methods and systems for an election fraud detection (EFD) system are described herein below. In the following description, for purposes of explanation, numerous specific details are set forth to provide a thorough understanding of example embodiments. It will be evident, however, to one of ordinary skill in the art that the present invention may be practiced without these specific details and/or with different combinations of the details than are given here. Thus, specific embodiments are given for the purpose of simplified explanation and not limitation. Some of the illustrative aspects of the present invention may be advantageous in solving the problems herein described and other problems not discussed which are discoverable by a skilled artisan.

Referring now to FIG. 1, the EFD system 100 according to an embodiment of the present invention will now be discussed in greater detail. An embodiment of the invention, as shown and described by the various figures and accompanying text, provides an EFD system 100 that may implement an automated method of analyzing election results for instances of fraud. For example, and without limitation, the EFD system 100, according to an embodiment of the present invention, may include a Fraud Detection Server 101, which may be in data communication with an Election Analyst Client 110, a User Client 120, and some number of Third-Party Data Servers 130. The Election Analyst Client 110, User Client 120, and Third-Party Data Server(s) 130 each may be coupled to the Fraud Detection Server 101 using a wide area network 150 such as the Internet. The Fraud Detection Server 101 also may have access to various third-party election data sources 140 through the Third-Party Data Server(s) 130 and/or through the Internet 150 directly.

For example, and without limitation, the Election Analyst Client 110 may comprise a web browser and a communication application. “Web browser” as used herein includes, but is not limited to, any application software or program (including mobile applications) designed to enable users to access online resources and conduct trusted transactions over a wide network such as the Internet. “Communication” as used herein includes, but is not limited to, electronic mail (email), instant messaging, mobile applications, personal digital assistant (PDA), a pager, a fax, a cellular telephone, a conventional telephone, television, video telephone conferencing display, other types of radio wave transmitter/transponders and other forms of electronic communication. For example, and without limitation, the Election Analyst Client 110 and User Client 120 may be configured to execute web applications designed to function on any cross-platform web server running Apache, MySQL, and PHP. Those skilled in the art will recognize that other forms of communication known in the art are within the spirit and scope of the present invention.

A typical user of an Election Analyst Client 110 may be a contributor to the process of interpreting quantitative data and designing statistical models related to outcomes of elections. Such a user may interact with various servers included in the EFD System 100 through the Election Analyst Client 110. For example, and without limitation, EFD System 100 users may include statistical data analysts who may be experts in the field of popular elections. Such statistical data analysts may use the Election Analyst Client 110 to service requests for information from users of various classes, as characterized above.

Continuing to refer to FIG. 1, the Fraud Detection Server 101 may comprise a processor 102 that may accept and execute computerized instructions, and also a data store 103 which may store data and instructions used by the processor 102. More specifically, the processor 102 may be configured in data communication with an Election Analyst Client 110, some number of User Clients 120, 122, 124, Third-Party Data Server(s) 130, and Election Data Sources 140. The processor 102 may be configured to direct input from other components of the EFD system 100 to the data store 103 for storage and subsequent retrieval. For example, and without limitation, the processor 102 may be in data communication with external computing resources 110, 120, 122, 124, 130, 140 through a direct connection and/or through a network connection 150 facilitated by a network interface 109. Data Management Subsystem 105 instructions, Data Analysis Subsystem 106 instructions, and Data Reporting Subsystem 107 instructions, and Access Control Subsystem 108 instructions may be stored in the data store 103 and retrieved by the processor 102 for execution. Although the data store 103 of FIG. 1 is shown as local storage, a skilled artisan will recognize that the data store 103 may alternatively, or in addition, comprise one or both of server-based storage and cloud storage.

The Data Management Subsystem 105, according to embodiments of the present invention, may be configured to advantageously receive and format input election results data in preparation for further analysis. The Data Management Subsystem 105 may also advantageously aggregate election results data into smaller subsets that may be an improved condition for further analysis.

The Data Analysis Subsystem 106, according to embodiments of the present invention, may be configured to advantageously perform statistical analysis of input data sets (and/or subsets) to identify outliers that may represent instances of election fraud. The Data Analysis Subsystem 106 may also advantageously rank the magnitudes of detected outliers to provide decision support regarding prioritization of limited audit resources.

The Data Reporting Subsystem 107, according to embodiments of the present invention, may be configured to advantageously report findings regarding election outliers to interested consumers of such information. The Data Reporting Subsystem 107 may also advantageously format reports for consumption not only by statistical analysis experts, but also by layman in the field of election monitoring.

The Access Control Subsystem 108, according to embodiments of the present invention, may be configured to advantageously enforce role-based access to data and functions related to election results analysis.

Exemplary operations of the Data Management Subsystem 105, the Data Analysis Subsystem 106, the Data Reporting Subsystem 107, and the Access Control Subsystem 108 are described individually in greater detail below. Those skilled in the art will appreciate, however, that the present invention contemplates the use of computer instructions that may perform any or all of the operations involved in election results auditing, including digital data management, version control, content searching, voter records administration, and gap analysis. For definition purposes, the term “gap analysis” as used herein may involve comparing the characteristics of actual election results with desired election results, and providing an insight into the opinions of the stakeholders in regard to the influences of the most important factors, which might account for the electoral losses. The disclosure of computer instructions that include Data Management Subsystem 105 instructions, Data Analysis Subsystem 106 instructions, Data Reporting Subsystem 107 instructions, and Access Control Subsystem 108 instructions is not meant to be limiting in any way. Those skilled in the art will readily appreciate that stored computer instructions may be configured in any way while still accomplishing the many goals, features and advantages according to the present invention.

The Fraud Detection Server 101 also may be in data communication with third-party software applications designed to create statistical data related to elections. For example, and without limitation, the EFD system 100 may provide the capability to access data from systems maintained by state election divisions and/or by caucuses of political parties. For example, and without limitation, the Third-Party Data Server(s) 130 may comprise web hosts configured for cloud computing.

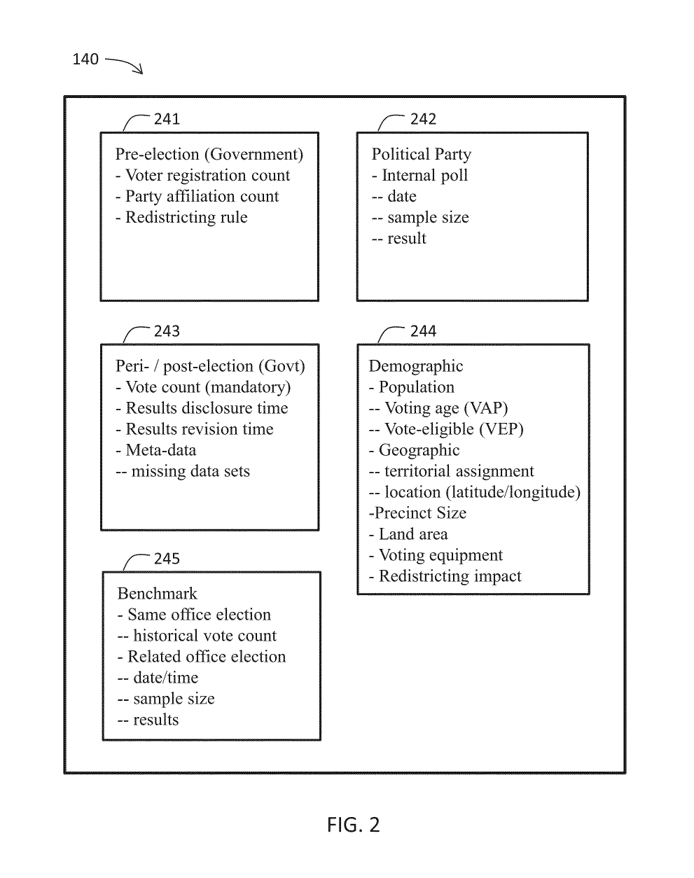

Continuing to refer to FIG. 1, and referring additionally to FIG. 2, the Fraud Detection Server 101 may retrieve data that is pertinent to a particular election, and may write those data to the data store 103. For example, and without limitation, the Third-Party Data Server(s) 130 may process a request from one or more of the subsystems 105, 106, 107, 108 of the EFD system 100 to download a copy of a particular data item from available Election Data Sources 140. The embodiment of third-party Election Data Sources 140 illustrated in FIG. 2 shows example structures of data objects that may be pertinent to an election of interest.

Employment of networking may permit the subsystems 105, 106, 107, 108 of the EFD system 100 to retrieve data from third-party Election Data Sources 140, thereby enhancing the timeliness and completeness of data used by the system 100. Although the embodiment of the invention discussed herein describes the data management, analysis, reporting, and access functionality performed by the subsystems 105, 106, 107, 108 of the EFD system 100 as illustrated in FIG. 1, those skilled in the art will readily appreciate that stored computer instructions may be configured in any way while still accomplishing the many goals, features and advantages according to the present invention.

Continuing to refer to FIG. 2, exemplary data structures for data sets that may be pertinent to a particular election will now be discussed. For example, and without limitation, data sets used as input to the election fraud analysis performed by the system 100 may include precinct-level metrics that may originate from government sources (e.g., state election divisions). Such data sets may include pre-election data 241 (e.g., voter registration count, party affiliation count, and/or applicable redistricting rules) and/or peri-election/post-election data 243 (vote count, date and time of results disclosure, date and time of results revision, and/or missing but expected election results). Government sources may also serve as repositories of useful benchmark data 245 such as historical vote counts for a particular office of interest, and such as historical and/or concurrent outcomes of similar or related elections (e.g., date and time of related election, sample size compared to election of interest, and results of related election). The sample size may be measured, for example, and without limitation, as either a number of precincts or a number of individual votes for various election choices in various precincts.

Also for example, and without limitation, data sets used as input to the election fraud analysis performed by the system 100 may include precinct-level metrics that may originate from non-government sources (e.g., polling conducted by political parties 242) and/or from sources of demographic data 244 not necessarily maintained by election divisions. Such demographic data 244 may include population (e.g., voting age, vote-eligible), geographic territorial assignment, geographic location (latitude and longitude), land area, voting equipment performance metrics, and impact analyses on redistricting rules). Although any of the data types described above may be useful to the election fraud analyses methods described herein, not all desired data are always available. In the embodiments of the invention described herein, vote counts for each of the choices in the election of interest are mandatory. Other data sets, such as voters' registration counts, voters' party affiliation counts, and histories of individual anonymous voting records are optional, although they may prove useful to augment the ability of the analyses described here to detect outliers in the available data set.

Additional examples of optional but helpful data may include precinct-level voting-eligible population (citizens at least 18 years of age whose rights to vote right are not rescinded; such data may be obtained from the Census Bureau's American Community Survey), voting age population (a superset of the vote-eligible population, which excludes non-citizen residents), land area (to compute voting-eligible population density), the type of voting equipment and software, geographical location (latitude and longitude), and details about overlapping of the current precinct with the former precinct(s) that existed before recent redistricting. Other examples of optional data may include the initial results of the election of interest, disclosure time of those results, and the subsequent results revision times (together with the initially reported and subsequently revised results) for each precinct. For example, this information may allow calculation of when detected outliers may have emerged.

For the purposes of the analyses described herein, the election results data sets need not be final and/or complete. However, all available elements (precincts and voters) of the data set at any given time may be used for the analysis. Analyzing partial results advantageously may allow for the timely detection of suspicious “red flags”. Subsequent analysis of the final results advantageously may present an opportunity to observe whether these “red flags” actually alter the ranking of election choices. Because the number of data producing elements (e.g. precincts or wards) may be in hundreds or, even the thousands for a particular election, the data set granularity may be on the precinct level, rather than on the (larger) county level for the entire state.

In one embodiment of the election fraud analysis of the present invention, missing data counts may not be allowed unless the entire registration or party affiliation information is unavailable, in which case some methods are not applied. If some data counts are missing from a precinct, the analysis may mark the precinct as “suspicious” and drop the precinct from the analysis. For example, and without limitation, each precinct may be assigned a unique name (or ID) within a county, and each precinct may have one and only one county assigned to it. The total number of votes (tally) may not exceed the registration count for any precinct. Party affiliation counts (e.g. Democratic, Republican, Others, and Unaffiliated) may not exceed the total registration count for any precinct either. The number of election choices may be unrestricted although, for practical purposes, the choices with low popularity may need to be aggregated into an “other” vote count, thus leaving approximately five or less categories of votes to simplify reporting of outlier reports.

In addition to the election under investigation, optional “benchmark” elections may be desirable for deeper investigation. For purposes of comparison to an election of interest, these “benchmark” elections may have taken place in the majority of the same precincts in the same state where the election of interest has taken place. For example, and without limitation, such elections may either be concurrent (i.e. occur in the same date range) but for a different office or on a different issue, or they may be recent historical elections. In the former case, such an election may be likely to include choices from the same party. In the latter case, the benchmark election may be for the same office, or may include the same candidate and/or parties as in the election under the investigation. In general, the “benchmark” may have some number of systematic and/or statistical similarities and may be as positively correlated pairwise between election choices with the current election as possible, so that idiosyncratic factors may be extracted in a cleaner form.

For the purposes of the analyses described herein, the assumptions may be made that a valid random audit exists, and that such an audit may assure that no widespread non-negligible election fraud exists. If such assumptions hold true, then non-negligible fraud may be presumed to alter the results by a significant amount within relatively small subsets of the electoral system, thus creating detectable outliers on various statistics of the election results data set.

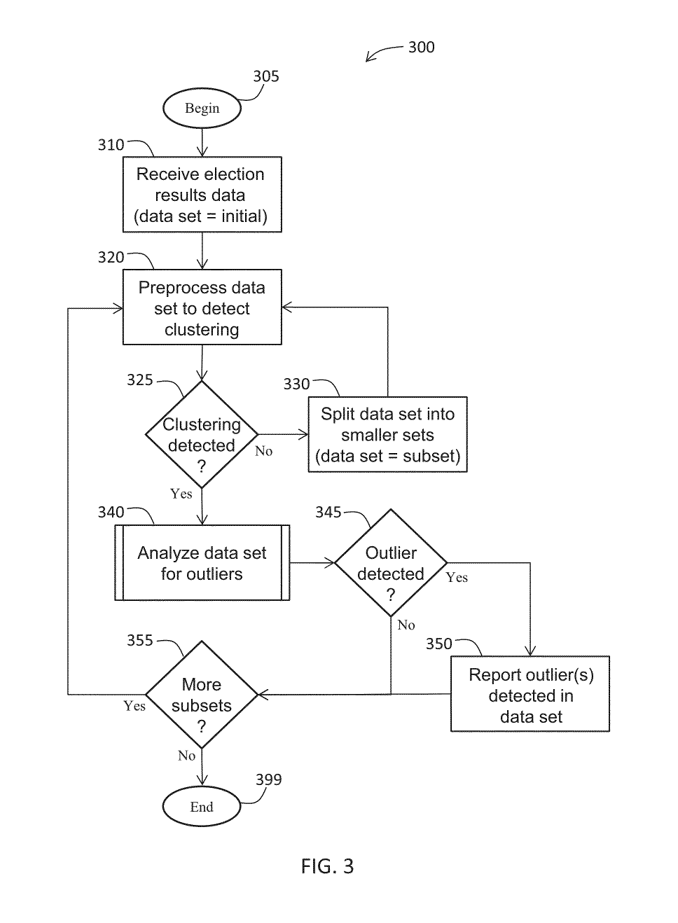

Referring now to FIG. 3, and continuing to refer to FIG. 1, an exemplary system and associated method for detecting outliers in an election results data set according to an embodiment of the present invention is now discussed in detail. From the beginning at Block 305, the Data Management Subsystem 105 may receive an initial set of election results data (Block 310). These data may be preprocessed by the Data Management Subsystem 105 for purposes of detecting a clustering condition in the data (Block 320). Clustering, as used herein, may be defined as a process of partitioning a set of data (or objects) into a set of meaningful sub-classes without the benefit of predefinition of those sub-classes. For example, and without limitation, preprocessing may include preparation of the data in a tabular format to support orderly analysis of the raw election results data. Also for example, and without limitation, preprocessing may include sorting the election results data by various factors or their aggregates, all for the purpose of observing the severity of the outliers on the state and county levels. If, at Block 325, no clustering condition is detected (e.g., non-negligible election fraud is determined to be widespread in the input data set), the Data Management Subsystem 105 may aggregate the data set into smaller subsets (Block 330), each of which may be passed to the Data Analysis Subsystem 106 for analysis for the presence of election fraud (starting, in each case, with preprocessing at Block 320). For example, and without limitation, aggregation of subsets may include cutting the statewide tail with distributional outliers for further analysis of these anomalies.

Continuing to refer to FIGS. 1 and 3, if clustering is detected at Block 325, the input data set may be analyzed by the Data Analysis Subsystem 106 for outliers (Block 340). Various exemplary operations applied for detection of outliers are described in more detail below. Generally speaking, outlier detection may involve operations directed to a) dissecting the tail of the distribution by various characteristics (dimensions), and comparing them with the rest of the statewide distribution. Identifying the most suspicious election choices, counties, and precincts for the audit purposes, b) deriving additional evidence from the data set of individual voting records in the most suspicious counties for detecting the most non-typical (or even illegal) voting patterns, and c) finding hard evidence about election fraud in these suspicious counties and precincts in the open sources.

Referring again to FIGS. 1 and 3, if an outlier is detected in an analyzed data set (Block 345), the Data Reporting Subsystem 107 may generate a report that may highlight the anomaly-containing data set as a candidate for further investigation of possible election fraud (Block 350). The system 100 may preprocess (Block 320), analyze (340), and report upon (350) each aggregated subset (Block 330) of the original input data set until no more system-generated subsets exhibiting clustering characteristics remain (Block 355). The process may terminate at Block 399.

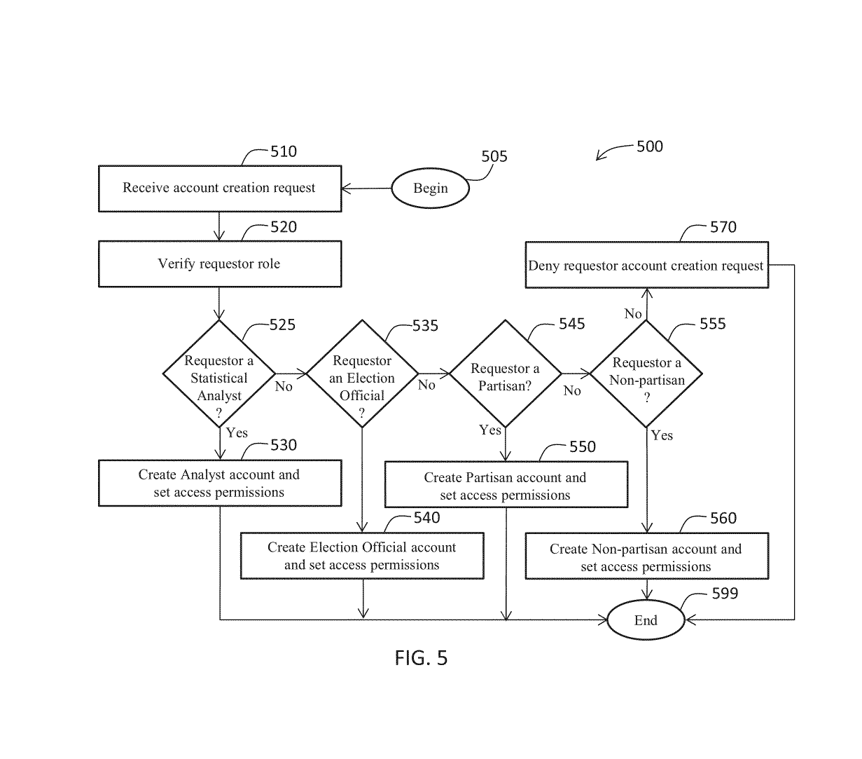

Referring now to FIG. 5, and continuing to refer to FIG. 1, the Access Control Subsystem 108, according to an embodiment of the present invention, will now be discussed. For example, and without limitation, the Access Control Subsystem 108 may be configured to facilitate role-based access control (e.g., user registration and association with permissions based on a user's role in the election monitoring and strategic response processes). From the start (Block 505), the access control subsystem 108 may receive a request to create a user account to access the EFD system 100 (Block 510). For example, and without limitation, setup of an approved account may include association of the account with a logon and password combination. At Block 520, the access control subsystem 108 may process identifying information for the user to verify the user's role in the election fraud monitoring process. For example, and without limitation, the user's role may be determined by the Access Control Subsystem 108 to be that of a Statistical Analyst as may be employed by an decision support service provider (Block 525), an Election Official such as may be employed by a government election commission, (Block 535), a Partisan consumer such as a political party operative (Block 545), or a Non-partisan such as a member of the free press (Block 555). Each user's access permissions within the EFD system 100 may be set accordingly (Blocks 530, 540, 550, or 560, respectively) before the process may end at Block 599. For example, and without limitation, association of appropriately-privileged users to specific election analysis projects for either creation or use purposes may be based upon the users' recognized roles. Alternatively, if the user's role is not recognized as an approved role within the system 100, then the Access Control Subsystem 108 may deny the user's account creation request (Block 570) before the process may end (Block 599).

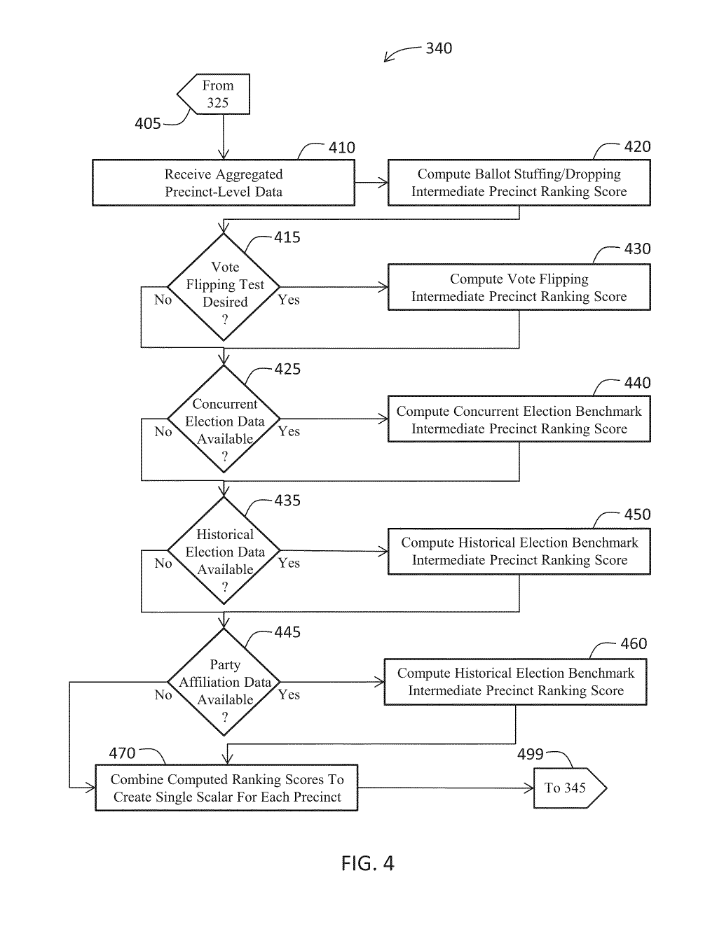

FIG. 4 describes an exemplary system and associated sub-process 340 for analyzing an election results data set for outliers, according to an embodiment of the present invention. As introductory background for that detail, the following intuitive, hypothetical illustrations are offered to describe how some combination of outlier detection methods may work.

Illustration 1: Suppose that the total statewide vote tally for an election of interest was 10000, and candidate A received 3500 votes statewide. Suppose also that in a certain precinct having the vote tally 100, and candidate A received 90 votes in this precinct. This precinct may be a candidate for auditing because a) it is relatively large, and b) it provided 90% support to candidate A as opposed to 35% support provided in the entire state. If another precinct exists that experienced a vote tally 10 and 9 votes for the candidate A, then this latter precinct may be considered less unusual than the former precinct, because the latter's small size may probabilistically justify such unusually high support for the candidate A. However, if there exist many such small precincts with unusually high support for candidate A, then these precincts may be considered for an audit as a group as well. Simply put, splitting the original precinct of size 100 into 10 equally sized small precincts may not change the level of necessity for its audit. A person of skill in the art will note that such random splitting is unlikely to produce all 10 precincts with 90% support. Instead, several precincts are likely to have nearly 100% support, which may make them more prominent outliers even in these small split precincts. If, for example, and without limitation, such outlier precincts are located in the county with 70% support for candidate A, then the necessity to audit these precincts is reduced. If other precincts in the state exhibit even more extreme deviation in support either on the state and/or their respective county levels, then they may be candidates for assignment of higher priority for an audit.

Another factor that may be significant for election fraud detection is that the candidate A may systematically receive greater support in large precincts, because a positive correlation may exist between population density and precinct size as measured by tally. For example, and without limitation, he candidate A may be legitimately more popular in high density areas, such as cities. In such cases, the precincts may be evaluated within a subset of precincts of approximately the same size from all over the state. This factor may be combined with the others (statewide and countywide expectations of the candidate support). If the statewide magnitude or aggregate impact of such outliers is insignificant, or if these factors cancel each other for each candidate (e.g. some precincts of size 100 may have 0 support for candidate A), or if these factors cancel each other across candidates (all candidates may have such outliers with large magnitudes), then the necessity for an audit is smaller. However, if these outliers change ranking of candidates statewide, then these conditions represent a “red flag” for further investigation. One may argue that valid and legitimate reasons may cause such outliers to exist. For account for such valid reasons, other statistics (systematic factors) may be evaluated for their outliers. For example, and without limitation, all precincts may be sorted by a driving statistic (e.g. population density), and the outliers may be detected within the subsets (e.g., subsequences) of precincts with approximately the same values of this systematic factor for each precinct in its own subset. In this way, the idiosyncratic precincts may be highlighted with extreme cumulative distribution function (CDF) scores. These idiosyncratic precincts may either impacted by the election fraud or some other curious reasons (e.g. a precinct full of a candidate's close friends and relatives, or a special interest group), which must not have a material impact on the statewide ranking among election choices anyway and, thus, may be identified as audit candidates. For example, and without limitation, systematic factors for creating a benchmark subset may include turnout, or, in the event a historical election is used as a benchmark, may include cross-election rates of change for the vote tally, turnout, and/or voter registration counts. If several of known factors (e.g. population density and population composition) are correlated with the election results (e.g. the most suspicious election choice alone), then these factors may be regressed (after some non-linear transformations, if necessary) on these results (assuming precinct level data availability) to produce combined explanatory factor values for each precinct. Such synthetic factors may have more explanatory power than each of the original factors, and may be used to generate benchmark subsets for each precinct as well.

Illustration 2: Suppose that the total statewide vote tally was 10000, and candidate A from party DR received 3500 votes statewide. Suppose that the statewide number of registered voters who affiliate themselves with party DR is 1000. Suppose also that a certain precinct experiences the vote tally 100, and candidate A received 35 votes in this precinct. Summarizing, the candidate has a 35% support both on the state and the precinct levels, which may seem at first analysis to suggest a reasonable, if not expected, outcome. However, suppose also that the number of registered voters in the precinct who affiliate themselves with party DR is one (1). Such a scenario may raise a suspicion that 35% support for the DR party's candidate in this particular precinct is high after all, considering the relatively low number of registered voters with DR's party affiliation (1 instead of an expected value of 10). The arguments for cause for suspicion are similar to those from Illustration 1 above, except with respect to an outlier for another statistic.

Other types of statistics may confirm the suspicion that the results in the precinct of Illustration 2 are out of line with statistical expectations and, thus, may merit auditing. For example, and without limitation, suppose another election on the same date and in the same precinct for another political office provided only 5% support to a candidate B from the same party DR, as opposed to the expected 35% support. Also for example, and without limitation, suppose historical election results are available for the same candidate A who ran for the same office in the same state a few weeks (or even years) prior to the election of interest. Suspicion may be raised if the statewide improvement in the candidate's support in the current election compared to the historical election was only 5% (taking into account another composition of rivals), while the subject precinct of size 100 provided 50% improvement in current support.

Another exemplary suspicious factor may be unusually high turnout in a given precinct. Similarly, another curious scenario may show that one of a candidate's rivals received unusually low support, while other rivals received the same support in the precinct of interest as opposed to the statewide support. Once again, all these deviation scenarios may be justified with legitimate reasons after an audit. However, because the probabilities of such scenarios happening purely by chance are infinitesimal for a variety of statistics, legitimate causes of such scenarios may be quite prominent, if not obvious. In addition, the aggregate impact of these outliers matters, and may be detectable as an intersection of outliers from various methods. Thus, the number of such outliers may become quite manageable for an audit.

As further introductory background for the detail in FIG. 4, the following hypothetical illustrations are offered to describe how to identify and characterize statistical traces that election fraud may generate in election results. For purposes of this illustration, the fact that systematic and non-negligible election fraud exists in a particular election is assumed. Election fraud may leave detectable statistical traces in the election result data set. The challenge of analysis for election fraud is to twofold: 1) Show that election fraud may be associated with detected traces, and 2) show that other factors (like legal campaign money spending) are not associated with these traces.

As for the second point of the twofold challenge, proposed statistical methods neither prove nor disprove the existence of election fraud, which may be identified and proved only by the hard evidence. However, such methods may provide meaningful direction to identify fraud (if it exists), and may identify the most suspicious election choice(s), counties, precincts, and individual voters in an election results data set for further audit and investigation. The statistical methodology defined herein may advantageously reveal the magnitude and locations of non-negligible election fraud, if it exists. If other factors leave false-positive traces, then such factors may be explainable because of their extreme nature. Such factors may be filtered out as well.

Election fraud may produce stresses (outliers) in the distributions of various statistics (temporal, spatial, and categorical) of an election results data set. Of primary interest is the magnitude of fraud that changes the ranking among candidates. Fraud impacts the statistical properties of the election results, for example, and without limitation, by increasing the weighted average vote fraction (across precincts with vote tally as weights) for one election choice (later “Beneficiary”), and decreasing the same statistic for the other election choices (later “Victims”). Weighted average fraction of votes is not the only statistic that is altered by the election fraud disturbance in the data set, as other statistics “unintentionally” may be altered as well. In fact, changing only one statistic of a data set, such as the weighted average (mean) in this case, may require careful pre-calculation and very cost-inefficient and risky altering of results in the majority of precincts with carefully pre-computed proportions. Such broad disturbances may be detectable in random audit of even a small sample of precincts (precinct tally-weighted uniform distribution may be used for precinct sample drawing without replacement from the statewide pool of precincts). In addition, the probability that election officials in such a big set of precincts may report the issue may be extremely high.

Thus, concluded premise of the present invention is that IF systematic non-negligible election fraud exists, THEN it is more likely to affect a relatively small subset of precincts. In order to be non-negligible in the entire state, the magnitude of such fraud in this small subset of precincts may be substantial, or at least sufficient to change ranking among election choices. Thus, these precincts may substantially deviate in their statistical properties from other “ordinary” precincts in the state, which may constitute the center of a normal (bell-shaped) distribution (which may not be symmetric, but its theoretical probability mass function has only one maximum). These precincts may change not on only the weighted mean vote fraction in the state, but also the skewness of the vote fraction distribution (positive skewness for the “Beneficiary”). In addition, such precincts may become outliers in multiple statistical properties in the statewide population of precincts. These outliers may be detected and singled out for further analysis. Anomalies may benefit multiple election choices, but of particular interest for purposes herein is the net-“Beneficiary”, especially if this election choice was the leader because of these anomalies. Note that the net-“Beneficiary” may be defined by the aggregate impact of all three factors, like the number and the size of precincts, as well as the magnitude of vote percent outliers in these precincts.

Positive skewness and the dominant role of the right-tail outliers for one and only one election choice may be caused by other factors, and not by the systematic election fraud. In this case, such an election choice may be defined as a “Suspected Beneficiary,” because the probabilities of such outliers to occur by chance are infinitesimal. These outliers almost certainly cannot happen randomly based on the assumption of independent events in the hypergeometric or normal distributions. Only very strong factors can produce these outliers, and these factors must be evident, easily detectable, and explainable. If the essence of a contributing factor is not on the surface, then the precinct of interest must be further investigated and audited for potential election fraud.

Typically, the set of such outlier precincts may be relatively small, and each precinct may be audited “on the field” individually. In any case, auditing this relatively small set of suspicious precincts with extreme results will not harm, and likely will be fruitful. The majority of these “Suspicious Precincts” may be clustered in a few “Suspicious Counties”, and such precincts may be outliers even within the sets of other precinct in the same “Suspicious County” and/or within a set of precincts of almost the same size across the state. Clearly, various election stakeholders may find it worth the effort to take a closer look at such outlier precincts after their anomalous results are detected, even if these results are later explainable by some legitimate factors such as intensive pre-election campaigning or legal monetary infusions for the special interests into these areas by the “Suspected Beneficiary” campaign. Multiple statistical factors may be combined to cause an anomalous result. For example, and without limitation, an unusually high vote fraction for one election choice (and unusually low support for a third election choice) combined with unusually high turnout in a large precinct with a low party affiliation statistic relative to the same party vote fraction support may make a precinct truly suspicious. Such statistical analysis may provide “soft evidence” and the main direction of the subsequent investigation, but the additional details have to be “dug out on the field” in each precinct in order to find hard evidence that would explain the anomaly.

As further introductory background for the detail in FIG. 4, the election fraud detection methods described herein may presume that an election of interest may, at any given point in time, take on one of the following five states:

1) Widespread high magnitude non-negligible fraud;

2) Widespread low magnitude negligible fraud;

3) Clustered high magnitude non-negligible fraud;

4) Clustered low magnitude negligible fraud;

5) Non-existent fraud; other factors may cause distortions or fraud-like traces.

If election fraud is widespread and has high magnitude, then random selection of precincts for an audit may uncover it. If the magnitude of the widespread fraud is low, then, most likely, the fraud present does not change the ranking for election choices, although a few outlier precincts with fraud may exist anyway and, therefore, may be likely to be detected by the proposed methodology. In the case low magnitude widespread fraud, random audit may be sufficient for lowering the magnitude of such fraud even further. Clustered and non-negligible election fraud may be the primary target of the proposed methodology. While random audit may be likely to fail to detect such fraud, the impact of this type of fraud may be significant (more specifically, this non-negligible fraud may be likely to change the ranking of election choices). The proposed methodology may detect clustered low magnitude fraud as well, although this fraud may be mixed with random data “noise” and, thus, may be barely detectable. Nonetheless, the presence of noise is not a big problem, since the ranking of election choices may most likely stay the same. Finally, the last option is very unlikely, because crime in general may be presumed to exist, and election fraud can be presumed to defy full eradication. As for other legitimate factors or simply random “noise”, these might produce somewhat similar traces as fraud does, but their magnitude must be substantial to influence election choices ranking, and an audit may unambiguously identify them even from a small subset of precincts with suspicious results. Once such factors are identified and approved as legitimate ones in one election, the subject election may be used as a benchmark for the subsequent elections to detect potentially fraud-related deviations from this benchmark.

As further introductory background for the detail in FIG. 4, the election fraud detection methods may be applied to the following relevant types of election fraud:

1) Ballot stuffing;

2) Voted ballot dropping or denying voting rights for the registered voters;

3) Vote flipping (electronically);

4) Illegal registration and voting; and

5) Illegal restricting or denying of registration, which prevent voting.

Analysis of the traces of each type of fraud in the properties of an election results data set may include outlier detection relative to temporal, spatial, and categorical benchmarks. Such traces may be quite strong in the outlier precincts. A Beneficiary may receive an unusually high percentage of votes, and a Victim(s) may receive an unusually low percentage of votes relative to the benchmark in all five types of outliers.

The side impact of ballot stuffing may be an increasing number of votes for the Beneficiary together with increasing tally count, while the number of votes for the other candidates may stay the same. Consequently, analysis may detect a decreasing percentage of registered but non-voted voters (e.g., the increase in the turnout), as well as unusually high ratio between Beneficiary's number of votes and the number of registered voters with Beneficiary's party affiliation.

The side impact of voted ballot dropping or denying voting rights for registered voters may be a decreasing number of votes for the Victim together with a decreasing tally count, while the number of votes for the other candidates may stay the same. Consequently, analysis may detect an increasing percentage of registered but non-voted voters (e.g., the decrease in the turnout), and an unusually low ratio between Victim's number of votes and the number of registered voters with the same party affiliation.

The side impact of vote flipping may be a dramatic symmetry between one pair of candidates only: one candidate may strongly deviate from its vote percentage mean (or/and median) in one direction, while the other candidate may strongly deviate from its vote percentage mean (or/and median) in the other direction. The votes may become discordant with the respective party affiliation statistics. All other statistics may stay unaltered in this case. If flipping occurs with one Beneficiary and multiple Victims, then the vote flipping trace may eventually transform from unusually high pairwise difference in vote percentage mean (median) deviations with opposite directions from the mean into an individual upward vote percent deviation from the mean for the Beneficiary.

The side impact of illegal registration and voting may be an increase in tally and registration, and most likely a decrease in the percentage of non-voting registered voters, because turnout among these illegally voting must be higher than the average turnout. In addition, the Beneficiary's party affiliation percentage may be likely to increase, while the Victim's party affiliation percent may be likely to decrease.

The side impact of illegal restricting or denying of registration may be the decrease in a Victim's vote percentage, tally, and registration. Party affiliation count of the Victim's party may be unusually low in the precinct of interest as well.

In summary, a person of skill in the art will observe that fraud may create outliers in both tails of the distribution for non-voted voters vote counts, as well as for the Beneficiary in the right tail and for the Victim in the left tail. As detailed below, the present method may test each election choice against all other election choices as a group for ballot stuffing or dropping. The present method also may test election choices vote counts pairwise for vote flipping. If voter registration data is available, then the present method may test each candidate vote count versus non-voted voters vote counts for ballot stuffing or vote dropping. The present method may execute cross-election tests for both historical and concurrent elections, as well as vote counts versus party affiliation tests. For example, and without limitation, all tests described herein may use outliers from both tails. Finally, the present method may execute the historical test for individual voters using their historical voting patterns.

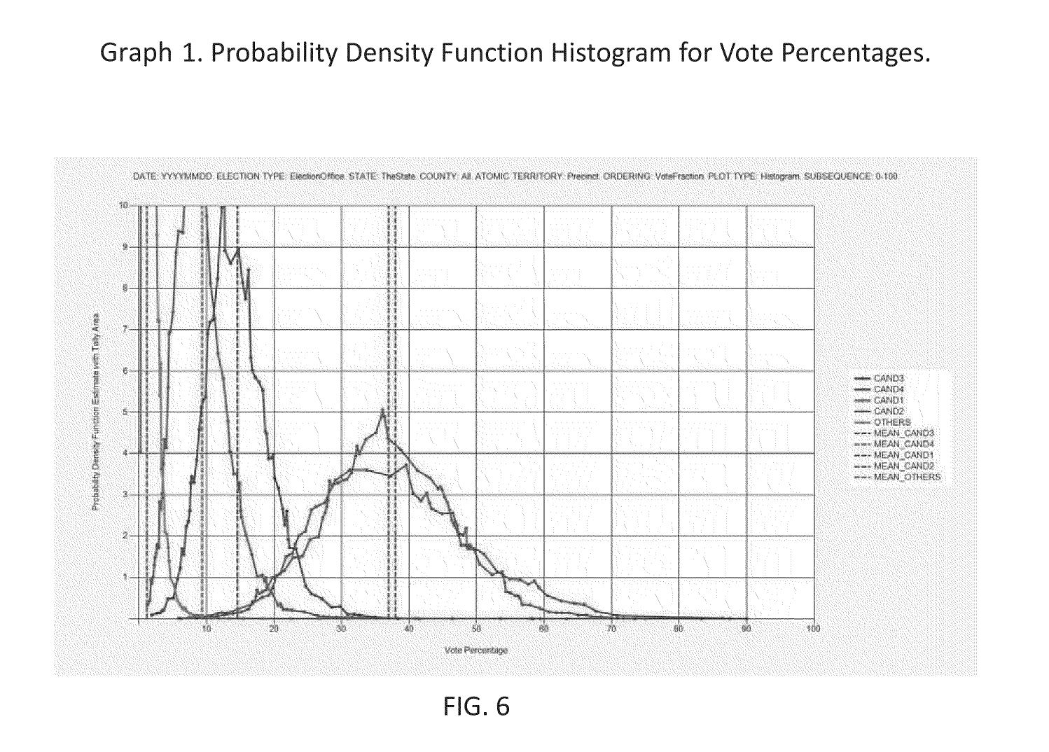

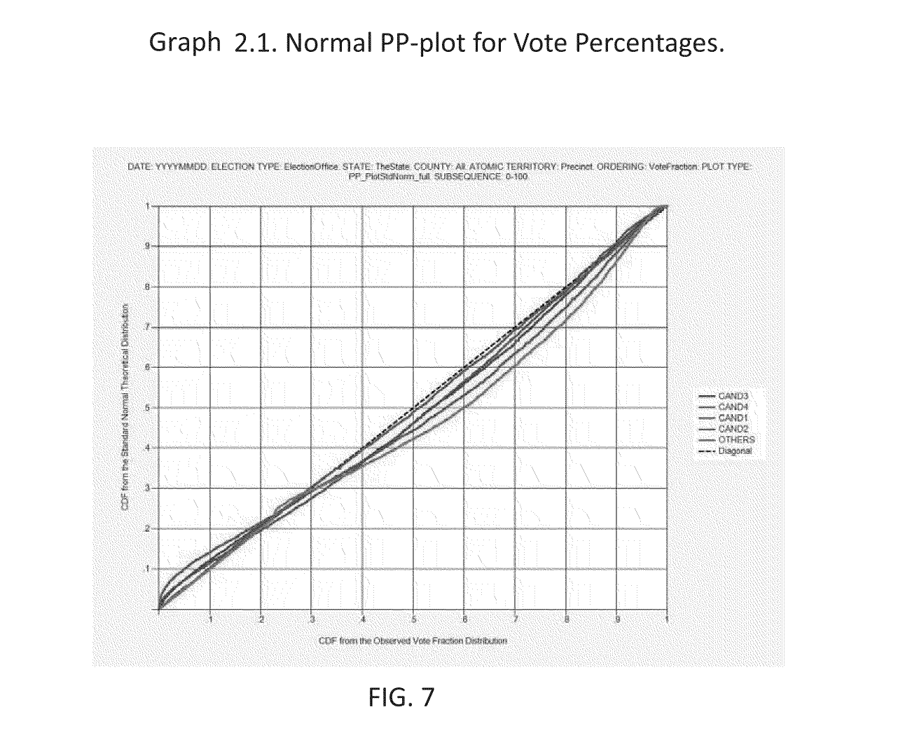

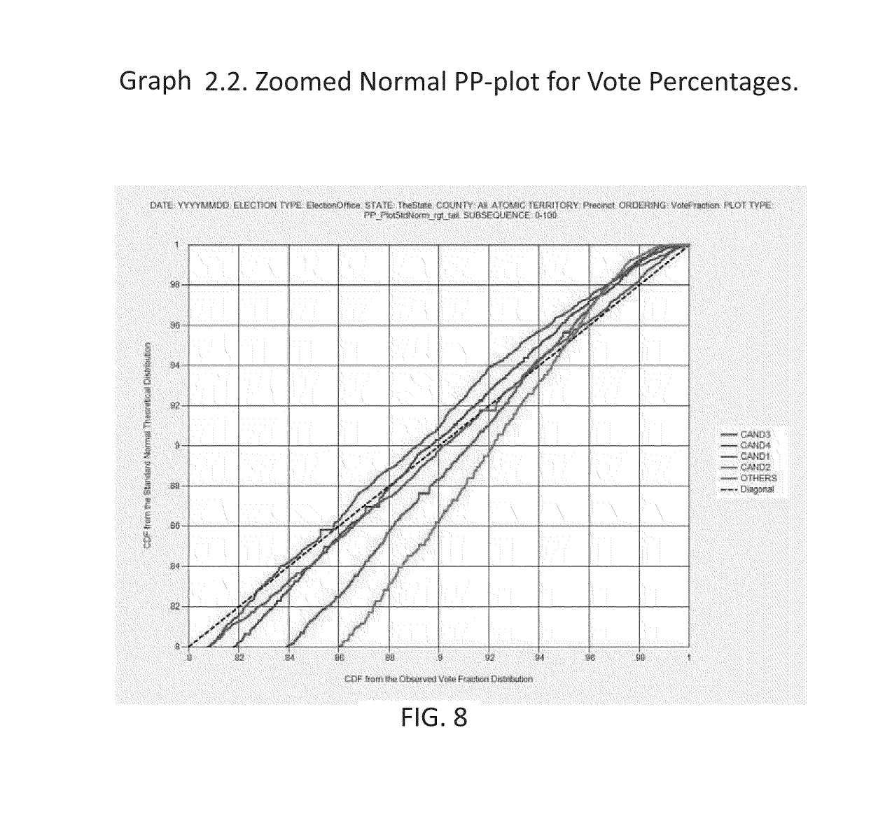

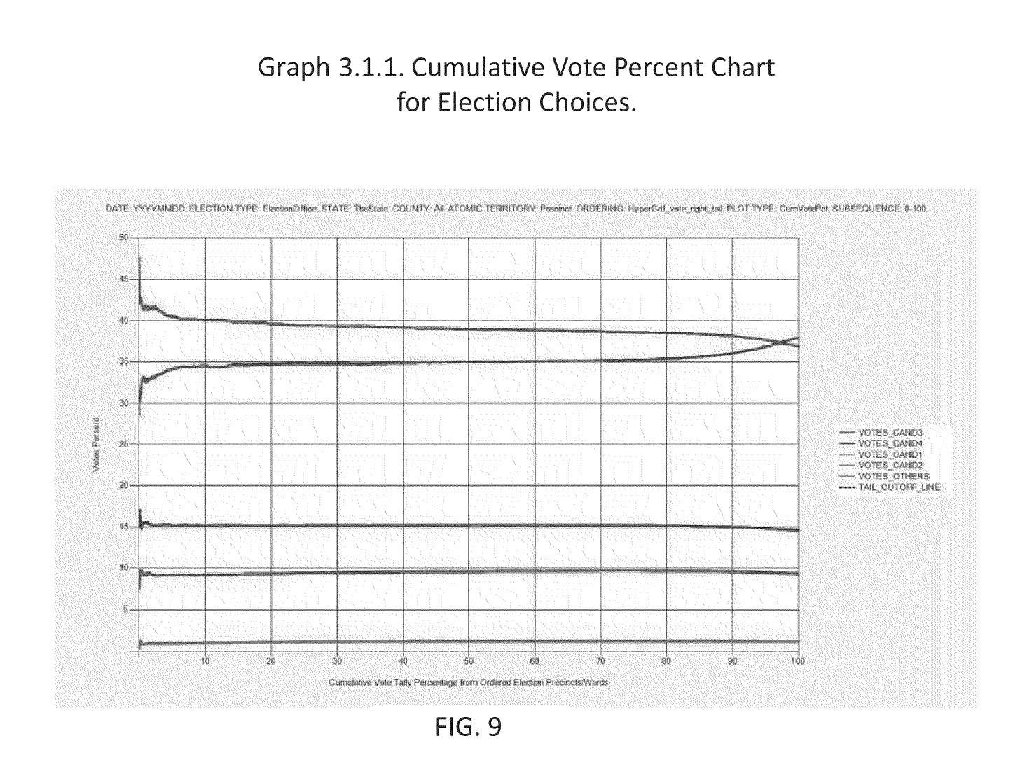

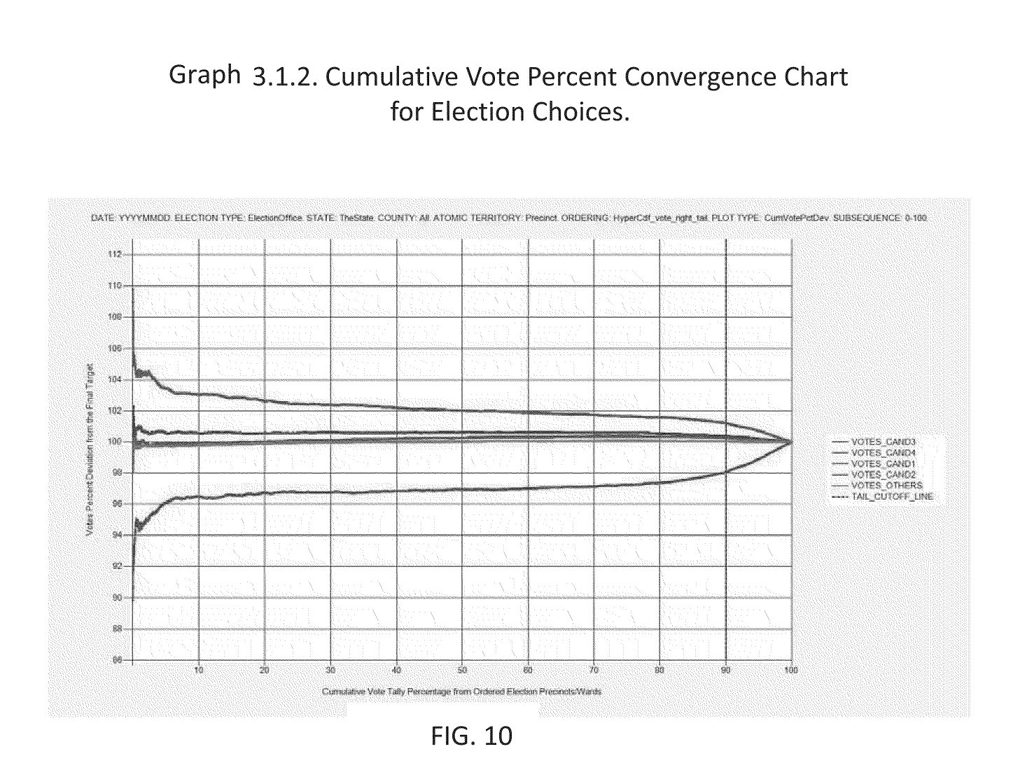

As further introductory background for the detail in FIG. 4, the election fraud detection methods may employ cumulative plots of vote fractions for outliers. Use of probability density function (PDF) histograms (see Graph 1 at FIG. 6) or normal PP-plots (see Graphs 2.1 and 2.2 at FIGS. 7 and 8, respectively) for the vote percentages may allow visual observation of outliers, but these outliers' impact on the candidates ranking may not be evident. Instead, the present methods may use cumulative vote percent charts (see Graphs 3.1.1 and 3.1.2 at FIGS. 9 and 10, respectively) to detect these outliers among election choices. The cumulative percent charts may have two axes: the horizontal X-axis and the vertical Y-axis. Each chart may have several curves, one per each election choice. If registration information is available, then one of these election choices may be the percent of registered voters who did not vote. If vote-eligible population (VEP) and voter registration information are available, then one of these “election choices” may be the percent of “vote eligible non-registered potential voters”. If voting age population (VAP) and VEP information are available, then one of these “election choices” may be the percent of “vote ineligible residents”, most of whom may be likely to be non-citizens. The cumulative percent charts may be constructed from the sorted sequence of precincts.

The X axis may have a range between 0% and 100% of the vote tally from the current subsequence of precincts relative to the grand total vote tally in all precincts in the entire state. The vote tally may be the sum of votes from all election choices, which may include “other election choices” or “invalid ballots”. If precinct level voter registration counts are available, then the X axis may contain the cumulative percent of registered voters, while another “election choice” curve may be added, which may be called “registered voters who did not vote”. If party affiliation counts are available on the precinct level, the X axis may be the percent of registered voters from the current subsequence of precincts, while the chart may contain additional curves for all party affiliation counts.

The Y axis may have a range between 0% and 100% of the votes in each election choice relative the vote tally (or the number of registered voters) in the current subsequence of precincts. Thus, when X is at 100%, each election choice curve may converge to the percent of votes for this election choice in the entire state. The right-most segment of these curves may be the most important one. As discussed below in more detail, the left-most segment of these charts may contain the center of the statistical distributions, and therefore may be relatively flat. The right-most segment of the chart may contain the tails and the outliers of the distributions. This segment of the curve may be flat as well, unless these outliers have extremely high impact on the election results. No bias may exist in favor or against any election choice during construction of this cumulative plot. No assumption may be made about the election choice to suspect the most. Even a small increase in cumulative vote percent in favor of an election choice in the right segment of the cumulative chart may imply not only the fact that small subset of precincts may have unusually high support for this election choice, but also the fact that it may overweigh outliers for the other election choices. The right segment of the chart may be cut off, which may include outliers from both tails for all election choices. The cutoff point may be either pre-determined as a fixed constant (10%, 5%, or 1% of the vote tally or number of registered voters in the tail), or the cutoff point may be set at an X value where one election choice curve may become convex and may start moving from a flat shape steeply upward, or the cutoff point may be set close on the left from the intersection point of two leading curves in the far-right segment of the chart. The predominance of one election choice in this separated right segment may make it a good candidate for further analysis. Note that if this right segment of the chart is cut off and another cumulative chart is generated from it, then the following may be observed:

1) The dominating election choice may have a higher vote percent than the one that it gets statewide. This vote percent may become the center of the distribution and may occupy the left and the central part of the new cumulative chart, and the right part of this election choice plot may be concave and decreasing.

2) The other election choices may become “suspicious” because the precinct with high support for them may become “outliers” in this chart, while they were not outliers in the statewide chart.

The hypothetical example above illustrates what may happen when a fraud factor is the dominant one in the statewide election. In this case, fraudulent results may not represent outliers anymore, and random selection audit may be used first to eliminate widespread high-magnitude election fraud before applying the present method of detecting outliers.

Although the concavity or convexity of a curve may be evident from the cumulative charts described above (see Graph 3.1.1 at FIG. 9), another plot may highlight this feature of the curve (see Graph 3.1.2 at FIG. 10). The X-axis of this “convergence” chart may have the same meaning as the one in the original Cumulative Chart. The Y-axis values for each curve, on the other hand, may be normalized the following way: The Y value for each election curve at each X slice may be divided by the Y value for the same election curve at X value of 100%. This transformation may show whether the curve converges to its right-most target from below of from above. Because the major election choices are of primary interest, and because they provide bigger sample sizes (for example, and without limitation, measured as the number of individual votes) for higher statistical inference power, another transformation may be applied on top of the previous one: raise its result to the power of the Y value for the same curve at X value of 100%. This second transformation may push curves of insignificant election choices closer to Y at 100%. After these two transformations, the most suspicious election choice may be easily detected as exhibiting a convex curve approaching 100% from below with a steep jump in the right segment of the chart, while all other concave curves converge to 100% from above.

Two or more cumulative charts may be combined into one chart for comparative purposes. For example, and without limitation, two charts from the same election for the same election office may be combined with the same election choices but for two different states. Another example would be combining two charts from the same election for different election offices from the same state. A third example would be combining two charts from two different elections for the same election office but for the same state. Such comparison(s) may allow identification of the election instance exhibiting the more pronounced outliers. The chart merging may consist of the following steps: First, each election may be analyzed independently, and a Cumulative Distribution Function (CDF) score may be assigned to each precinct in each election. Second, all precincts from both elections may be combined into one sequence and sorted by the CDF ranking scores as one sequence. If two sequences from the same state are combined, then duplicate precincts may be allowed. If two sequences with the same election choices from two states are combined, then these election choices may be plotted separately. The X axis of the combined cumulative chart may contain cumulative tally from precincts from both elections combined. However, the Y axis may contain election choices percent for each election choice independently in each election. This percent may stay constant flat (extrapolated to the right) in the gaps on the X axis that may be filled with precincts from another election.

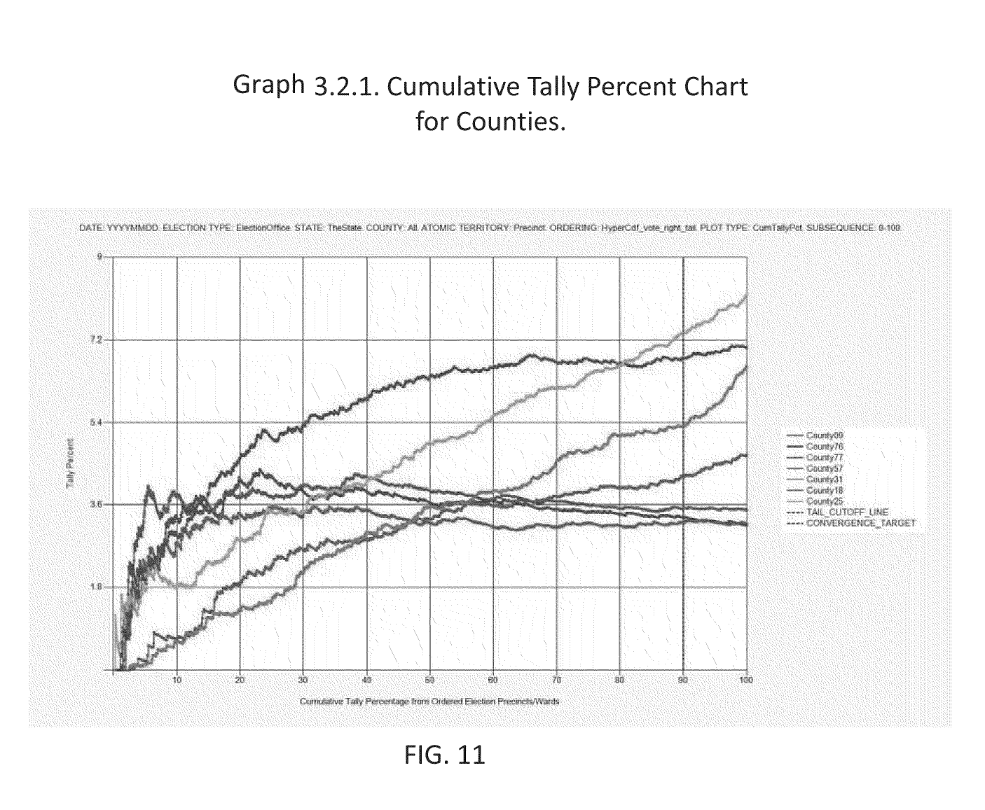

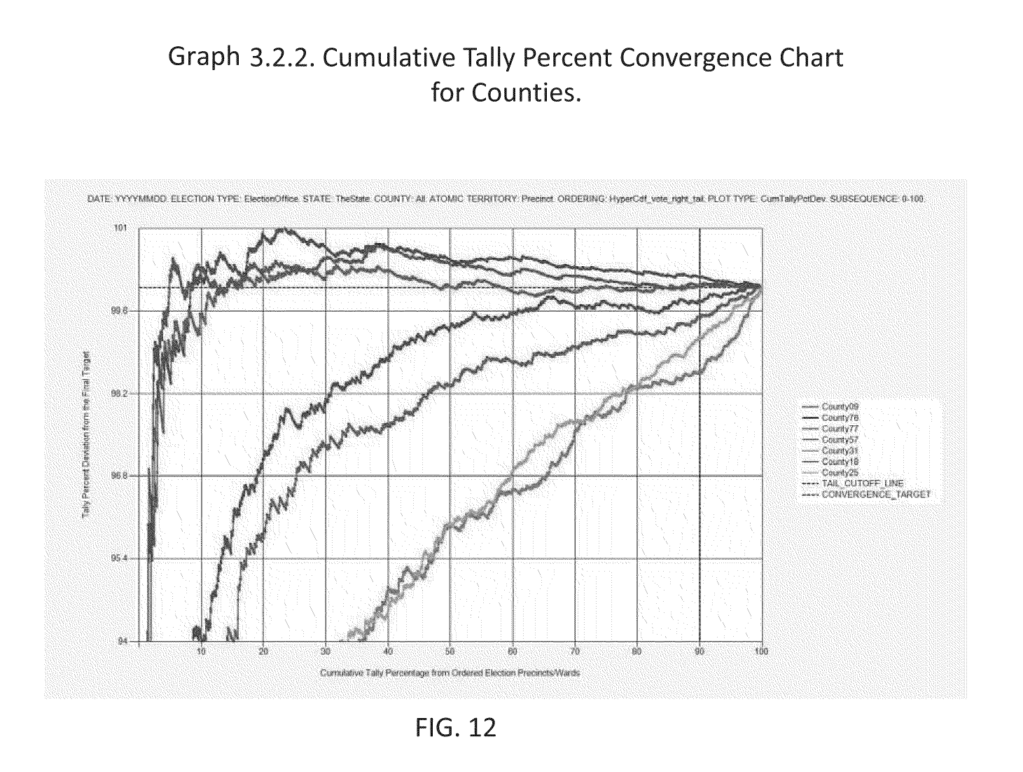

Cumulative vote percent charts (see Graphs 3.2.1 and 3.2.2 at FIGS. 11 and 12, respectively) also may be used to detect outliers among counties or other sets of electoral territorial units. For example, state territories (typically counties) may be grouped by the type of voting equipment that is used in these counties. Doing so may detect which equipment produces the majority of suspicious outliers. The cumulative charts for territorial unit (counties) may be almost the same as the ones for election choices. The difference may be that the Y axis may contain cumulative vote tally for each county as a percentage of the cumulative vote tally on the X axis. The counties with the steepest slope in the right-most “tail” segment of the chart may be the ones that require close attention for auditing.

As described above, of particular interest is convexity (upward sloping) or concavity (downward sloping) in the right most part of the cumulative charts for election choices or counties. Although these shapes may be observed visually, such characteristics may be measured and compared numerically as well. A linear regression may be run only for the right-most tails of cumulative charts of each election choice or county respectively. This regression may be estimated on equally spaced points on the curve (since the curve was constructed from unequally spaced points, some equally spaced points may need to be linearly interpolated from the original points). The slope of each line from this regression may describe the steepness of the curve in the tail: positive values may show the degree of upward slope, and negative values may show the degree of downward slope. The most convex curve may have the steepest slope with the largest linear regression multiplier. For example, and without limitation, a suspicious case may be identified when the slope (steepness) of the tail (right-most segment of the cumulative curve) is different from the slope (steepness) of the rest of this curve, which may not be flat either.

As further introductory background for the detail in FIG. 4, the election fraud detection methods may employ sorting of precincts with the cumulative distribution function (CDF) of hypergeometric distribution. More specifically, the previous section described how to plot data from a sequence of sorted precincts. This section describes how to sort these precincts so that this ordering may assemble the most suspicious precincts at the end of the sequence.

For example, and without limitation, assume that the statewide vote tally is “N”, there are only two election choices in the subject election, and the first election choice received “K” votes out of “N” statewide. A random sample may comprise “n” uniformly random draws without replacement from the entire pool of “N” ballots cast. Assume that this random sample contains “k” ballots in support of the first election choice, where “k” clearly does not exceed “n”, “K”, and “N”. The probability mass function (PMF) of the hypergeometric distribution may be applied to determine the probability of such an event, which is drawing such sample. This PMF may be defined as BC(K, k)*BC(N−K, n−k)/BC(N, n), where BC(a, b) is a binomial coefficient defined as a!/(b!*(a−b)!), where x! is a factorial operator. Similarly, the cumulative distribution function (CDF) of the hypergeometric distribution may be computed as an aggregate probability (sum of PMFs) that the random sample of size “n” contains at most “k” ballots in support of the first election choice. If this CDF is very close to zero, then it means that the sample has “unusually” low “k”. Similarly, if this CDF is very close to one, then it means that the sample has “unusually” high “k”. In the first case, it is a random draw from the left tail, while in the second case it is a draw from the right tail. Clearly, in the example above, by construction the outlier was generated purely by random noise. If a precinct is selected with vote tally “n” and “k” votes in favor of the first choice, then this sample will not be fully random. In addition to random idiosyncratic noise, it may contain the following variety of systematic factors, each of which is discussed in greater detail below:

1) Statewide factor

2) Countywide factor

3) Precinct size factor (potentially correlated with population density factor)

4) Precinct location factor

5) Election timing factor

6) Precinct political activity factor (including campaign factor)

7) Precinct political preference factor (defined by party affiliation)

These factors may explain a major portion of the election result. The above hypothetical basic example uses statewide factor as a benchmark for comparison: The results in the precinct are expected to be roughly the same as the results in the entire state. If the statewide factor was the only one, then the only reason for deviation from this expectation would be random noise of hypergeometric distribution. In this case, if the probability of drawing such a sample were infinitesimal, then some newly introduced “hidden” factor almost certainly causes this deviation. Thus, this precinct is a candidate for audit, since this “hidden” factor may be election fraud. The more benchmark factors are used, the smaller will be the “false positives” among these “red flags” for the audit purposes. Clearly, some legitimate factors may be omitted from the model, or the limitations of the data availability may impose restrictions on the number of benchmark factors in the model. Nevertheless, the model is flexible to accommodate both limited (incomplete) amounts of election data and increase its accuracy in case more data availability. In any case, the user may select any number of the most suspicious precincts depending on audit capacity. The amount of calibration data for the model may vary and is adjustable. For example, if precinct heterogeneity produces explainable outliers in some precincts, then these precincts may be benchmarked against recent elections or party affiliation information, but not against other precincts from the election under investigation. The model may indicate that the audit is unnecessary at all.

As further introductory background for the detail in FIG. 4, computational complexity considerations for hypergeometric distribution in the election fraud detection methods described herein are now discussed in more detail. The computational complexity of hypergeometric CDF is quite high, although it may not be prohibitive on a modern day powerful personal computer. The brute force approach may involve summing tens or hundreds of factorial ratios for hundreds (or thousands) of precincts, and this summation may be applied multiple times for various methods and election choices. This computational complexity may be resolved with various numerical algorithmic approximations combined with other approximating distribution's CDFs for some combinations of inputs. For approximating Hypergeometric CDF, one may theoretically use Bernoulli, Poisson, Binomial, or Normal CDFs, as well as numerical approximations (e.g. Lanczos) of Hypergeometric CDF. There is usually a tradeoff between reduction of computational time and numerical accuracy at least for ordering purposes, although both may be achieved with the same method. The accuracy issue is both mathematical (when other distributions are used as proxies) and numerical (when numerical computational aspects are related with specific hardware limitations). Of primary interest in the present methodology is high accuracy in the tails, when CDF is close to either 0 or 1. The center of the distribution may have lower accuracy for each precinct, since the present methodology may analyze the tails only.

Three exemplary methods for computing Hypergeometric CDF are disclosed in Appendix 1: numerical Lanczos approximation of Hypergeometric CDF (“cdf_hypergeometric_num_dbl” function), numerical approximation of Normal CDF (“cdf_normal_dbl” function), and precise formula for Hypergeometric CDF (“cdf_hypergeometric_exact” function). Each method has its advantages and disadvantages. As defined in Appendix 1, the function “cdf_hypergeometric_approx” combines all of the above three functions, and function “cdf_hypergeometric_simulate” shows how hypergeometric CDF may be generated, for example, and without limitation, with Monte Carlo simulation.

Both “cdf_hypergeometric_num_dbl” and “cdf_normal_dbl” require very little computational time, while “cdf_hypergeometric_exact” may require longer, but not prohibitively longer computation time (for precinct with tally no bigger than a few thousands) (see Appendix 2 and Appendix 3 for sample timing and accuracy). The function “cdf_hypergeometric_num_dbl” may provide sufficient accuracy (always at least 1e-7, and the accuracy increases as the values approach 0 or 1). Function “cdf_hypergeometric_num_dbl” may not work in rare cases when the sum of the sample size (n) with the number of successes (K) in the population exceeds the population size (N), or when n exceeds K. The function “cdf_normal_dbl” may provide good and adequate accuracy (always at least 1e-7, and the accuracy increases as the values approach 0 or 1) relative to the theoretical value of the Normal CDF, which may provide good approximation for Hypergeometric CDF under some conditions, as summarized below.

The function “cdf_hypergeometric_exact” may provide extremely good accuracy for any practical input set. It uses built-in C#“double” numerical type, which supports probabilities down to around 5*10e-323 in scientific notation. Thus, there is no need to use arbitrary precision floating point arithmetic library. The accuracy is important as long as it assures correct ordering among CDFs, including those that are very close to zero or one. If a “double” number is very close to one, then the accuracy of 10e-323 cannot be supported by this type “double”. However, the method disclosed in Appendix 1 may support such accuracy. The CDF may be computed as two summands: the “base”, which may be either 0 or 1, and the “adjustment”, which may be added to the “base”. If the “base” is 0, then “adjustment” is between 0 inclusive and 0.5 inclusive. If the “base” is 1, then adjustment is between −0.5 exclusive and 0 inclusive. In this way the accuracy of tail probabilities is very high (can be smaller than 10e-300 in far tails).

Another exemplary technique that may preserve accuracy in “cdf_hypergeometric_exact” stems from the manner in which CDF is computed. CDF is a sum of Probability Mass Functions (PMFs). First, these PMFs are summed in increasing order, preserving accuracy during summation. Second, PMF computation may involve a ratio of two huge numbers, which may be products of several factorials. Dividing these two large numbers may produce poor accuracy. To avoid this result, the methods herein iteratively construct this ratio by multiplying or dividing the evolving ratio by the integers from the decomposed factorials so that this ratio does not deviate too much from value ONE (1) during this process. When this ratio is below one and there are no numbers left to multiply it by, then this ratio is divided by the remaining numbers from the denominator to arrive to the final PMF value.

Considering the advantages and disadvantages of the three CDF computation methods described above, the systems and associated methods of the present invention may include a sequence of conditionals that determine which method to use each time a Hypergeometric CDF is to be computed. For example, and without limitation, the automated method may check two conditions (as defined above) for the validity of the Lanczos approximation method from the function “cdf_hypergeometric_num_dbl”, and may use it if the conditions are met, which is the case in the vast majority of cases. The function requires very little computational time. If such conditions are not met, the automated method may check several other conditions that determine whether exact Hypergeometric CDF computation (which is relatively time consuming) is to be applied, or whether Normal CDF is to be applied as an approximation instead.

To characterize the decision process above, and by way of definition, assume k:=the number of success in the draws without replacement; n:=the total number of trials/draws; K:=the number of success in the population; N:=population size. The function “cdf_hypergeometric_exact” may be used for small “n” or for “k” close to 0 or n (depending on the ratio (k/K)/(n/N) relative to 1), because the computational complexity and time for such cases is low. The function “cdf_hypergeometric_exact” may be used when the sample size is substantial relative to the population size. The function “cdf_normal_dbl” may be used as an approximation only if Hypergeometric PMF has relatively symmetrical bell shape. The function “cdf_hypergeometric_exact” may be used if the fraction of success in the sample is very different from the fraction of successes in the population. Finally, regardless of the above conditions, the function “cdf_hypergeometric_exact” may not be used for very large sample sizes (bigger than several thousands, which is a rare case, especially after optional scaling downs of all precinct sizes and unlikely failing to use “cdf_hypergeometric_num_dbl”), and “cdf_normal_dbl” may be used instead, because of computational time. Note that ratio K/N may not be used as a conditional for approximation, since it would introduce a bias to election choices based on their popularity. Appendix 1 contains tested and recommended thresholds and parameters for these conditionals and selections among these three methods, although they may be further calibrated based on available system performance and analysis time constraints. Note that the description of aggregation below discusses precinct size scaling, which may be partially relevant to the technical aspect of computations from this section.

Distributed computing in multiple machines and/or multithreading may substantially improve performance of the CDF computational process, which may be acceptable on a single thread as well. The data set may be split into independent blocks, which may be processed in multiple machines within the same network, CPUs, CPU cores, processes, and/or threads concurrently. All results may be accumulated on one machine in one thread for charting and reporting purposes. The number of thread may be equal to the total number of cores in the CPUs. Some programming languages may provide special libraries for these purposes, for example “Task Parallel Library” in Microsoft's C#. In case of distributed computing and/or multithreading, constraints that prevent using exclusively “cdf_hypergeometric_exact” may be substantially relaxed, although this may be unnecessary. For example, and without limitation, the following C#code example demonstrates how to use multiple cores in parallel:

using System.Threading.Tasks;
// for (Int32 iRowIndex = iStartRowIndex; iRowIndex <=
iEndRowIndex; ++iRowIndex)
ParallelOptions options = new ParallelOptions( );
options.MaxDegreeOfParallelism = 12; // can be 1 or more, up to the
number of CPU Cores;
// Watch out for the CPU overheats with high degree of parallelism!
Parallel.For(iStartRowIndex, iEndRowIndex + 1, options, delegate(Int32
iRowIndex)
{ // Process (compute) an element from an array or a table with index
″iRowIndex″
} );

As further introductory background for the detail in FIG. 4, the election fraud detection methods may employ an assembly of features to produce a model implementation. More specifically, the description above illustrates how to apply hypergeometric distribution in a basic setting. The following disclosure describes additional features that may improve the quality of the model, as well as new data sets that may allow production of results that may be more accurate.

For example, and without limitation, as an alternative to the Hypergeometric distribution, a person of skill in the art may suggest use of only Normal distribution. This is a methodological issue, but not an issue of numerical approximations for the Hypergeometric CDF computation, as described above. This Normal method may include several steps: First, the weighted average estimate of the vote percent and the weighted standard deviation estimate of the vote percent may be computed for all precincts statewide, where the weights may be the vote tallies of these precincts. Second, vote percent for each election choice across all precincts may be assumed to be approximately normally (or log-normally) distributed, at least after excluding the outliers. Third, vote percent statistic for each precinct may be standardized by subtracting earlier computed mean estimate and dividing by earlier computed standard deviation. The result may be standard normal variables, mapped from the interval (−Infinity; +Infinity) to (0; 1), where zero origin is mapped to the new origin one half, and all other values are mapped symmetrically around this new origin:

If X>=0 then X′=(2−1/(X+1))/2

else X′=1−(2−1/(−X+1))/2,
which is equivalent to the following transformation:

X′=(X/(1+X*Sign(X))+1)/2.

The most extreme (the closest to zero or one) value may be selected among all election choices in the current precinct. This value may be used as a sorting criterion for this precinct in the statewide sequence of precincts.

The major deficiency of using Normal distribution may be its inability to account for the size of the precinct. For example, if an election choice got 10% of the votes statewide, then the precinct of size 1000 votes may be much less likely to have 50% of votes for this election choice than the precinct of size 10 votes. Hypergeometric distribution, on the other hand, may account for the precinct size factor in its CDF. Preserving the original non-aggregated precincts in the analysis is essential to identify them precisely if their results are statistically suspicious. For this reason, the Normal distribution may be rejected as an alternative to the Hypergeometric distribution for the purposes of the fraud detection method described herein.

Excluding Outliers during Expectation Calibration: When outliers have a substantial impact on the mean (outlier have impact on the median too, which is implicitly used in the CDF score, which has its maximum of 0.5 in the median point), removing them for the mean (median) estimation may make the cumulative chart somewhat more meaningful. For example, and without limitation, if the outliers are kept, the plot may slowly drift downward from the distorted mean (median), and then jump upward in the right segment. These outliers may be removed for the purposes of “K” (the statewide votes for the current election choice) and “N” (the statewide vote tally) adjustments (adjusted “K” and “N” may be smaller than the unadjusted ones). This adjustment may be done for all election choices at once as long as at least one of them is an outlier in the current precinct, the entire precinct may be marked as an outlier for this stage only. Obviously, these outliers are not to be removed from subsequent analysis: these are outliers for the mean (K/N) estimation only. If these outliers are removed when computing “K” and “N”, then the chart will be mostly flat, since it will start from the undistorted mean in its left segment. It will jump upward in the right segment too, since these outliers are kept in the analysis. This exclusion of outliers does not make a big difference for the results, because these outliers may be assembled in the upward jumping right segment of the chart in either case. However, in this case the cumulative plots may produce expected flat segments of curves in the left and central parts of the chart. Note that adjusted “K” and “N” should still be valid for each existing sample of size “n” with “k” successes in it: n<=N and k<=K<=N. In order to exclude outliers, “N” and “K” may be adjusted by excluding those precincts that have the most extreme (among all election choices in the precinct) hypergeometric CDF very close to zero or one.

For example, and without limitation, an alternative way to achieve the same objective of flattening the Head segment of the plot may consist of the following steps: process, rank, and sort all precincts (including potential outliers) statewide; cut the Tail subset of precincts (the outliers); process, rank, and sort the Head subset of precincts again, but without the outliers from the Tail this time; attach the earlier cut Tail to the doubly-processed Head. In this sequence of steps, the Head precincts will be ranked and sorted based on adjusted outlier-free means and medians. Note that this extra step does not change the composition if the Tail, but merely flattens the Head segment of the plot.

Election Choice Column Aggregation: Typically, an election comprises two or more choices (even if election has one choice only but registration information is available as well, election results may still be analyzed). In some cases, the number of choices may be large, but most of them may receive a negligible percent of votes. Although the fraud detection methodology described herein may correctly process any number of choices, doing so for a particular data set may cause processing time to be longer even though there is no need to analyze the negligible choices. To advantageously achieve economy of computational resources and/or simplification of reporting, these negligible choices may be aggregated into the “Other” choice. For example, and without limitation, the number of choices may be reduced to a manageable number between 2 to 5, which may include choices with at least 5% to 10% of the votes. A person of skill in the art may note that, in addition to the “Other” choice, an aggregation may comprise a “registered voters who did not vote” choice, if voter registration information is available. Similarly, when analyzing party affiliation and registration information, aggregations may be created for “Unaffiliated” and “Other Party Affiliation” choices. Similarly, when vote-eligible and/or voting age population information is available, aggregations may be created for “vote eligible non-registered potential voters” and “vote ineligible residents”.

Precinct Data Aggregation: For example, and without limitation, the methodology described here may be presumed to operate against precinct level data, since the method's purpose may be to identify the most suspicious precincts and election choices. Therefore, no precinct aggregation may be expected or advisable. The precincts may have different sizes, and the methodology may handle it correctly. Absentee vote counts may be mixed with other vote counts on the precinct level. If the absentee vote counts are available for each county, then these sets may be processed as “precincts”. If absentee vote counts are available on the state level only, then this set may be considered as a “county” with one “precinct”.

The present methodology may be applied to the data set with the county or congressional district granularity, if the precinct level data is unavailable. However, in this case, the analysis results may be expected to be much less informative. For example, and without limitation, the most extreme case may be the availability of statewide aggregates only, and clearly this level of aggregation may not be used for meaningful analysis. More specifically, this case may not be resolved, since these coarse aggregates may not be decomposed into precinct level granularity.

For example, and without limitation, as another extreme, the precinct sizes may be very small, with vote tally less than 30 and even close to one. In this case, many such precincts may exhibit the same CDF. This issue may be partially solved with the secondary sorting criterion for each precinct, which may be a uniformly distributed random number between 0 and 1. This secondary storing criterion may randomly shuffle all groups of precincts with the same CDF for the purposes of the cumulative plots.

When precinct sizes are close to one vote, the results of the analysis may be uninformative for these very small precincts (but for other larger precincts the results may still be informative). In order to resolve this issue, the election results from these very small precincts may be aggregated into pseudo-precincts of size at least 30 (but not much larger). However, the latitude and longitude of each of these small precincts may be required in order to construct such pseudo-precincts. This extreme case may be virtually never observable in real precinct partitioning. Typically, such very small precincts (by tally size) are rare, and they may have negligible impact on the statewide election results, and thus their aggregation may be unnecessary. On the other hand, in a hypothetical example, if a real precinct of tally size 1000 with 100% support for 1 candidate is split by the election authority on purpose into 1000 precincts of tally size 1, then 100% support for this candidate in each of these small precincts may not be as extreme, given that this candidate may have, for example, 45% support statewide. Therefore, aggregating these extremely small precincts into pseudo-precincts of size at least 30 may be desirable, since these pseudo-precincts with 100% support may still be considered as extreme and unusual. Such extreme redistricting may be assumed not to happen, unless the model actually detects it, in which case the small precinct should be questioned as described above.

Redistricting may present a situation whereby precinct aggregation may be unavoidable. As described below, historical election data may be used as a benchmark for the current election. In this case, all data pairs for all precincts must be available, both from the historical election and the current election. Accessing this data directly may not always be possible: the boundaries of some precincts may have been altered because of redistricting. In this case, these precincts may be aggregated both in the historical election and the current election, and a pair (or pairs) of these aggregates may be generated. All paired aggregated precincts pairs must encapsulate the same geographical area from both the historical and the current election.

By way of definition, the term Precinct as used herein may refer to the smallest atomic (indivisible) geographical area. The term State as used herein may refer to all Precincts under analysis. The term County as used herein may refer to a subset of Precincts within the entire set, which may be presumed to refer to a State. Clearly, a County may not be the only way to aggregate Precincts. For example, and without limitation, Precincts may be grouped into Congressional Districts, or subsets of precincts with the same type of voting equipment, or other geographical division criteria. Within these geographical subsets (or within the entire statewide set), for example, and without limitation, we may have smaller subsets having approximately the same vote tally, turnout, number of registered voters, population density (if population size and land area are provided), amount of campaign money spent per voter, rate of change in turnout, and/or tally or registration relative to the benchmark historical election. If a geographical location of each Precinct is known, such as latitude and longitude, an arbitrary fixed number of points in the Earth surface may be set (including the scenario whereby one and only one point exists for each precinct in the full set), and then Precincts may be geographically grouped based on shortest distances from them to each of these pre-set points. Although this method may provide a lot of flexibility for grouping, it may require extra data and effort. For purposes of explanation herein, automatic grouping by County may be presumed to be sufficient for the objectives of the analysis, and within Counties smaller subsets may be based on relevant statistics, which in some cases may be highly correlated (either positively or negatively) with one of the election choices for higher emphasis on the outliers.

The election fraud detection method described herein may be applied on a bigger scale: counties may be used as atomic units (instead of precincts) and states (instead of counties) as subset of counties (as atomic units) within the entire nation. The main issue with such setup may be potentially slow computational performance during hypergeometric CDF computation, since the sizes of counties may be much larger than the sizes precincts, which may be sufficiently quickly processed with the exact Hypergeometric CDF. Another issue may be zero CDF scores for many atomic units because of limited floating point precision (type “double” in C#cannot be smaller than 5*10̂(−324)). An exemplary solution to this issue is described below, and may be applied to the analysis of precincts on the state level as well if computations are too slow or rounding is unacceptable for a given computer system setup.

If computational time is unacceptably long or CDF score rounding sets it to zero, the following three optional modifications may be applied to the analysis herein: 1) scale down all counts in the data set, 2) aggregate the smallest atomic units (precincts for statewide analysis and counties in the nationwide analysis) before scaling them down, and 3) compute CDF scores with Lanczos or Normal approximations only, but not an exact version of hypergeometric CDF (see function “cdf_hypergeometric_approx” in Appendix 1). The first modification may require establishment of an upper threshold for the median vote tally in the set of atomic units. If this threshold is exceeded, then all vote counts and registration counts may be reduced by the scaling factor such that, after its application, the scaled median vote tally may be equal to the above upper threshold (e.g. 300). All scaled counts may be rounded to the nearest integer. Such rounding may have the major impact on the smallest atomic units, which may be even reduced to size zero. This phenomenon is the reason the second modification may require aggregation of such smallest atomic units (with their identity preserved) into somewhat bigger atomic units (e.g. with scaled down size at least 30). This aggregation may be performed before scaling and rounding (to preserve unrounded information), but it may be applied to the original atomic units with the potentially post-scaling and post-rounding size less some threshold (e.g. 30). This aggregation may be done either on the county or state levels (when precincts are atomic units), and either on the state or nationwide level (if counties are the atomic units). The third modification may be applicable to the biggest atomic units, which may be still too big for the exact Hypergeometric CDF computation even after scaling down their sizes (e.g. post-scaled size above 3000). For such rare big (after scaling) atomic units, either fast Lanczos approximation (which is the most frequently applied method anyway) or fast but somewhat less accurate Normal approximation may be applied, the latter of which may be adequate in such extreme cases given unacceptably high computational costs. Although this inaccuracy may be undesirable, it may nonetheless be acceptable. If zero CDF scores for multiple atomic units are received, the units may be shuffled in the sorted sequence by the secondary sorting criterion (the primary one if the CDF score), which may be a Uniform random number. A person of skill in the art may note that this approximation may be avoided by either deeper scaling down of all atomic units, or by increasing the threshold that imposes this approximation (in our example 3000).

Each precinct may be characterized by a vote percent for multiple election choices. Some election choices may have “unusually” high vote percent, while others may have “unusually” low vote percent. The statistical meaning of the word “unusually” may vary across benchmarks and methods, as discussed in more detail below. An objective may be to rank precincts with the hypergeometric CDF in the order from the least “unusual” to the most “unusual” ones. For example, and without limitation, the following are three ways to achieve this ranking:

1) Use the right tail only (i.e. select the maximum CDF, meaning closer to one, from all election choices' CDFs, and use it for precinct ranking. This is the case of detecting the highest “unusual” vote percent).

2) Use the left tail only (i.e. select the minimum CDF, meaning closer to zero, from all election choices' CDFs, and use it for precinct ranking. This is the case of detecting the lowest “unusual” vote percent).

3) Use both the left and the right tails (i.e. take the smallest CDF “adjustments” by their absolute value from all election choices' CDFs, and use them for precinct ranking. Recall the following definitions from above: CDF “base” at 0 or 1, and CDF “adjustment” for the “base”, and this decomposition was justified by accuracy preservation). This is the case of detecting either the lowest or the highest “unusual” vote percent, whichever is less likely under the assumption of random drawing.

If a precinct has “unusually” high vote percent for one candidate, then it may be likely to have “unusually” low vote percent for another candidate, unless this deviation from the expectation is distributed among multiple candidates. The same rule holds for the “unusually” low vote percent. Therefore, both the first and the second approaches may overlap to some degree, and they may both be valid. Nonetheless, in order to apply uniform approach, which is unbiased to any election choice, the third approach only may be utilized: the methodology described herein may presume grouping of outliers from both tails together for subsequent analysis. The left-side CDF, which does not add up to 1, may be used with the right-side CDF because of the discrete nature of hypergeometric distribution: the probability of drawing at most “k” successes plus the probability of drawing at least “k” successes may be slightly greater than 1, since the probability of drawing exactly “k” successes may be counted twice. This deviation from one may be insignificant for larger precincts (samples of votes), and it may be acceptable for the purposes of two-tail analysis even in the small precincts: the left- and right-tail CDFs need not be averaged.

As further introductory background for the detail in FIG. 4, the election fraud detection methods may employ a generalized methodology of computing precinct rank order from hypergeometric CDFs of all election choices. For example, and without limitation, the following Outlier Score Computation Methods may be applied to more than two election choices:

Method 1: For each election choice, create two groups of votes: in favor of this election choice and in favor of all other election choices.

Method 2: For each pair of election choices, create two groups of votes: in favor of the first election choice in the pair and in favor of the second election choice in the same pair.

Method 3: Pre-select pairs of election choices with high correlation, such that these choices originate in different elections. For each pre-selected pair of election choices, create two groups of votes: in favor of the first election choice from the current election in the pair and in favor of the second election choice in the benchmark election in the same pair.

Method 4: Pre-select pairs of election choices with their respective party affiliation counts during the same election. For each pre-selected pair of election choices with party affiliation information, create two groups of counts: votes in favor of the election choice in the pair and the number of registered voters that are registered as affiliated with the party of this election choice.

Method 5: Select only one pair of election choices (among more than one election choices), and create two groups of votes: in favor of the first election choice in this pair and in favor of the second election choice in this pair.

For each out of these five methods, the most extreme CDF among these numbers (in the previous sub-section, we defined “extreme” CDF as the one near either zero or one) may be selected, and the absolute value of CDF “adjustment” may be assigned as the precinct's ordering rank. The smallest absolute values of CDF “adjustments” may represent the most extreme CDFs.

The first method may be good for detecting ballot stuffing and ballot dropping. In fact, when this type of fraud occurs, it has a targeted impact on one election choice, while the other election choices proportionally absorb the opposite impact.

The second method may be good for detecting vote flipping. In fact, when this type of election fraud occurs, it targets a specific pair of election choices, while other election choices are not impacted.

Both of the above methods may have overlaps in their detection power, but each of them has its own specialization. They may be used together, and the precinct ranking scores from each of them may be averaged with geometric average of absolute values of CDF “adjustments” to produce the aggregate precinct ranking score.

The third method may be applicable for comparing a current election with another concurrent election or a historical one. For example, votes for a party candidate may be combined with votes for another candidate from the same party, such that this other candidate runs for another office in the concurrent election. Another example may involve combining the votes for the candidate in the primary runoff election with the votes for the same candidate in the recent primary election. Pairs may be created between elections for the same office that occurred during the previous election cycle and potentially had the same candidate(s). By pairing such highly correlated vote counts, precinct-level proportion may be relatively close to the statewide proportion. Precinct ranking score from this method may be combined with the previously described ranking scores from two other methods with simple geometric averaging of absolute CDF “adjustments”.

The fourth method is somewhat similar to the third one, but it may “compare” the vote counts with party affiliation registration information, instead of “comparing” vote counts only. A person of skill in the art will recognize that the ratio between these counts can differ from each other by a lot, but it does not matter. Only the proportion of these counts in the precinct relative to a statewide proportion (or, in general, the corresponding benchmark subset proportion) and the precinct size may matter. In this method, a pair may be created between candidates (or election choices in general) vote counts and party affiliation counts based on their high correlation between them.

Finally, the fifth method may be applicable to isolate and analyze precincts that have “unusual” vote percent deviations only for a specific pair of election choices. This method may require a prior knowledge about the existence of such a pair, and, therefore this method may be biased. This prior knowledge may be obtained from the previous four methods, which may detect this pair without such a bias. Since avoiding any bias at every stage of analysis is preferred for the sake of sound argument, this fifth method may be avoided.

Outlier Breadth: Statewide, Countywide, Precinct Size, and other factors: In the preceding sections, precinct results were compared with the statewide results, and the precinct outlier ranking was computed based on how much the precinct results deviated from the statewide results. Although this comparison is valid and carries some valuable information, since the precinct is part of the state, but the state can be very non-homogeneous to be a good benchmark for many of its own precincts. Therefore, we may use additional benchmarks, which may be used in conjunction with the statewide benchmark. The second benchmark may be each precinct's county. We may compute hypergeometric CDF for each precinct using its own county as a pool of votes for drawing, the same way we may do with the statewide pool of votes. For example, and without limitation, if the county contains less than 30 precincts, or at least one of these precincts has vote tally fraction of more than one-thirtieth of its county vote tally, than we may substitute the county-level CDFs for such precinct(s) in this county with the CDFs that we derived on the statewide level.

This county-level CDF may be combined with the statewide CDF for the same precinct to get combined precincts ranking score. Alternatively, we may have combined these CDFs by simple multiplication, but this approach may lead to the loss of accuracy. Thus, we may compute this combined ranking score by applying geometric average to the absolute values of CDF “adjustments” (see above for the definition of CDF “adjustment”). In order to avoid the loss of accuracy during this averaging, we may raise each of these absolute CDF “adjustments” to the power 0.5 first, and only after this we may multiply them together. Similar geometric averaging may be applied to more than two absolute CDF “adjustments”, but each of them may be raised to the power 1/“x”, where “x” is the number of these CDFs. The combined ranking score may be in the range from 0 inclusive to 0.5 inclusive, where smaller numbers (close to zero) may represent the tails, while numbers near 0.5 may represent the center of the distribution.

Even the county-level benchmark may be non-perfect, since urban areas may have different preferences relative to rural ones. Typically, urban precincts are larger than the rural ones, probably because of higher population density. Thus, we may sort all precincts in the state by the vote tally (or the number of registered voters, if the latter is available), and may use the subset of precincts of approximately the same size as a benchmark for each precinct in this subset. For example, and without limitation, for each precinct, we may use its nearest 30 (or a bit more) neighbor precincts in the sorted sequence, and the fraction of the vote tally of each precinct in this subset may not exceed one-thirtieth of the vote tally in this subsequence. Making this subset smaller than 30 (or having a relatively large precinct that is bigger than one-thirtieth of the subset) is not recommended, since it may consist of mostly outliers, and may yield false positives. Making this subset much bigger than 30 may produce almost same ranking score as the entire statewide set. This size-based precinct ranking score (CDF) may be similarly combined with the other two scores (county- and state-level). Finally, we may combine the second dimension with the third one: for each precinct, we may use a subset of 30 precincts (or a bit more, if some precincts in the subset exceed one-thirtieth vote tally of the subset) of approximately the same size, but these at least 30 (or slightly more) precincts may be drawn only from the county of this precinct, but not from the entire state. If the county contains less than 30 precincts (or one of these precincts exceeds one-thirtieth of the total tally), then we may substitute this score (CDF) of the 4th dimension with the score that we computed in the 3rd dimension, which used statewide subset of precincts of approximately the same size. If the same issue occurs on the statewide level (i.e. we have less than 30 observations or one of them has a tally weight of more than one-thirtieth), then our data set may not be granular enough to provide accurate results, because it may consist of county level granularity, while precinct level granularity is recommended.

Thus, all these four dimensions together may participate in detecting outlier precincts. Combining all four dimensions may be supplemented by analyzing each dimension separately. In fact, all four dimensions may show consistent results with the same majority of outlier precincts in the tail.

The technique above may be generalized and expanded to other sets of factors (dimensions), depending on data availability. As described above, four types of sub-populations of precincts may be used as benchmarks for their member precincts results: statewide population, county sub-population, same-tally-size sub-population, and the intersection of the latter two sub-populations. If, for example, land area and population size are available for each precinct, then CDF may be computed for each precinct within a statewide (or countywide) sub-population of precincts with approximately the same population density (the precinct count in the sub-population should have been at least 30, and each precincts tally size within its sub-population should have been relatively small, e.g. less than 3.33333%). As another example, we may create sub-populations of precincts with approximately the same amount of political campaign money spent per registered voter. If we have latitude and longitude for each precinct, we may create sub-populations of precincts within geographical neighborhood of each precinct, although county information for each precinct serves as a proxy for such benchmark grouping. In general, precincts may be benchmarked against any sub-population of relatively homogeneous precincts with similar one or multiple properties. The second condition is that the sub-population may be sufficiently large (preferably at least about 30 precincts), and each precinct in its sub-population may have relatively small fraction of size (e.g., its vote tally may be less than one thirtieth of its sub-population total vote tally).

Combining Outlier CDF Ranking Scores: In the previous section, we combined multiple CDF outlier ranking scores into one score by the equally weighted geometric mean of CDF “adjustments”. In the subsequent sections, we will introduce other methods, which produce CDF scores, and we may combine them into one scalar CDF ranking score for each precinct as well. When combining CDFs from multiple methods, we may want to make sure that the number of intermediate CDFs that we computed within each precinct is the same across methods. This way we may avoid the need for Bonferroni Correction (normalizing the most extreme CDF by the total number of CDFs that were used to derive it), although it is optional anyway. For example, if we have five election choices and we select the most extreme CDF among five computed CDF, then it may be preferable not to combine it with the most extreme CDF among all 10 pairwise CDFs from these five election choices, or with the most extreme CDF among three CDFs that we computed from three historical election choices from the same precinct. But even if we combine these methods, the only mild drawback is that those of them with more intermediate CDFs might have somewhat greater impact on the final score, since they are more likely to have more extreme CDFs. In this section, we will refine the method of combining CDF ranking scores. Since different methods may produce almost the same ranking for the majority of precincts, we may compute and assign weights to each of these CDF scores depending on how much its result differs from the results of other CDFs. In other words, we propose an alternative: geometric weighted (not just equally weighted) average of CDF scores.

For example, and without limitation, assume that for a specific election, the statewide and countywide methods from the previous section generate exactly the same ranking order for all precincts, while the precinct-size method generates somewhat different ranking order of precincts. Then the same factors seem to drive the first two methods, and thus these two methods are redundant for this particular election. In this case, theoretically we can drop either of these two methods, and combine just two remaining CDF “adjustments”. However, dropping a method is typically not a good solution, since it may contain valuable information which is not available in other methods. Instead, we need to assign weights to each method. These weights will be calibrated constants in range between zero (inclusive) and one (inclusive). Every CDF “adjustment” may be raised to the power of its weight (instead of being raised to the same equally weighing power) when used in the geometric weighted average.

Computing weights: Each method may generate one and only one sorted sequences of precincts, which may be ordered by their CDF ranking scores. We may repeat the following procedure for each pair of ordered sequences of the same set of precincts. Each precinct has size, which may be, for example, and without limitation, either vote tally or the number of registered voters. We may use this precinct size as precinct weight in later calculations. Each precinct may be characterized by beginning and end boundaries in the ordered sequence. For example, and without limitation, if the first precinct has weight 100, then its boundary offsets are 1 and 100. If the second precinct has weight 25, then its boundary offsets are 101 and 125. The end boundary of the last precinct may be equal to the state size. We may compute the midpoint offset for each precinct as well. In the above example, the midpoint offset for the first precinct is 50.5, and it is 113 for the second precinct. When we observe two different sequences of the same precincts, their midpoint offsets are different. We compute the sum of products of precinct weights by the absolute values of differences between their midpoint offsets in two sequences. Then, we need to normalize this sum to the interval between zero and one. Thus, we divide it by the product: state size multiplied by the state size, and divided by two. The state size is the sum of all its precinct sizes (or weights). The intuition behind this procedure is to measure how different these sequences are. If we compare two identical sequences, all midpoint offset absolute differences will be zeros, and we will get the “sequence similarity” measure zero for these sequences. If we shuffle some precincts in one of these sequences, then midpoint offset absolute differences will be non-zeros, and our “sequence similarity” measure will be positive, but below one. Finally, we may maximize the “sequence similarity” measure at one, if we have all precincts of size one, and we set the second sequence in the inverse order of the first one.

As described above, we have computed “sequence similarity” measure for every pair of sequences, which means that if we have “S” sequences from different methods, we can associate (S−1) scalars with each sequence, and we compute the sums of these (S−1) numbers for each sequence. Next, we compute grand total for all sequences by adding up (S−1)*S numbers, and we use this latter sum as a normalizing factor (denominator) for each sum of (S−1) sequence weights. These sequence weights may be used as powers for CDF “adjustments” for each precinct during geometric averaging.

Continuing the example above, since the statewide and the countywide methods produced the same sequences, their “sequence similarity” measures will be zero. Each of them will have the same positive “sequence similarity” measure with the precinct-size method. Assume the measure is 0.8. Thus, the grand total will be (0+0.8)+(0+0.8)+(0.8+0.8)=0.32. The respective weights will be (0+0.8)/0.32=0.25, (0+0.8)/0.32=0.25, and (0.8+0.8)/0.32=0.5. The first two weights 0.25 indicate that the first two methods were redundant, and thus they can be numerically combined by equal weights that add up to the weight of the other method. Thus, there may be no need to drop one of the methods explicitly. Instead, all methods that have very similar results with other methods may be assigned lower weight, while the methods that discover new outlier factors may preserve their relatively high weights. Alternatively, we may set all weights to the same constant one third (one over the number of methods), if we believe that each dimension (method) is equally important. This would be equally weighted geometric average of CDF “adjustments”.

Outlier Benchmarks: the Same Race, Concurrent Race, or Historical Race in the Same State; the Same Race in Other States: Above, we described a basic election setting with only one election as a benchmark. Later, we added four more dimensions for a better single election analysis. We now extend the framework even more to include other comparable elections, as follows:

1) Concurrent election (race) for another office in the same state.

2) Historical recent election in the same state.

3) The same election race in another state.

The primary prerequisite for using historic (or concurrent) election is the availability of vote counts in the majority of exactly the same precincts, which are used in the current election under investigation. If some precincts were merged or split during redistricting, then they may be excluded from the analysis (which is not advisable), or may be kept in the analysis only after their aggregation into bigger areas so that they may be mapped from one election to another. In the worst case, all precincts from the entire county may be aggregated, and the county statistics may be still used in the analysis. An alternative to the countrywide aggregation may include setting zero vote counts benchmark exclusively for these precincts without their respective counterparts from the historical election. Such a benchmark with zeros assigned to all election choices may make this election precinct identify as an outlier, and it makes sense to treat it as such.

By way of definition, as used herein, a concurrent election is the political race for another office, such as, for example and without limitation, US President, US Senate, Attorney General. Typically, two major parties may be represented in these races. As described above, we may construct three pairs of vote groups: Democratic, Republican, and “Other Parties”. Note that these pairs may be constructed between highly correlated groups of votes with optional user-provided lower boundaries for such correlation statistic. In fact, we may use the correlation as the only factor for constructing these pairs of vote groups across historic or concurrent election: these pairs may be selected based on the highest positive correlation between them. In this case, we may use any historical or concurrent election as a benchmark, since we may be pairing vote groups quantitatively, but not categorically. Pairing election choices between historical or concurrent elections or with party affiliation counts (later called “benchmark” counts) may require computation of weighted Pearson correlations between all pairs and selection of only the ones with the highest correlations. Since the grand total counts (like statewide historical tally or voter registration total with all party affiliation counts) are likely to be different from the current election statewide tally, just for the purposes of correlation computation all counts on the “benchmark” side in this correlation may be scaled to equate these grand totals. After scaling, the weighted correlation may be computed between the precinct-level ratios of each election choice vote counts to the doubled tally with the same precinct ratios of each election choice vote count in the historical or concurrent election to the same doubled vote tally (which equals to the scaled historical or concurrent election vote tally). Similarly, party affiliation fractions relative to the scaled registration counts (which are now the same as the current election vote tally counts) may be used in correlation computations. The weights are the ratios of each precinct's vote tally (from both the current election and the scaled benchmark election count or party affiliation count) to the doubled grand total vote tally. After pairs are determined in preliminary stage, we may run the pairwise CDF computation for each precinct, and then may select the most extreme precinct CDF ranking score out of these multiple (up to three in our example) pairs for each precinct in the current election. During this computation, we may use up to four (or more) methods for calculating outlier breadth described above.

Finally, we may combine these precinct ranking scores derived from the concurrent election with the precinct ranking scores derived exclusively from the current election, which are defined in methods 1 and 2 in the Outline Score Computation Methods section described above. An example of a recent historical election may be either an election with the same candidate(s) or an election for the same office. For example, a primary election may be followed by a runoff election, which may be followed by the general election with the same candidate. The runoff election may be benchmarked against the primary election, while the general election may be benchmarked against any of the above. In another example, the current election for a particular office may be benchmarked against the old election for the same office from the previous cycle. Similar to the concurrent race case, we may create highly positively correlated pairs of election choices from both elections. Then we may perform similar CDF computations on the state, county, and precinct size set levels (as well as others), and may combine the resulting CDFs scores with the ones computed in the other methods described earlier.

If we detect outliers within the current election only (i.e. based on the same election benchmark subsets only), we may still get several precincts with extremely unusually high support for an election choice, while this support is fully legitimate. Such outlier may be audited and then may be explained as a cluster of specific political interest. However, these precincts are not supposed to be detected as outliers against historical or concurrent races, or else they may require additional scrutiny. Similarly, they are not supposed to produce extreme turnouts or show discordance with party affiliation statistics, as will be shown below. When historical election benchmarking produces an outlier, for example, and without limitation, the outlier may be caused by at least one of the following reasons: the vote percent for one of the election choices in the current election may have changed drastically relative to the one in the highly correlated election choice from the historic election (while precinct vote tally may have stayed approximately the same); vote tally may have increased drastically in this election in this precinct (relative to the historical election in the same precinct) with unusually high vote percent (relative to other precinct in the benchmark from both current and historical elections) for one of the election choices. Both reasons may merit more scrutiny in the audit.

Suppose that we want to treat an outlier precinct as if it is valid and legitimate, because it was audited and certified recently. For example, and without limitation, a cluster of unusually high political support in a precinct for an election choice may be explained after close analysis. Alternatively, we may have concluded that this outlier precinct in one method (e.g. statewide benchmarking) is not suspicious because it is not an outlier in another method (e.g. historical benchmarking). One approach may be to combine CDF scores from these multiple methods for all precincts, as described in another section. Alternatively, such outlier precinct may be excluded from the Tail and moved from the Tail to the Head, and its position in the ordered Head subsequence may be random with uniform distribution. Some other most suspicious precinct(s) from the Head's boundary may be pushed to the Tail in this case. In the boundary case, when the size of all such excluded precincts exceeds the size of the Head, we may shift the cutoff point, and the Tail size may be reduced to accommodate increased size of the Head. If the fully audited and legitimate precinct happened to be located in the Head, then it may be moved from its CDF-based computed position in the Head to a random position in the Head. Thus, the Head segment of the plot may be a bit flatter. If we mark all precincts as “audited”, then the Tail will shrink to size zero, and the Head may contain virtually flat cumulative curves.

If precincts cannot be mapped between the current and historical (or even concurrent) election, then an alternative method may be used. Instead of aggregating unmapped precincts, we may use the following procedure for counties with unmapped precincts (counties with mapped precincts we can still use the methodology described in this section earlier):

1) Sort precincts in both the current and the benchmark election results in such a county by vote tally.

2) Scale up or down the vote tally in the benchmark county to equate its tally with the tally in the same county for the current election. All precinct-level vote count aggregates for each election choice are scaled by the same factor.

3) Re-partition the ordered sequence of scaled precincts in the benchmark county into a sequence of pseudo-precincts, which would have exactly the same tally as precincts in the ordered sequence of this county in the current election in the same position in the sequence. This procedure will require splitting and/or merging adjacent scaled precincts in the benchmark election. The votes for each election choice are split or merged proportionally. Eventually, both the benchmark and the current election sequences for this county will have one-to-one pairwise mapping for all their precincts, and these precincts will have the same vote tally. Round all vote counts to the nearest integer in all benchmark precincts in this county.

4) Apply the same methodology that was described at the beginning of this section, since now we have mapping between precincts.

This method of sorting, scaling, slicing/merging, and mapping allows approximate validation even for counties without precinct mapping between elections.

Another way of benchmarking may be to compare states in the same race on the same election date. If two or more states hold concurrent elections with the same election choices (at least the same major election choices), then their sets of precincts may be merged into a superset for comparative analysis across states. When multiple states are processed this way, the Tail of this merged superset sequence may have disproportionately higher representation from one of the states relatively to the other ones, when compared with the Head. For example, we merge two sets of precincts from two states, such that one of them (State “A”) has twice as high vote tally as the other one (State “B”). If they were homogeneous, then we would expect that the Tail (and the Head) will have twice as high vote tally from the State's “A” precincts as the vote tally from State's “B” precincts. However, if we observe that the vote tally of precincts in the Tail may be the same for both States (accordingly, the Head will have disproportionate vote tallies for 2 States in the other direction), then we can conclude that State “B” results are more “suspicious”, i.e. outliers have a bigger impact on the results in the State “B” than in the State “A”.

Outlier Subset Slicing: Vote Counts and Voter Registration Counts: Above is described a basic election data set that includes only vote counts for all election choices, which are used to derive vote tally. Sometimes, we have additional precinct level statistics: voting age population (VAP), vote-eligible population (VEP), registered voter counts, or even party affiliation counts. These additional data make the analysis results even richer.

When we have voter registration, then all earlier described methods still hold, but the difference may be that we introduce another groups of votes, which we can call “registered voters who did not vote”. The frequently use notion of “voter turnout” fits nicely with this artificial group: when turnout is higher, this group constitutes lower percent. Thus, with this new group of votes, we can analyze turnout outliers as well.

Obviously, instead of using “vote tally” counts, we switch to using “voter registration” (or even VEP or VAP) counts in this setting. Note that ballot stuffing may be especially evident when we get some precincts with very high support just for one election choice and very low percent of “registered voters who did not vote”. This is like “vote flipping” between them, rather than “vote flipping” between two actual election choices. Similarly, “registered voters who did not vote” may be benchmarked between concurrent of historical races. This way we can detect potentially illegal voter registration, if we get unexplainable surge in recent new registration with another surge of support for a particular election choice. Another extension may be using “voting-eligible population” instead of “vote tally”. In this case, we will have not only “registered voters who did not vote” group, but also “unregistered voting-eligible residents” group for each precinct. If we run separate analysis, the outliers in the latter group may point to the subset of suspicious precincts with likely violations in the voter registration process.

During outlier detection in election results, CDFs for “registered voters who did not vote” (and “unregistered vote-eligible residents”, and “vote-ineligible residents”) should not be considered in calculations, but they may be just plotted. Instead, only the real votes cast for various election choices may be used for identifying the most suspicious election choice in each precinct. It does not mean that these counts cannot be used in a separate registration-related outlier analysis (which may include party affiliation counts as well), which uses the proposed methodology in almost the same way.

Alleged voting or registration disenfranchisement of some groups of voting eligible citizens may be detected with the same method, which we described earlier. Let's assume that every registered voter has an opportunity to associate himself or herself with any of these three groups: “non-minority”, “minority”, and “no association” (the latter may be assigned to a registered voter by default). Each of three groups may be subdivided into two subgroups in each election: “voted registered voter” and “non-voted registered voter”. All these counts may be collected during any election. We may have additional precinct-level counts for all of these three groups: “non-registered vote eligible population”, in which case the total number of sub-groups is nine (or seven, if the latter group cannot be subdivided into three groups). All these precinct-level counts (for either 6, 7, or 9 sub-groups) may be processed in a similar way as we processed vote counts for each election choice. All rules and various benchmarks are applicable to these groups as well. For example, we can assign the most extreme CDF score to each precinct based on CDF scores from three pairs (one for each group): “voted voter” versus “non-voted registered voter” sub-groups. If we have counts on the non-registered vote eligible population for each population group, then we can similarly assign the most extreme CDF score to each precinct based on CDF scores from three pairs (one for each group): “registered voter” versus “non-registered vote eligible potential voter” sub-groups. We may plot “vote-ineligible residents” counts as well for more insights, if VAP in addition to VEP counts are available. Thus, the precincts with potentially extreme cases of disenfranchisements may be identified and audited individually. In this case, the cumulative plot will highlight the precinct outliers and their impact on the voter turnout anomaly among different groups of population. The benchmark may be statewide, countywide, etc. (as described earlier). If the “minority” group is really extremely disenfranchised somewhere, then we can expect to have the cumulative curve of “minority votes” or “registered minority voters” will slope downwards in the right side of the plot. Note that disenfranchisement may be not reflected by the lower turnout or registration ratio in one group relative to another, since some of these groups may be inherently less politically active. Instead, disenfranchisement may be reflected by the outliers, i.e. by an unusually (abnormally and suspiciously) big deviation for a particular group within a precinct from the expected (benchmark) level of political activity for this group within a bigger sample (subset of precincts).

Outlier Subset Slicing: Vote Counts and Party Affiliation Counts: If we happen to have party affiliation information, then we may have yet another invaluable source of data for benchmarking. First, it may be analyzed separately from the elections with exactly the same methodology. The difference may be that the vote tally counts may be replaced with the voters' registration counts, and the vote counts for individual election choices may be replaced with the party affiliation counts, for example “Democrats”, “Republicans”, “Other Party Affiliation”, and “Unaffiliated”. In addition, the party affiliation data may be combined with the vote counts as well. Specifically, we may create three pairs of groups for the same election within each precinct and within its benchmark:

1) Vote count for a Democratic candidate combined with the number of registered Democrats;

2) Vote count for a Republican candidate combined with the number of registered Republicans;

3) Vote count for all other candidates and invalidated ballots combined with the number of registered voters with some other party affiliation and unaffiliated registered voters.

When we compute hypergeometric CDF for each of these groups (as defined basic election setting section above) and use Method #4 from the Outline Score Computation Methods section above together with all methods from the Outlier Breadth section above, we may discover that in some precincts some election choices get “unusually” high support, which contradicts with the party affiliation statistics in these precincts and “typical” ratios of either of these two counts in the benchmark. All precincts ranking CDFs from this party affiliation benchmarking method may be combined with the CDF scores derived from other methods, as described earlier.

Methods of Outlier Detection and Data Availability: In the previous sections, we described in detail various features of exemplary models for election fraud analysis. Referring now to FIG. 4, the sequence of steps for computing precinct outlier analysis and ranking, according to an embodiment of the present invention, is summarized. We may compute this ranking as a geometric (optionally weighted-) average of many hypergeometric CDFs rankings (absolute value CDF “adjustments”). The number of CDFs may depend on data availability. The model may exhibit a high degree of flexibility: it may advantageously produce meaningful and useful results with limited input data, and it may advantageously produce high quality results with abundance of input data. The more effort put into data collection, the more accurate the results of the model. The model may not “prove” the existence of fraud; instead, it may detect the most suspicious precincts that merit audit.

In summary, the following are described above:
why we use hypergeometric, but not a normal distribution.
why and how we detect and sometimes exclude outliers during computation of two population parameters for the hypergeometric distribution.
why and how we always use outliers from both tails.
that, if voter registration information is available, we may use voter registration counts instead of vote tally.
that, if we have party affiliation information, then the step-by-step procedure may be applied to it independently from the election results (even if merely total registration counts are available, they may be analyzed with the same procedure relative to the respective historical registration counts).
that, if we have just registration counts, then they may be benchmarked against historical registration independently from election results.
that every time we refer to CDF ranking score combining, we imply that these CDFs' “adjustments” are geometrically averaged.
the notions of CDF “base” and CDF “adjustment”.

Referring now to FIGS. 3 and 4, the step-by-step methodology for creating a sorted sequence of precincts, according to an embodiment of the present invention, may be described as follows:

1) Receive data set comprising precinct level data, such as vote counts, and optionally VAP, VEP, registration, and party affiliation counts (Block 310), as well as other statistics than may be used to precinct grouping for benchmarking purposes, and these statistics may be highly correlated (either positively or negatively) with election results. Each precinct may be assigned to one and only one county. Historical and concurrent races may be optionally available.

2) Aggregate columns for some insignificant election choices (Blocks 320, 325, 330). If historical or concurrent races will be used for benchmarking, then aggregate election choices to the point when they may be paired with these races. Row aggregation may be typically unnecessary, and more granular data (e.g. precinct level) may be more preferable than less granular data (e.g. county level), since the main purpose of the methodology may be to show as precisely as possible where to audit the results. If historical election contained redistricted precincts, then they may need to be aggregated to assure direct territorial mapping to the current election aggregates, up to the county level. Dropping precincts from analysis may be possible as the model is robust enough to handle it, but doing so may not be advisable, since the precincts both contribute to the distribution and may be outliers themselves.

3) At Block 420, apply Method 1 from the Outline Score Computation Methods section above to test for ballot stuffing and ballot dropping up to four times or more, as described in the Outlier Breadth section above (sub-populations by state, county, precinct size statewide, and precinct size countywide). Combine these multiple CDF ranking scores to get ballot stuffing/dropping intermediate precinct ranking score (Block 470), as described above.

4) At Block 430, apply Method 2 from the Outline Score Computation Methods section above to test for vote flipping up to four times or more, as described in the Outlier Breadth section above. In one embodiment of the present invention, this step may be optional (Block 415). Combine all these CDF ranking scores to get vote-flipping intermediate precinct ranking score. Combine all these uncombined CDF ranking scores with the scores from the previous test, which used Method 1 (Block 470). Use equally weighted or weighted geometric average, as described above.

5) If concurrent election race information is available at Block 425 (as defined above), apply Method 3 from the Outline Score Computation Methods section above to test concurrent cross-race outliers of highly correlated election choices up to four times or more, as described in the Outlier Breadth section above (Block 440). For example, and without limitation, such analysis may consider statewide, county level, and/or congressional district level election choices, as well as influence factors such as voting equipment type. Combine all these CDF ranking scores to get concurrent election benchmark intermediate precinct ranking score. Combine all these uncombined CDF ranking scores with the scores from the previous tests, which used Methods 1 and 2 respectively (Block 470).

6) If historical election race information is available at Block 435 (as defined above), apply Method 3 from the Outline Score Computation Methods section above to test historical cross-race outliers of highly correlated election choices up to four times or more, as described in the Outlier Breadth section above (Block 450). For example, and without limitation, such analysis may include creation of another subset with approximately the same statistic for each precinct within the first level subset, and may consider tally, registration, turnout, vote eligible population density, geographic proximity, rate of change (relative to historical election) in tally, turnout, registration, and/or other statistic. Combine all these CDF ranking scores to get historical election benchmark intermediate precinct ranking score. Combine all these uncombined CDF ranking scores with the scores from the previous tests, which used Methods 1, 2 and 3 respectively (Block 470).

7) If party affiliation information is available for the current election race at Block 445 (as defined above), apply Method 4 from the Outline Score Computation Methods section above to test vote-versus-registration outliers up to four times or more, as described in the Outlier Breadth section above (Block 460). Combine all these CDF ranking scores to get party affiliation benchmark intermediate precinct ranking score. Combine all these uncombined CDF ranking scores with the scores from the previous tests which used Methods 1, 2, 3, and 3 respectively from the Outline Score Computation Methods section above (Block 470).

After processing each precinct through these seven steps (where steps 4, 5, 6, and 7 are desirable but optional), the result after execution of Block 470 may be a single scalar number associated with each precinct. This number may be in the range between 0 and 0.5 (numbers near 0 may indicate that the precinct is an outlier), and it may be computed as a geometric (weighted-) average of absolute values of hypergeometric CDF “adjustments”, as described above. This number may be subsequently used as the primary sorting criterion for the precincts. Since some precincts might have the same the same number (although this may be very unlikely), we use the secondary sorting criterion: uniform random number between zero and one. Note that if we used only the second sorting criterion, then the right segment of the cumulative charts would be almost certainly flat.

After sorting by these two criteria, the precincts from the center of the distributions may be assembled in the left side of the sequence, while all outliers may be grouped in the right side of the sequence. For example, and without limitation, this sorted sequence may be plotted on the cumulative charts (which can have without limitations either statewide or countywide coverage), as described above. Any non-flat curve in the right segment of the chart may be cut-off and analyzed in details, as described below.

Column Plots: Percent and Marginal Contributions: Above we described how to sort precincts and construct cumulative plots for visual presentation of outliers' impact. The next step may be to cut off the outlier precincts in the right segment of this plot. Let us call these outlier set as “Tail”, while the rest of the precincts as “Head”. The cutoff point may be either pre-set based on the auditing capacity (i.e. at 10%, 5%, 1%, etc.) of the statewide vote tally (or the number of registered voters and/or VEPNAP statewide). Alternatively, it may be set at the point where a flat curve on the cumulative plot tilts upwards in the right segment of the chart. In either case, the “Tail” may be carefully studied and compared with the “Head”. Cumulative plots may have already provided information about the most suspicious election choice and the relative magnitude of the anomaly in results. For example, and without limitation, we may additionally slice the data in different dimensions to analyze this anomaly in more details. For this purpose, we will use Bar Charts, which we will carefully define and describe in a systemized way as follows.

A Bar Chart is a two-dimensional plot with finite Categories on the X axis and real numbers on the Y axis. For our purposes, the Y axis will contain percent between −100% and +100%. For each Category on the X axis, we can have one or more rectangular columns of different colors. Each of these columns will belong to one and only one Series of columns and each of these Series will have its unique color. Each Series will have the same length, one element for every Category. The ordering of columns will be the same for each Category. The width of each column will be the same, and the height will reflect the scalar percent values for its Series element. Each group of Columns may be centered around equally spaced Category ticker on the X axis. Each column starts at Y value of 0%, and it spans either up or down, depending on the sign of its corresponding value. The Categories' names are printed below the X axis next to their tickers. The series names are listed in the right part of the plot with their color information. The Y axis has numeric scaling, and each column has its numeric value printed next to it. Each Bar Chart will have a Title, which will define the coverage (or scope) of this Bar Chart. Multiple Bar Charts may be generated for multiple sub-scopes, for example one for each county.

The number of Categories may be capped at a fixed number, such as 7. The number of Series may be capped at a fixed number, such as 5. If the number of data points exceeds these caps, then only the Categories or Series with the biggest percentages are plotted (details to be provided later in this section). The Categories are sorted in descending order based on the maximum absolute values from each Series element in this Category. There are two types of Bar Charts: absolute contribution percent and marginal contribution percent.

The “absolute contribution percent” may be the votes (voters) percent for a Category in each Series relative to votes (voters) in all Categories in the same Series. For example, if we have counties in the Series and election choices in the Categories, then the columns will contain the number of votes for each election choice (Category) divided by the total vote tally in the respective county (Series). If the number of counties is large, then only 5 of them with the largest support for any election choice may be displayed in the Bar Chart.

The “marginal contribution percent” may be the votes (voters) marginal contribution percent of a Series to a Category votes (voters) percent relative to all Categories in all other Series. For example, if we have counties in the Series and election choices in the Categories, then the columns will contain the change in the election choice support attributed to adding this county to the pool of all other counties in the state. Specifically, we compute it as a difference between two ratios: the number of votes for this election choice divided by the statewide vote tally minus the number of votes for the same election choice in all counties except the one is the Series divided by the statewide vote tally less the vote tally of the same county in the Series. Marginal contribution shows how valuable the county for the election choice. Marginal contribution depends not only on the support percent in the county, but also on the size of the county.

Let us define eight exemplary types of “absolute contribution percent” Bar Charts that we may use in our analysis:

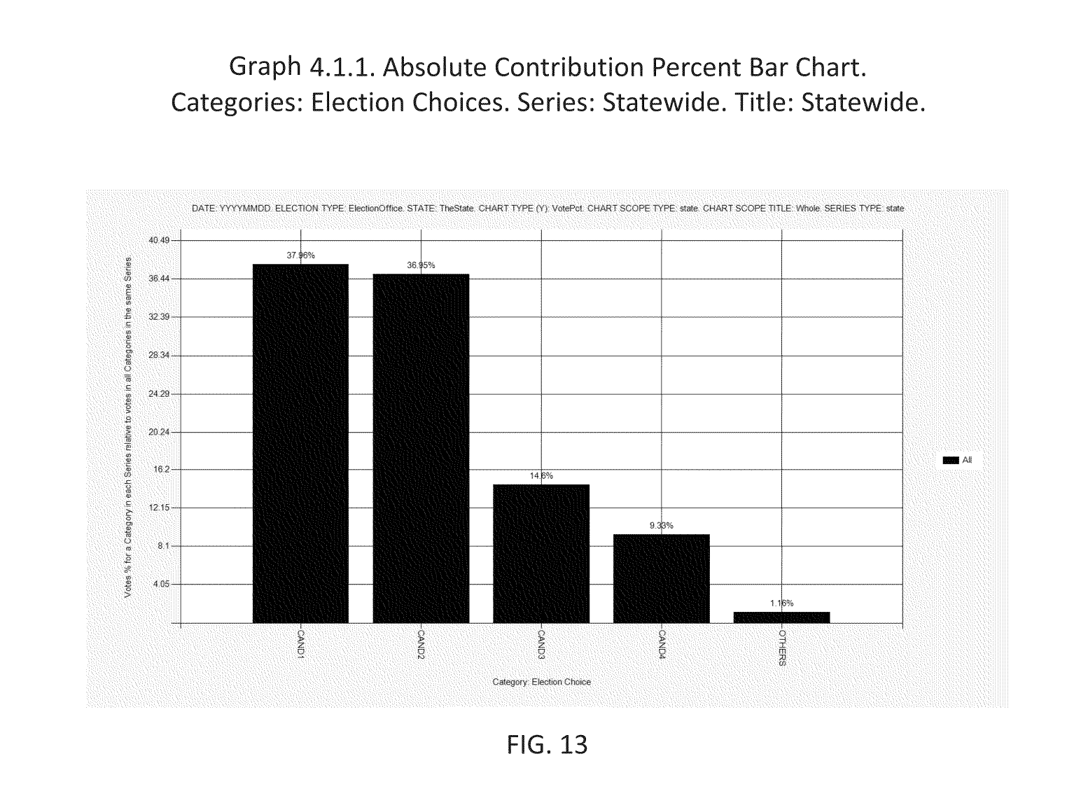

1) Graph 4.1.1. Category: election choices. Series: statewide (one series for both Head and Tail). (FIG. 13) Title: statewide (all counties in one chart). This Bar Chart provides visual comparison of statewide percent of votes for the major election choices. Most attention may be paid to the leading choices and the difference in vote percent between them.

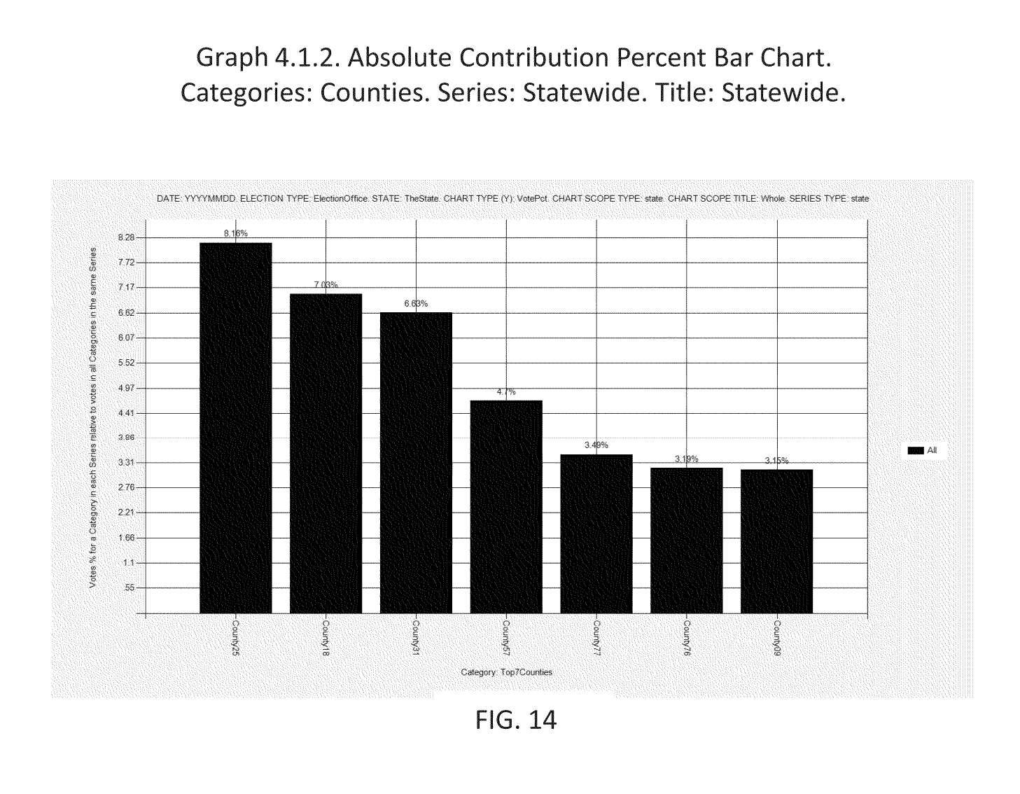

2) Graph 4.1.2. Category: counties. Series: statewide (one series for both Head and Tail). (FIG. 14) Title: statewide (all election choices in one chart). This Bar Chart provides visual comparison of vote tally percent in the largest counties relative to the statewide vote tally.

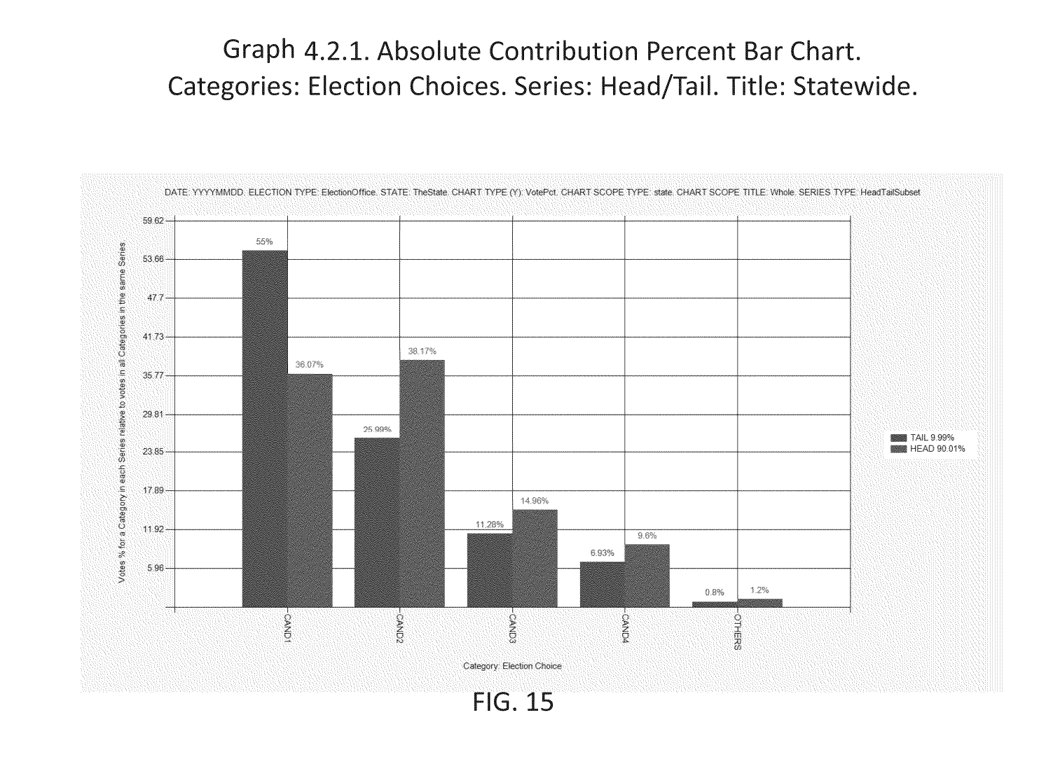

3) Graph 4.2.1. Category: election choices. Series: Head and Tail (two series). (FIG. 15) Title: statewide (all counties in one chart). This Bar Chart provides visual comparison of vote percent for the major election choices as a ratio of votes for each election choice in the Tail divided by all votes cast in the Tail versus the similar ratio in the Head. The most suspicious election choice may be the one that has the biggest positive difference between the Tail and the Head. In fact, most other election choices are likely to have negative differences.

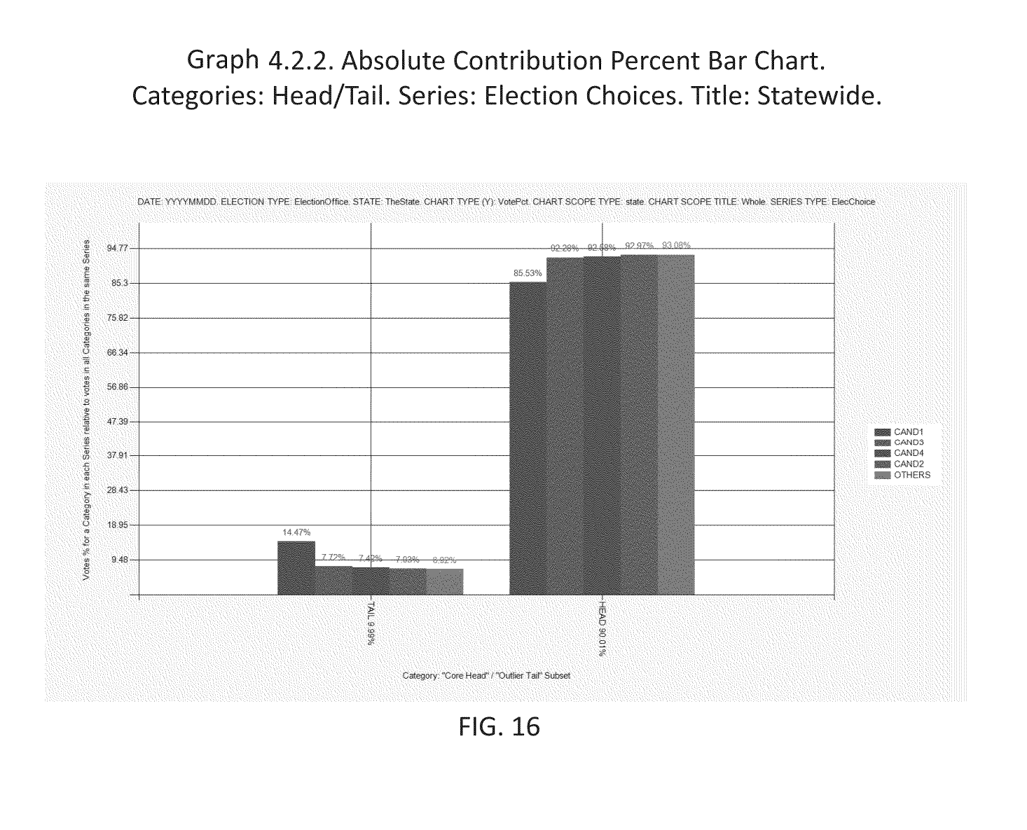

4) Graph 4.2.2. Category: Head and Tail (two categories). Series: election choices. (FIG. 16) Title: statewide (all counties in one chart). This Bar Chart provides visual comparison of vote percent for the major election choices as a ratio of votes for each election choice in the Tail divided by all votes cast for the same election choice statewide versus similar ratios for other election choices. If Tail to Head total vote tally ratio is, say, 1-to-9, and an election choice has a higher (and the highest) ratio, then this election choice may be the most suspicious one.

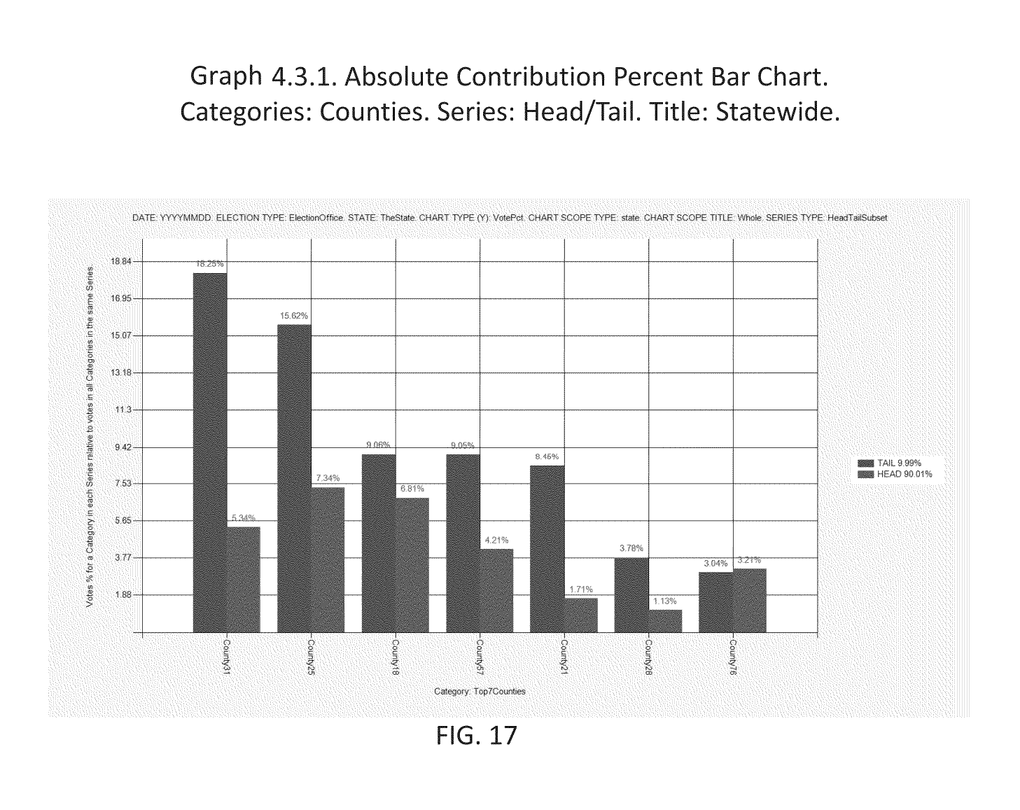

5) Graph 4.3.1. Category: counties. Series: Head and Tail (two series). (FIG. 17) Title: statewide (all election choices in one chart). This Bar Chart provides visual comparison of vote tally for the counties as a ratio of tally in each county in the Tail divided by the total tally in the Tail versus the similar ratio in the Head. The most suspicious counties are the one that have the biggest positive difference between the Tail and the Head.

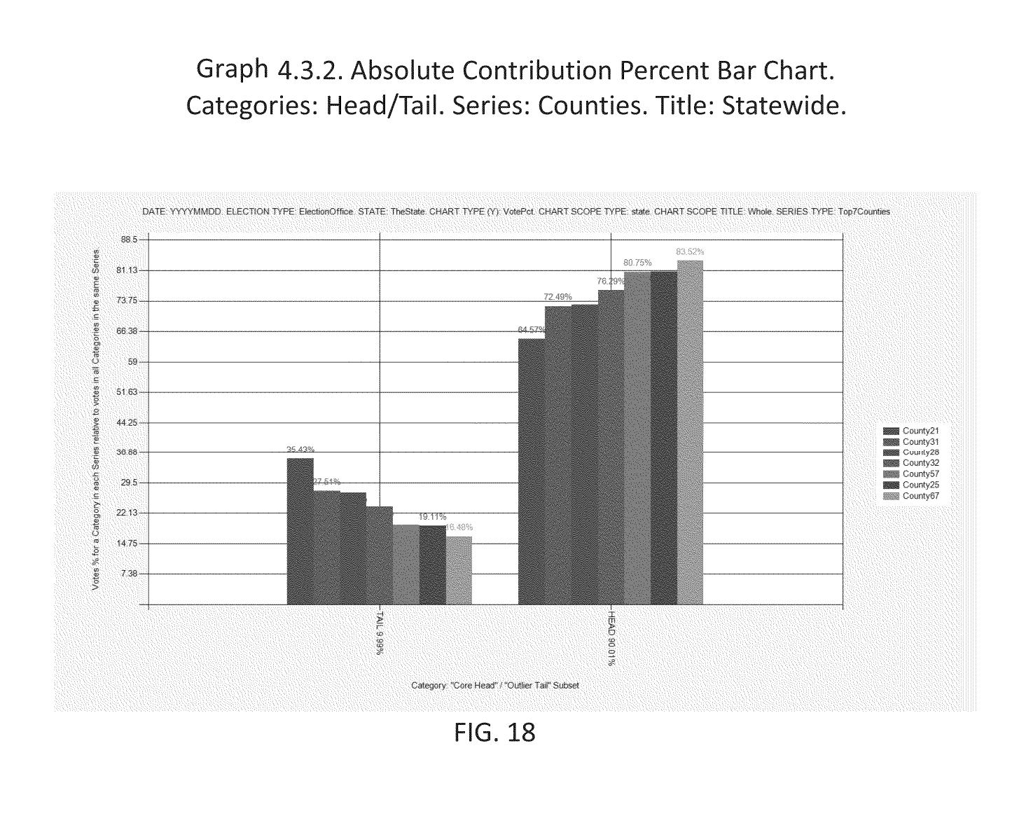

6) Graph 4.3.2. Category: Head and Tail (two categories). Series: counties. (FIG. 18) Title: statewide (all election choices). This Bar Chart provides visual comparison of tally for the counties as a ratio of vote tally for each county in the Tail divided by total tally for the entire same county versus similar ratios for other counties. If Tail to Head total vote tally ratio is, say, 1-to-9, and a few counties have much higher ratios, then these counties are the most suspicious ones.

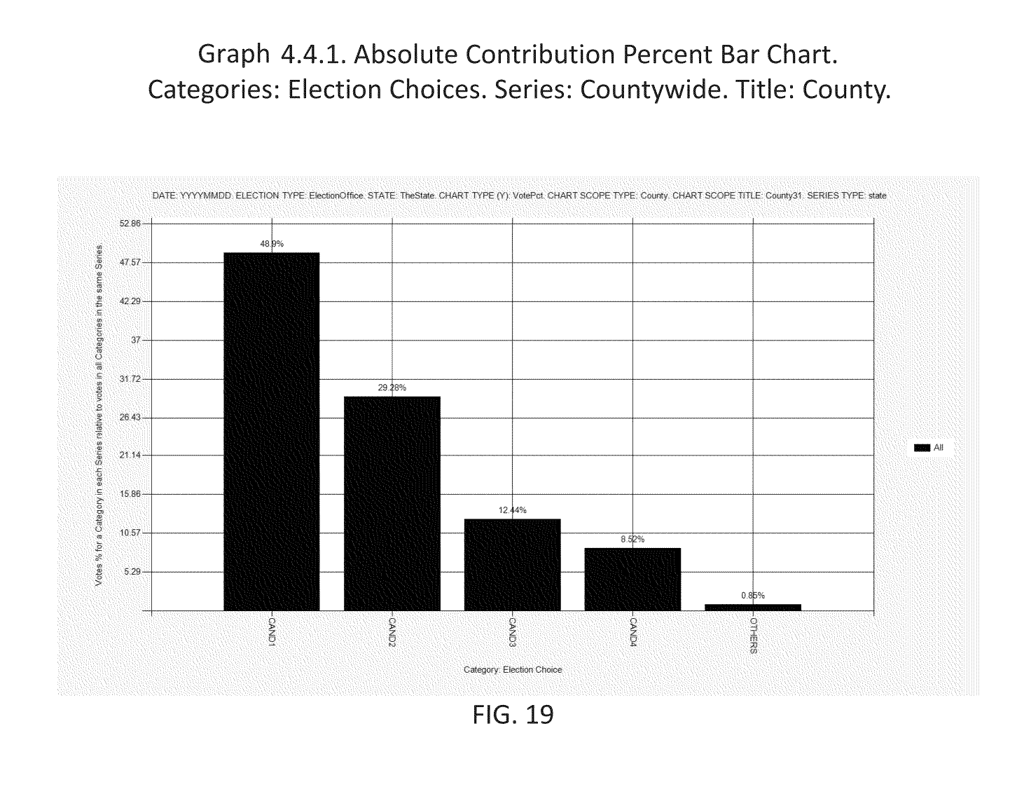

7) Graph 4.4.1. Category: election choices. Series: countywide (one series for both Head and Tail). (FIG. 19) Title: countywide (a chart for each county). This Bar Chart provides visual comparison of vote percent for the major election choices as a ratio of votes for each election choice in the county divided by all votes cast in the county versus the similar ratio for other election choices in the same county. Each county has its own chart.

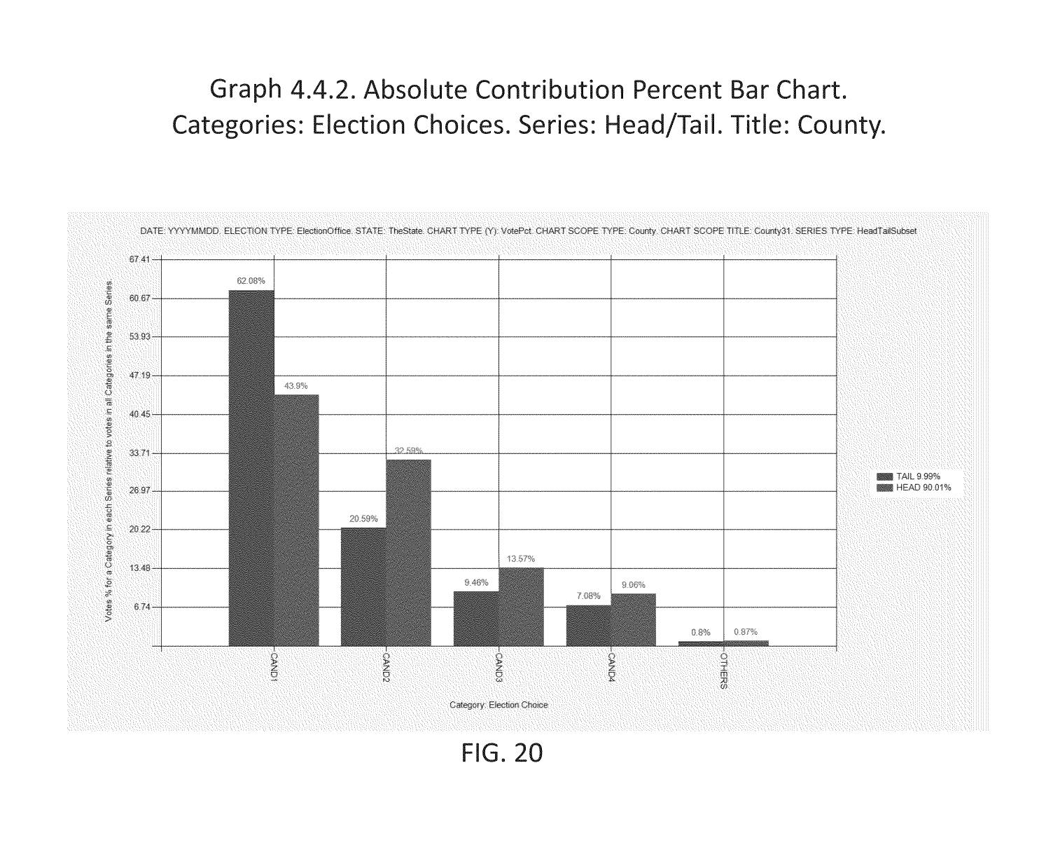

8) Graph 4.4.2. Category: election choices. Series: Head and Tail (two series). (FIG. 20) Title: countywide (a chart for each county). This Bar Chart provides visual comparison of vote percent for the major election choices as a ratio of votes for each election choice in the county Tail divided by all votes cast in the county Tail versus the similar ratio for the Head in the same county. Each county has its own chart.

Bar Charts (1), (2), and (7) provide basic summary and statistics about election results. Bar Charts (3) and (4) identify suspicious election choices. Bar Charts (5) and (6) identify suspicious counties. Bar Chart (8) provides county-level details for all (including the most suspicious) counties for each election choice, including the most suspicious ones.

Let us define eight exemplary types of “marginal contribution percent” Bar Charts that we may use in our analysis:

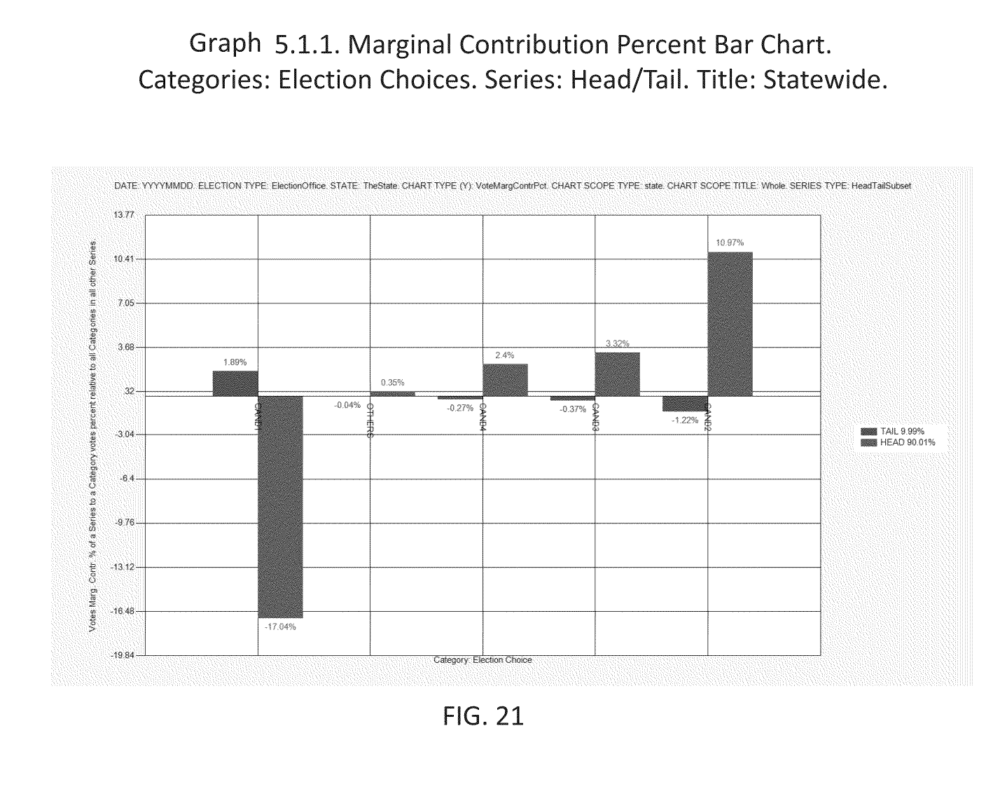

1) Graph 5.1.1. Category: election choice. Series: Head and Tail. (FIG. 21) Title: statewide (all counties). This Bar Chart shows the change of vote percent for each election choice after adding the Tail (or the Head) to the Head (to the Tail respectively) statewide. Even a small Tail (e.g. 5% of statewide vote tally) can make a change in the ranking of election choices, when the outlier precincts in the Tail swap their ordering in statewide support. Often only one election choice may have a positive marginal contribution of the Tail, while all other election choice will have the negative ones. For example, if the vote percent of an election choice statewide is 30%, but, without the Tail, it drops to 26%, then this election choice will have positive 4% marginal contribution of the Tail. The most suspicious election choices are the ones with the largest marginal contribution on the Tail.

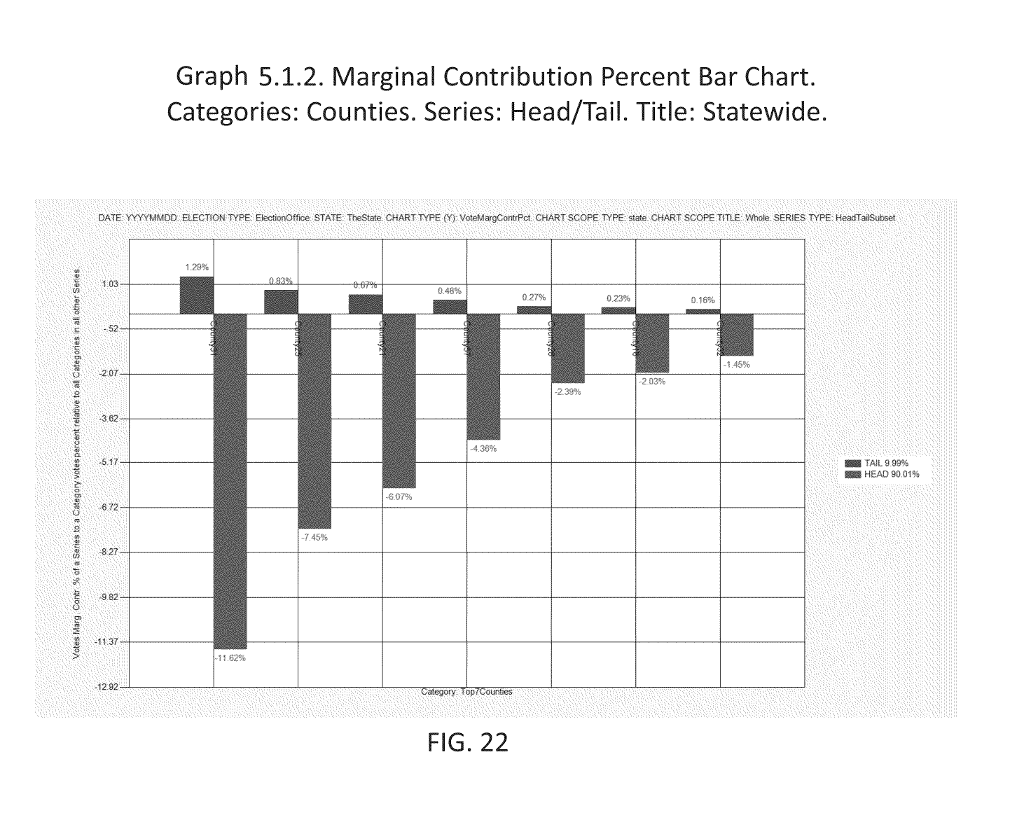

2) Graph 5.1.2. Category: each county. Series: Head and Tail. (FIG. 22) Title: statewide (all election choices). This Bar Chart shows the change of vote tally percent for each county after adding the Tail (or the Head) to the Head (to the Tail respectively). For example, if the vote tally fraction of a county in the statewide tally is 7%, but, without the Tail, it drops to 4%, then this county will have 3% marginal contribution from the Tail. The most suspicious counties are the ones with the largest marginal contribution on the Tail.

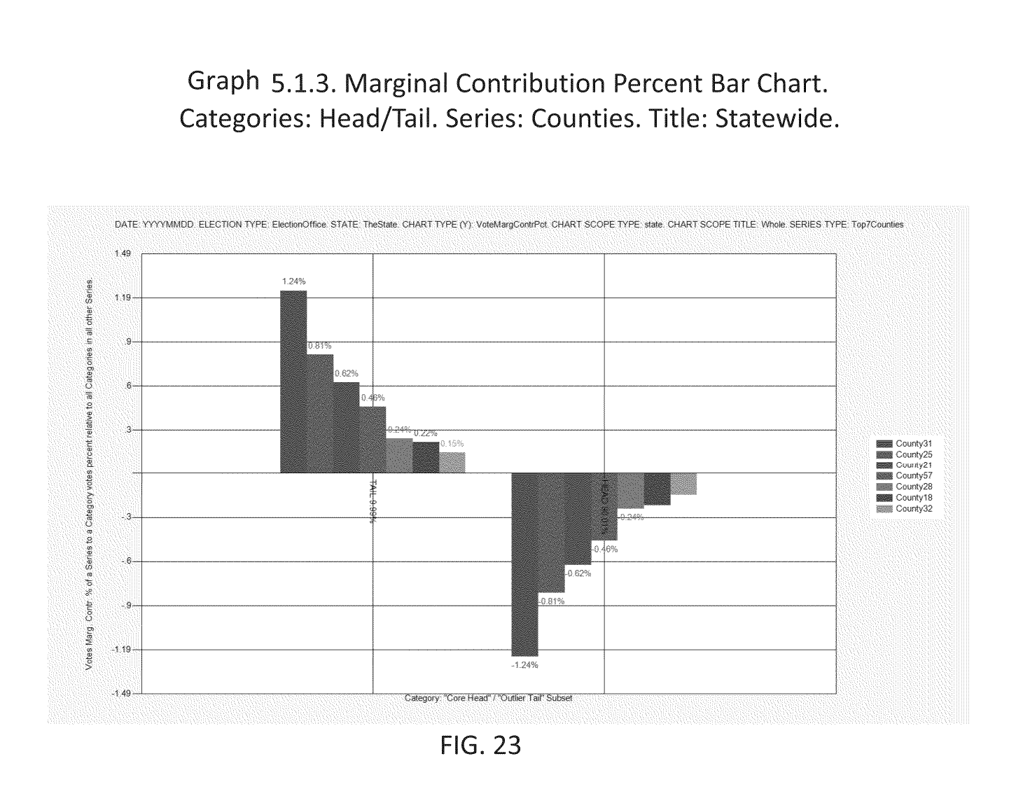

3) Graph 5.1.3. Category: Head and Tail. Series: counties. (FIG. 23) Title: statewide (all election choices). This Bar Chart shows the change of vote tally percent for the Tail (or the Head) after adding a county to all other counties. For example, if the vote tally of the Tail in the statewide tally is 10%, but, without one county, it drops to 9%, then the Tail will have 1% marginal contribution from this county. The most suspicious counties are the ones make the largest marginal contribution to the Tail. Note the difference from the previous Bar Chart: this one shows how the county influences the Tail results, while the previous one shows how the Tail affects the county results.

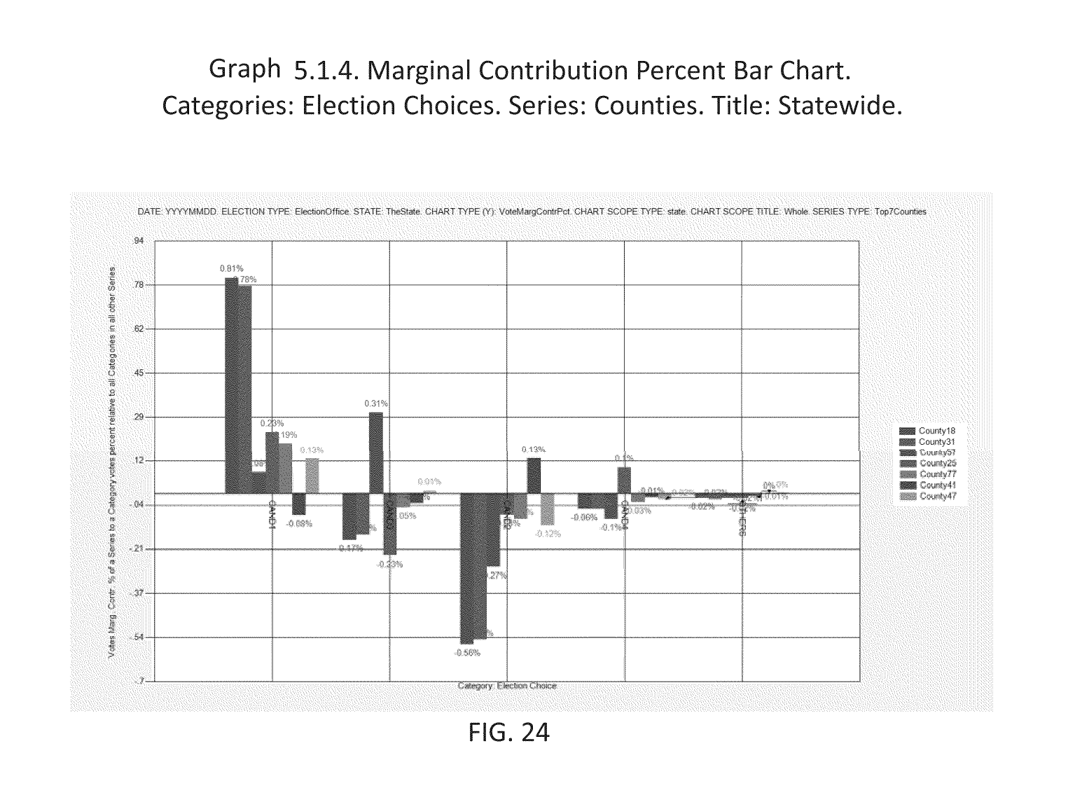

4) Graph 5.1.4. Category: election choices. Series: counties. (FIG. 24) Title: statewide (Head and Tail combined). This Bar Chart shows the change of vote percent for each election choice after adding a county to all other counties statewide. For example, if the vote percent of an election choice statewide is 30%, but, without a particular county, it drops to 26%, then this election choice will have positive 4% marginal contribution from the county. This Bar Chart merely shows an importance of each county to each candidate, and it does not identify suspicious election choices or counties.

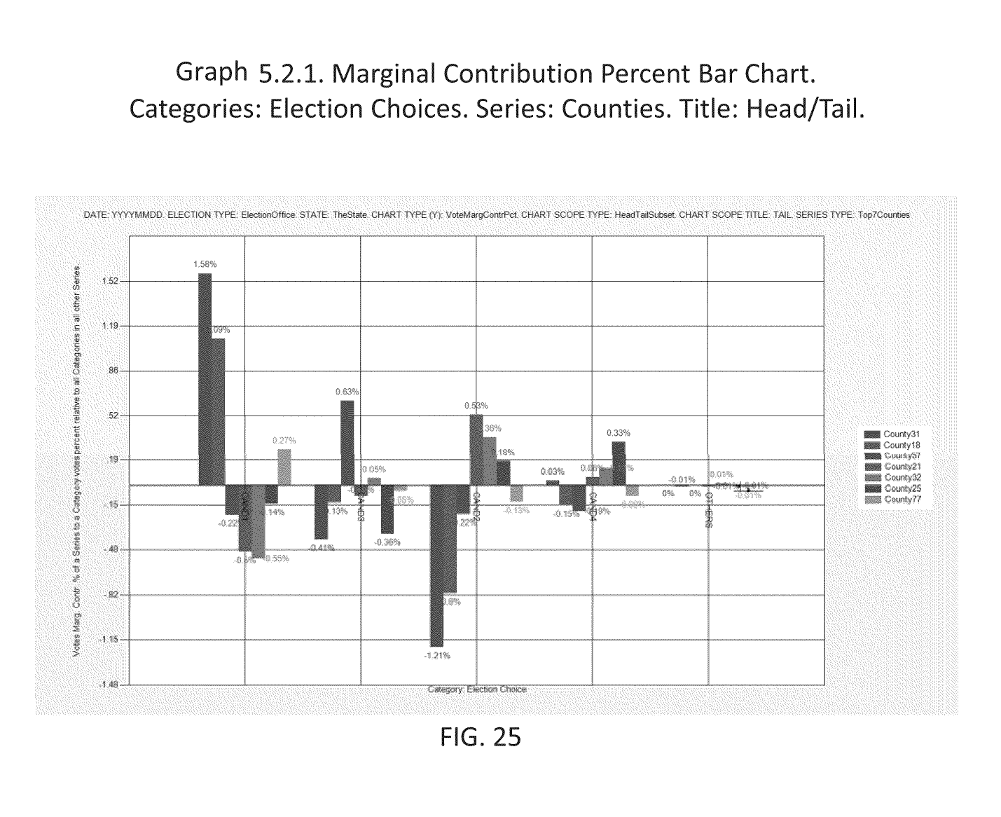

5) Graph 5.2.1. Category: election choices. Series: counties. (FIG. 25) Title: Head and Tail. This Bar Chart shows the change of vote percent for each election choice after adding a county to all other counties either in the Tail or in the Head only. For example, if the vote percent of an election choice is 40% in the Tail (20% in the Head), but, without a particular county, it drops to 37% in the Tail (increases to 22% in the Head), then this election choice will have positive 3% marginal contribution of the county for the Tail (negative 2% marginal contribution of the county for the Head). Large positive or negative marginal contribution of a county to any election choice in the Tail makes this county suspicious.

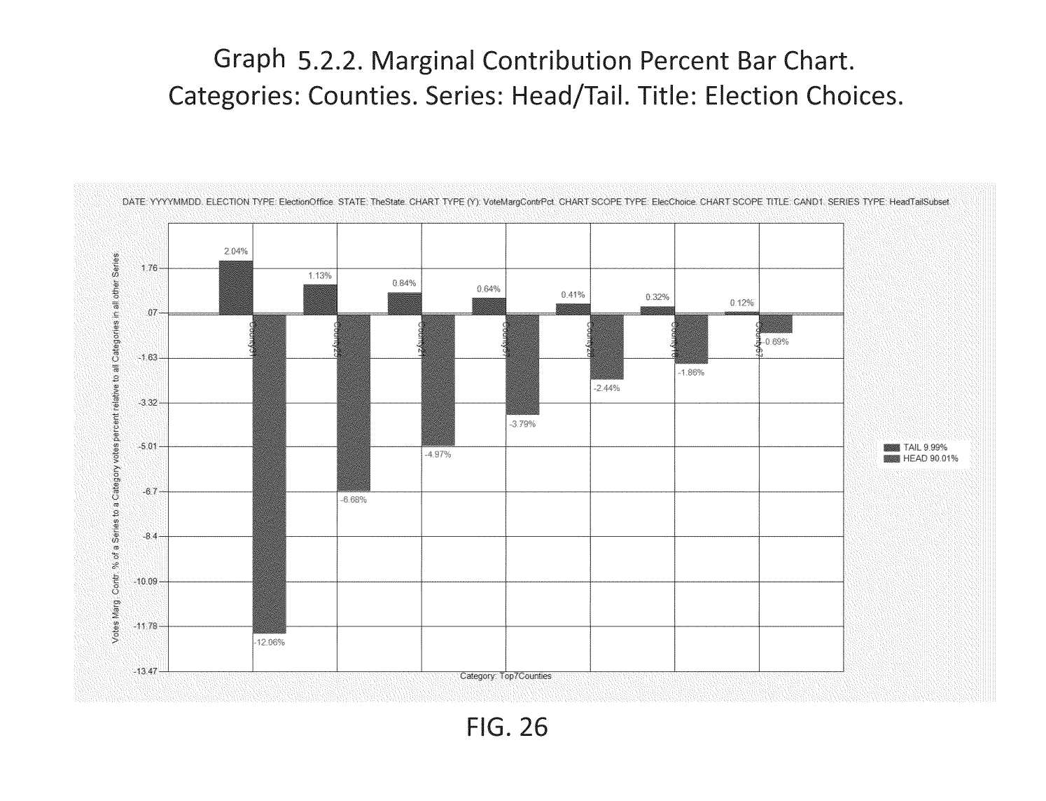

6) Graph 5.2.2. Category: counties. Series: Head and Tail. (FIG. 26) Title: election choices. This Bar Chart shows the change of election choice-specific vote count percent for each county after adding the Tail (or the Head) to the Head (to the Tail respectively). At this point, we already know the most suspicious election choice. Thus, we select the Bar Chart for this election choice. For example, if the vote count fraction for this election choice in a county is 7% relative to the statewide count, but, without the Tail, it drops to 4%, then this county will have 3% marginal contribution from the Tail for this suspicious election choice. The most suspicious counties are the ones with the largest marginal contribution on the Tail.

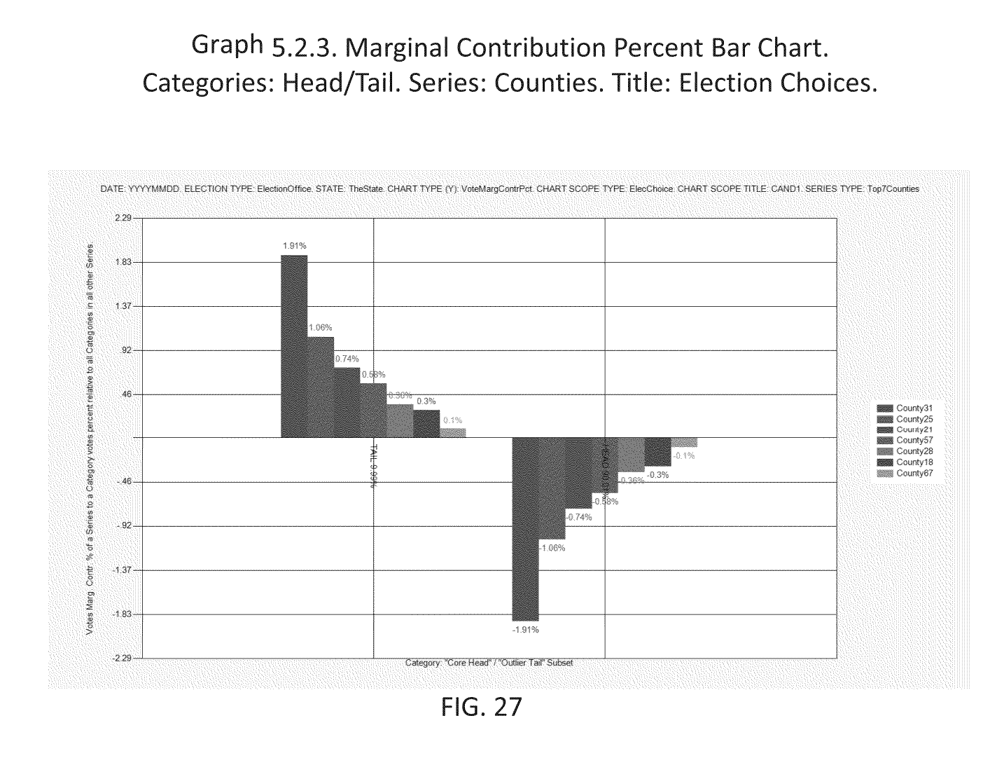

7) Graph 5.2.3. Category: Head and Tail. Series: counties. (FIG. 27) Title: election choices. This Bar Chart shows the change of election choice-specific vote count percent for the Tail (or the Head) after adding a county to all other counties. At this point, we already know the most suspicious election choice. Thus, we select the Bar Chart for this election choice. For example, if the vote count fraction for this election choice of the Tail in the statewide tally is 10%, but, without one county, it drops to 9%, then the Tail will have 1% marginal contribution from this county for this suspicious election choice. The most suspicious counties are the ones make the largest marginal contribution to the Tail. Note the difference from the previous Bar Chart: this one shows how the county influences the Tail results, while the previous one shows how the Tail affects the county results.

8) Graph 5.2.4. Category: election choices. Series: Head and Tail. Title: counties. This Bar Chart shows the change of vote percent for each election choice after adding the Tail (or the Head) to the Head (to the Tail respectively) with each county one-by-one. At this point, we already know the most suspicious counties. Thus, we select the Bar Chart for these counties. The most suspicious election choices are the ones with the largest marginal contribution on the Tail in these most suspicious counties.

Bar Chart (4) provides each county importance for each election choice. Bar Chart (5) shows similar importance of each county for each election choice in the Tail and in the Head separately. The Tail importance provides initial hints about the most suspicious counties and election choices. Bar Chart (1) identifies the most suspicious election choice(s) statewide. Bar Charts (2) and (3) identifies the most suspicious counties by showing how they influence the Tail and how the Tail affects them. Similarly, Bar Charts (6) and (7) identify the most suspicious counties, but exclusively for the most suspicious election choice(s). Finally, Bar Chart (8) confirms the most suspicious election choices in the most suspicious counties one by one.

Tail Precinct Statistics: In the previous section, we plotted Bar Charts to identify the most suspicious election choices and the most suspicious counties from the Tail. In this section, we will describe how to create tables with information about the most suspicious precincts.

Earlier we have computed a scalar precinct ranking score for each precinct. This score is between zero and 0.5, and we have cut off the outlier precincts with the smallest scores. During this score computation, we have identified the election choice that produces the most “unusual” result in this precinct. These precincts with extreme results have are presented in the tables with increasing ranking scores. Thus, the most “unusual” precincts will be on the top of the table. In order to manage the size of the table, only a fraction of the outlier precincts may be included in the table, while the rest of them from the Tail are aggregated, and included at the bottom of the table. Very small precincts (size 10 or smaller) are always aggregated at the bottom of the table. The top row of the table will contain statewide statistics for comparison purposes. Since aggregation hides many precincts from the Tail, we propose the following three types of slicing the Tail:

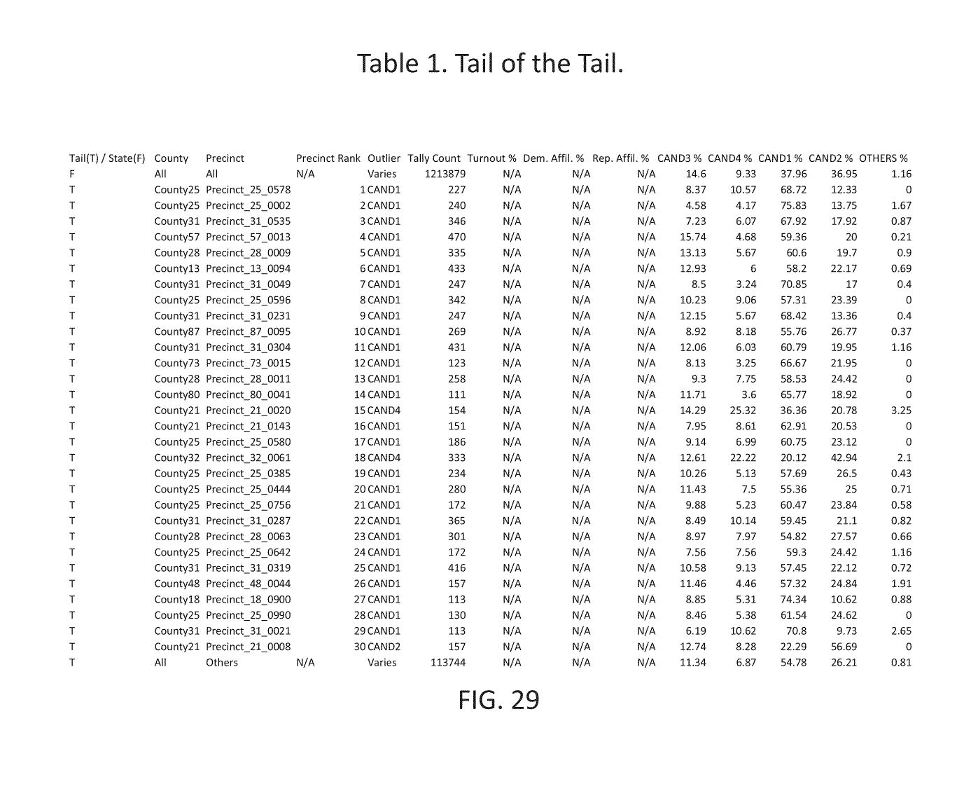

1) Table 1. (FIG. 29) Top most “unusual” precincts from the entire Tail, with the rest of them aggregated.

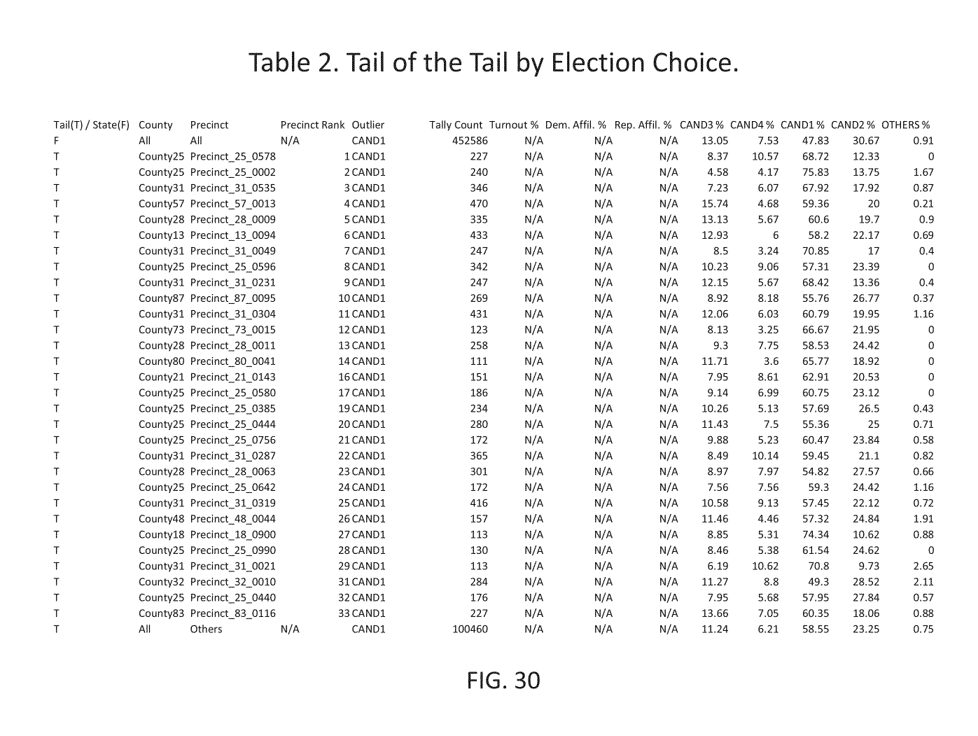

2) Table 2. (FIG. 30) Top most “unusual” precincts for the most suspicious election choice as a reason for the precinct to become “unusual”. All of them come from the Tail only as well, and the rest of them from the same subset of the Tail are aggregated.

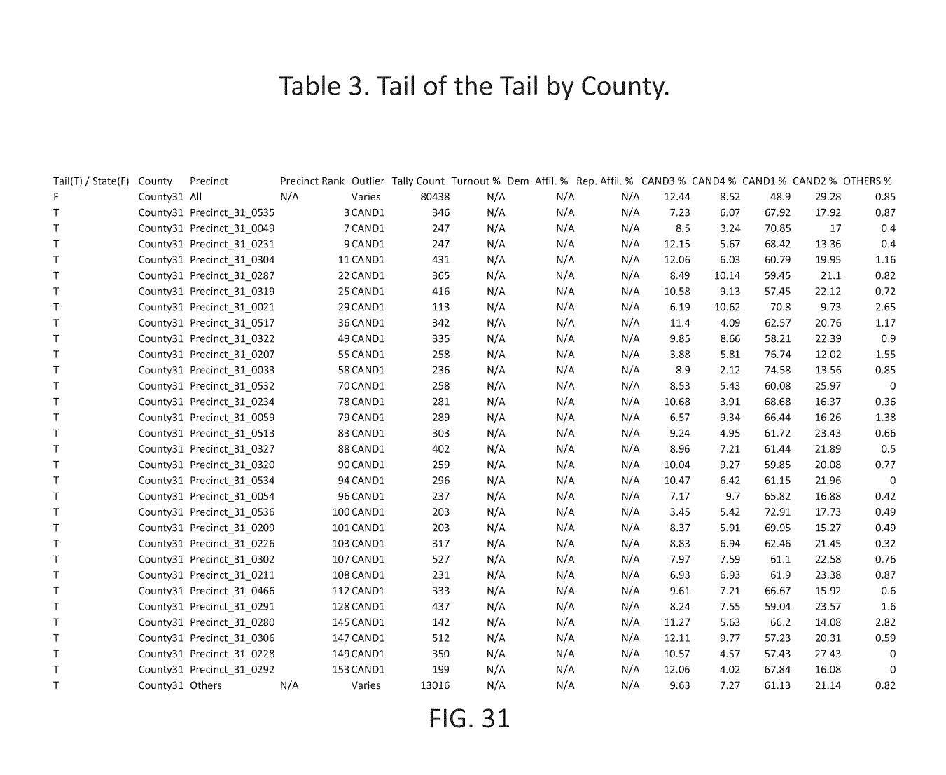

3) Table 3. (FIG. 31) Top most “unusual” precincts for the most suspicious counties. All of them come from the Tail only as well, and the rest of them from the same subset of the Tail are aggregated.

These tables may contain the following columns:
1) Boolean flag “Tail/State”: “true” for precinct (or aggregated precincts) from the Tail; “false” for the statewide statistics.
2) County Name: either precinct's county name or “All” for aggregated precincts or statewide statistics.
3) Precinct Name: precinct name or ID, or “All” for statewide statistics, or “Others” for aggregated precincts from the Tail.
4) Precinct Rank: a positive integer that starts from one with increments for each precinct. The lowest statewide rank indicates the most “unusual” result. The rank is “N/A” for statewide statistics and for aggregated precincts.
5. Election Choice Outlier Reason: the name of the election choice that caused this precinct to become an outlier. It has a value “Varies” for statewide statistics and for aggregated precincts.
6) Vote Tally Count.
7) Turnout % (if available).
8) Democratic Affiliation % (if available).
9) Republican Affiliation % (if available).
10) Election Choices Vote Percent, one column per each election choice. Some election choices may be aggregated into “Others”.

Each row with precinct statistics from the current election may be supplemented with one or more rows (or columns) that were used as benchmark(s) for this precinct results in the current election (both groups of benchmarks precincts and individually mapped precinct results). These benchmark subsets are defined above: statewide, countywide, subset of precinct of approximately the same size within the state, subset of precinct of approximately the same size within the precinct's county, pairwise results for the same precinct in the concurrent race, and pairwise results for the same precinct in the historical race. These benchmark rows may be interleaved with the current election results rows. Such interleaving of rows (or simply additional columns) will provide easily comparable numerical evidence of how each outlier precinct result deviates from the corresponding benchmark.

These tables complete the analysis of the aggregated election results. Note that this analysis may be performed dynamically on partial election results as well, as they keep arriving from various counties. This way the “red flags” may be detected in a timely manner, and the appropriate action may be taken before the tight deadline date that often follows the election date.

After the most suspicious election choices, counties, and precinct are identified, the subsequent analysis may require individual voters' records, and this method is discussed in the next section. The primary objective of this preliminary validation is to narrow down the field for the following steps.

Individual Voting Records data description and a Simple Way to detect anomalies: In the earlier sections, we determined whether some outliers benefit predominantly one election choice so that these outliers affect its ranking, and we identified the most counties that cause these outliers. In this section, we can focus our attention on these counties by analyzing individual voting records in them. The objective is to detect unusual voting patterns that lead to the change in ranking for the most suspicious election choice. First, let us describe the data set that we use for analysis.

For each county, we have a table of individual voting records of the same format. Each row contains voting history for one and only one uniquely identifiable registered voter in the county. For the purposes of our analysis, the uniqueness may be simply assured by a unique integer. Clearly, more detailed information (such as full name, date of birth, and address) would be helpful for cross-county and cross-state verification against illegal multiple voting, but this may be out of scope of our analysis. In addition to the column with unique voter's ID, we have an arbitrary number of columns for each election race.

We may have multiple election races for the same voter on the same election date. Each election race has a finite positive number of election choices. One of such choices for any election race for any voter may be “no vote cast”, which means that either this voter was unregistered at the time of the election, or he/she was registered, but did not vote in that particular election race. Although this data set may be statewide, its size may be enormous for analysis. Therefore, for practical purposes, we will use countywide data sets for our analysis of individual voting records (if the hardware system configuration affords processing huge statewide data set of individual voting records, it may be done as well).

In view of the data set described above, we can detect some non-typical voting patterns. For example, we may detect that one election choice won over the other because a substantial fraction of voters in a few precincts radically changed their political views in the current election. We may also detect that the same victory was also caused by a cluster of newly registered voters in another small set of precincts. We can statistically infer relations between political preferences, and then observe unusual historical patterns of these views in the voting history of some voters, who may have actually caused the suspicious victory. For example, if a voter cast his vote for a different party in this election than the party that he supported in the primaries of the same year, then it may look a bit suspicious. If the same voter recently supported an issue that is rarely supported by the party of his current choice, than his current vote may require even more attention. If the same voter is not alone in his precinct, then this anomaly reinforces our special attention to this cluster. Finally, if such voters change the ranking of an election choice relative to the other choices, then we need to continue our investigation.

All voters in the county may be sorted in the order of “suspiciousness”. The end of the list will contain voters with the most suspicious voting record. Technical details about sorting methodology will be described further hereinbelow. The voters are sorted by the voter ranking score first and then by the uniform random number as a second sorting criterion, if the ranking score is the same for multiple voters. The cumulative charts a constructed from these sorted sequences of voters. Similar cumulative charts for the precincts were described in the earlier section. The right segment of these charts will show whether these non-typical voters make a difference in the election choice ranking. The right tail of this chart may be cut-off for further analysis on the individual voter basis.

Before proceeding to describing the methodology, let us look at a real life case where this methodology may be directly applicable. Let us suppose that we have two rounds of primary election for two parties (“A” and “B”), when the second round (which happens three weeks after the original primary election date) is called a “run-off” election. Let us suppose that the law prohibits voting in the run-off election of party B, if this voter voted in the original primaries of party A, and vice versa. Clearly, most voters will not break this law, while we can detect the rest as voters with “non-typical” voting patterns. As an example, let us assume that party A had four election choices in the original primaries, including “no vote” (“A1”, “A2”, “A3”, and “no vote”). Similarly, we assume that party B had five election choices in the original primaries, including “no vote” (“B1”, “B2”, “B3”, “B4”, and “no vote”). Finally, we assume that party B had three election choices in the “run-off” primaries, including “no vote” (“B1”, “B2”, and “no vote”).

Individual Voting Records Analysis: Let us use the example from the previous section as a building block for the methodology. Each voter has one election choice from party “A” and party “B” original primaries and another election choice from party “B” “run-off” primaries. Any of these three election choices may be “no vote”. Let us assume that a voter voted for “A1” in party “A” original primaries, had “no vote” in party “B” original primaries, and for “B1” in the party “B” run-off primaries. Let us define two sets of voters:
1) Set X consists of the voters who voted for “A1” in party A original primaries;
2) Set Y consists of the voters who voted for “B1” in party B run-off primaries.

Let us create a union of sets X and Y, and an intersection of sets X and Y. Next, we count the number of voters in both the union and in the intersection. If candidates “A1” and “B1” are very popular in their respective parties, then the union may be relatively large. On the other hand, the intersection may be expected to be quite small, since it consists of only illegal votes during party B run-off election. We compute the ratio of the voter counts from the intersection divided by the voter counts from the union. Other voters have other combinations of election choices. Since we have four election choices in the party A original election and three choices in party B run-off election, the total number of ratios that we may need to compute for different voters is 12 (4 times 3). Before using ratios as voters' ranking scores, we apply another transformation to all of them. Note that these intermediate results are in the range from zero (exclusive) to one (inclusive). We need to take into account not only the degree of how non-typical each voter is, but also the power of our estimation. Thus, we raise our earlier computed ratio of intersection by the union to the power of another ratio, this time the ratio of the same union of voters count divided by the total number of voters in the entire county. The transformed score may be assigned to each voter, and then all voters are sorted by these scores in the decreasing order. The voters at the end for the sorted table with the smallest scores will contain the most non-typical historical voting records, which are likely to be mostly illegal in our case. Note that the secondary sorting criterion may be a uniformly distributed random number between zero and one, and it will randomly shuffle voters within subgroups of voters with the same ranking scores.

We have just described methodology of detecting the most non-typical voters from a history of just one extra election. We can apply the same methodology to the current election by combining it with another historical benchmark election. Since we will get another score in the range from zero to one, where the smallest numbers are assigned to the most non-typical voting record trace, we can combine these two scores for each voter by computing their geometric average and still using the same ranking criterion for the combined score. Similarly, we can process as many election pairs (the current with a historical election) as we have in our input data set, and then generate the final score as the geometric average of these intermediate scores. Note that each time the methodology will dynamically detect typical correlations between political preferences on different issues or about political candidates, and then it will single out the anomalous voting patterns. One of such patterns may be excessive support of an issue or a candidate among newly registered voters. Illegal voting pattern, like the one that we described earlier, will be detected as well, since they are non-typical (if the majority of votes are illegal, then even a random audit can detect it, and our methodology complements random audit in this sense). The methodology might produce false positives, i. e. assigning low scores to the voters with rare but legitimate historical voting patterns. But these individuals do not affect the ranking of election choices, unless they form sufficiently big clusters, which need to be explained or investigated further. In summary, the proposed methodology has the following strengths:
1) It advantageously searches voters with rare (or even illegal) historical voting patterns;
2) It advantageously takes into account the power of its conclusion as a fraction of voters who participated in the test relative to the total number of voters;
3) It advantageously takes into account the power of its conclusions as a geometric average of results from various historical elections;
4) It advantageously uses cumulative plots to show whether these voters with unusual voting patterns change the ranking of election choices in the results.
5) It advantageously lists these voters with the most unusual patterns in a sorted table, which highlights these patterns and uniquely identifies these voters either by anonymous ID, or even by name and address.

Method Validation: One way to validate the proposed method of election fraud detection may be to find reported instances of election fraud and observe how well they are detected by this method: are they in the Tail of the sequence of precincts, and how far from the end? But there may be another, more formal way to validate the method. This statistical technique will measure whether the concentration of fraud is statistically higher in the Tail than in the Head of the sorted sequence of precincts. We will measure this concentration with p-values from hypothesis test on the proportion of votes for the most suspicious election choice. The p-value will be computed from the post-audit random sample of individual votes. We will compare these p-values between the Head and the Tail. The smaller p-value will indicate higher probability of higher concentration of election fraud. The following is the description of the validation technique, supplemented with a hypothetical example. Let's define the following election reported results:
N_all: the statewide vote tally (e.g. 100,000);
N_tail: the vote tally in the Tail (e.g. 10,000);
N_head=N_all—N_tail: the vote tally in the Head (e.g. 90,000);
K_b_all: the statewide number of reported votes for the most suspicious election choice (e.g. 40,000); this election choice is the most likely “election fraud Beneficiary”, if fraud existed;
K_b_tail: the number of reported votes in the Tail for the most suspicious election choice (e.g. 6,000);
K_b_head=K_b_all−K_b_tail: the number of reported votes in the Head for the most suspicious election choice (e.g. 34,000);
P_b_all=K_b_all/N_all: statewide reported proportion of votes for the most suspicious election choice (e.g. 40%);
P_b_tail=K_b_tail/N_tail: reported proportion of votes in the Tail for the most suspicious election choice (e.g. 60%);
P_b_head=K_b_head/N_head: reported proportion of votes in the Head for the most suspicious election choice (e.g. 37.777777778%);

Let's draw a random sample from the statewide set of votes. The random seed for this drawing has to be set to a timestamp (including millisecond) of a future event that definitely happens soon after the election only once, for example the moment when the last county reports its results. Thus, there will be just one random sample per election. This random sample must be reused for validations of all variation of election fraud detection methods in use, and all results must be reported. The random sample will contain individual votes (not precincts) as observations. There is no strict requirement on the sample size, but the bigger it is the better. Additional comment on the sample size will follow. The random sample may be thoroughly audited for election fraud, but we do not provide details how this may be achieved, since it is outside of the scope. In the current settings, the following election fraud types may be detected in the sample: vote flipping (including flipping between election choices and ineligible ballots), ballot stuffing, and ineligible votes or voters. If we merely use votes cast as our statistical population, we will not detect vote dropping or denial of access to the polls or registration. These types of election fraud may be detected by the earlier proposed methodology, but they may be validated only if we switch to the population of all registered voters (for detecting vote dropping) or the population of all eligible to vote people in the state (for detecting denial of access to the polls or registration). But in these cases the audit of a sample will be hard or impossible, and thus we will stick to the vote tally only.

After we audited the random sample we will get presumably fraud-free vote counts within this refined sample. Some of these vote counts originate from the Tail. The original sample size may be large enough to assure that there are at least approximately 30 votes from the Tail in the refined sample. Let's define the following variables from the refined post-audit sample:
n_all: the size (in ballots cast) of the post-audit sample (e.g. 1000), which was refined from the original statewide random sample of votes; the size of the original sample was very likely different (in this example, from 1000), but it is irrelevant at this stage.
n_tail: the number of ballots in the subset of the refined post-audit sample; this subset is associated with the Tail (e.g. 100); note that 100 is bigger than 30, which is highly advisable.
n_head=n_all−n_tail: the number of ballots in the subset of the refined post-audit sample; this subset is associated with the Head (e.g. 900);
k_b_all: the number of votes for the most suspicious election choice from the refined post-audit sample (e.g. 390);
k_b_tail: the number of votes for the most suspicious election choice from the subset of refined post-audit sample (e.g. 55); this subset is associated with the Tail;
k_b_head=k_b_all−k_b_tail: the number of votes for the most suspicious election choice from the subset of refined post-audit sample (e.g. 335); this subset is associated with the Head;
p_b_all=kb_all/n_all: the proportion of votes for the most suspicious election choice in the refined post-audit sample (e.g. 39%);
p_b_tail=k_b_tail/n_tail: the proportion of votes for the most suspicious election choice in the subset of the refined post-audit sample (e.g. 55%); this subset is associated with the Tail;
p_b_head=k_b_head/n_head: the proportion of votes for the most suspicious election choice in the subset of the refined post-audit sample (e.g. 37.222222222%); this subset is associated with the Head;

The expected value of “p_b_all” is the true statewide proportion of votes for the most suspicious election choice. Without election fraud, this true proportion must be the same as the reported proportion “P_b_all”. Clearly, the audited random sample proportion “p_b_all” may deviate from the true statewide proportion. This is applicable not only on the statewide level, but also within the Tail and the Head separately. Let's estimate these deviations (SQRT stands for square root function):
STD(p_b_all)=SQRT((1/n_all)*p_b_all*(1−p_b_all)*(N_all−n_all)/(N_all−1)): standard deviation of the audited sample estimate of the true statewide proportion of votes for the most suspicious election choice (e.g. 1.5347%);
STD(p_b_tail)=SQRT((1/n_tail)*p_b_tail*(1−p_b_tail)*(N_tail−n_tail)/(N_tail−1)): standard deviation of the Tail subset of audited sample estimate of the true Tail proportion of votes for the most suspicious election choice (e.g. 4.9502%);
STD(p_b_head)=SQRT((1/n_head)*p_b_head*(1−p_b_head)*(N_head−n_head)/(N_head−1)): standard deviation of the Head subset of audited sample estimate of the true Head proportion of votes for the most suspicious election choice (e.g. 1.6033%);

Now we are ready to compute p-values for the reported proportions relative to true proportions, which are estimated from the sample:
CDF_all=NormalCDF(x=“P_b_all”, mean=“p_b_all”, standard deviation=STD(“p_b_all”)): cumulative distribution function for Normal distribution for the statewide proportion.
CDF_tail=NormalCDF(x=“P_b_tail”, mean=“p_b_tail”, standard deviation=STD(“p_b_tail”)): cumulative distribution function for Normal distribution for the statewide proportion in the Tail.
CDF_head=NormalCDF(x=“P_b_head”, mean=“p_b_head”, standard deviation=STD(“p_b_head”)): cumulative distribution function for Normal distribution for the proportion in the Head.
If “P_b_all”<“p_b_all”, then p-value is “CDF_all”, else it is (1−“CDF_all”). In our example, the statewide p-value is 25.7329%.

If “P_b_tail”<“p_b_tail”, then p-value is “CDF_tail”, else it is (1−“CDF_tail”). In our example, the Tail p-value is 15.6236%.
If “P_b_head”<“p_b_head”, then p-value is “CDF_head”, else it is (1−“CDF_head”). In our example, the Head p-value is 36.4477%.

If the Tail p-value is smaller than the Head p-value (which is the case in our hypothetical example: 15.6236%<36.4477%), then we can statistically infer that the Tail has higher concentration of election fraud, then the Head. In this case, this observation shows that our method facilitates in election fraud detection. Let's assume that we decided to test the null-hypothesis whether election fraud invalidates election results, i.e. reported proportion (e.g. 40%) is statistically different from the one in the audited sample (39%). Let's assume that the two-tail significance level Alpha=5%, and we want to ensure that our estimates of “p_b_all” must be within “eps_all”=40%-39%=1% from the true proportion. Then we can estimate the minimal sample size for this purpose:
Z_two_side(1−Alpha)=Normal_CDF_lnverse(probability=1−Alpha/2, mean=0, standard deviation=1)=1.959963985: Z-score for two-tail hypothesis test;
p_hat=50%: the most conservative estimate of the true proportion to ensure that the sample size is large enough; we could have set “p_hat” to 40% as well, and the required minimal size would be smaller;
m_all_req=Z_two_side*Z_two_side*p_hat*(1−p_hat)/(eps_all*eps_all): the minimal sample size without correction for small finite population (e.g. 9603.6471);
n_all_req=CEILING(m_all_req/(1+(m_all_req−1)/N_all)): the minimal sample size with correction for small finite population (e.g. 8763);

For the purposes of method validation, we have used a much smaller sample of size 1000, instead of 8763. This is acceptable and easier to implement, since we did not have a goal to reject the null hypothesis with small p-values, but we just compared even relatively large p-values between the Tail and the Head. This comparison of p-values may be done by dividing them by each other and comparing the ratio with one.

If we get multiple Head-Tail pairs of p-values to compare across multiple elections or earlier proposed sub-methods, then we can compare p-value geometric averages from the Tails against corresponding p-value geometric averages from the Heads.

### APPENDICES

### Appendix 1

C#code for Hypergeometric Cumulative Distribution Function. using System;

### Appendix 2

C#code with examples of Hypergeometric Cumulative Distribution Function Usage.

```
using System;
namespace TestHypergeometricCdfAccuracy″
{
  class Program
  {
    // Inputs:
    // k: number of successes in the draws without replacement; 0<=k<=n
    // n: number of trials/draws; 1 <= n <= N
    // K: number of successes in the population; 0 <= K <= N.
    // N: population size; 1 <= N.
    // if bLeftSide == true, then F(x <= k; n, K, N):
    // probability of drawing at most ″k″ successes in ″n″ trials.
    // if bLeftSide == false, then F(x >= k; n, K, N):
    // probability of drawing at least ″k″ successes in ″n″ trials.
    // bIsExact: indicates whether Hypergeometric CDF could have been
    // potentially approximated with Normal CDF
    // bOutIsOnePlusResult: if true, then CDF = 1 + result_hypergeom,
    // else CDF = 0 + result_hypergeom
    // ICdfElapsedMillisecs: time to compute CDF in milliseconds.
    private static void process_result(int k, int n, int K, int N,
    bool bIsLeftSide, bool bIsExact, bool bOutIsOnePlusResult,
    double result_hypergeom, long ICdfElapsedMillisecs)
    {
      // infinitesimal positive real number: 0.0 <= eps <= 0.5
      double dAbsEpsilon = System.Math.Abs(0.000001);
      bool bIsOutlier;
      System.Console.WriteLine((bIsExact ? ″Exact″ : ″Approx.″) +
      ″ Hypergeom. ″ + (bIsLeftSide ? ″L. CDF(k<=″ : ″R. CDF(k>=″) + k.ToString( ) +
      ″, n=″ + n.ToString( ) + ″, K=″ + K.ToString( ) + ″, N=″ + N.ToString( ) + ″) = ″);
      if (!bOutIsOnePlusResult) // result is added to zero
      {
        System.Console.Write(″0 + ″ + result_hypergeom.ToString( ) +
        ″= ″ + result_hypergeom.ToString( ) + ″;″);
        if (result_hypergeom < 0.5)
          bIsOutlier = (result_hypergeom < dAbsEpsilon);
        // high precision
        else
          bIsOutlier = ((1.0 - result_hypergeom) < dAbsEpsilon);
        // low precision
      }
      else // result is added to one
      {
        System.Console.Write(″1 + ″ + result_hypergeom.ToString( ) +
        ″ = ″ + (1.0 + result_hypergeom).ToString( ) + ″;″);
        if (result_hypergeom > -0.5)
          bIsOutlier = (-result_hypergeom < dAbsEpsilon);
        // high precision
        else
          bIsOutlier = ((1.0 + result_hypergeom) < dAbsEpsilon);
        // low precision
      }
      //System.Console.Write((bIsOutlier ? ″ Outlier″ : ″ Not Outlier″) +
      // ″ for Eps. = ″ + dAbsEpsilon.ToString( ) + ″;″);
      System.Console.WriteLine(″ Time; ″ + ICdfElapsedMillisecs.ToString( ) + ″ ms.″);
    }
    // Inputs:
    // k: number of successes in the draws without replacement; 0 <= k <= n
    // n: number of trials/draws; 1 <= n <= N
    // K: number of successes in the population; 0 <= K <= N.
    // N: population size; 1 <= N.
    // If bLeftSide == true, then F(x <= k; n, K, N):
    // probability of drawing at most ″k″ successes in ″n″ trials.
    // If bLeftSide == false, then F(x >= k; n, K, N):
    // probability of drawing at least ″k″ successes in ″n″ trials.
    private static void test_hypergeometric_cdf(int k, int n, int K, int N,
    bool bIsLeftSide)
    {
      double p = (double)(K) / (double)(N); // probability of success
      double q = 1 - p; // probability of failure
      double mu = (double)n * p;
      double sigma = System.Math.Sqrt((double)n * p * q);
      System.Diagnostics.Stopwatch stopwatch = new
System.Diagnostics.Stopwatch( );
      int iNumTrials = 10000;
      double result_hypergeom_sim = Hypergeometric.cdf_hypergeometric_simulate(
      k, n, K, N, iNumTrials, bIsLeftSide);
      System.Console.WriteLine(″Sim. Hypergeom. ″ +
      (bIsLeftSide ? ″L. CDF(k<=″ : ″R. CDF(k>=″) + k.ToString( ) +
      ″, n=″ + n.ToString( ) + ″, K=″ + K.ToString( ) + ″, N=″ + N.ToString( ) + ″) = ″);
      System.Console.WriteLine(result_hypergeom_sim.ToString( ) + ″;″ +
      ″ Num. of Trials: ″ + iNumTrials.ToString( ) + ″.″);
      stopwatch. Restart( );
      bool bOutIsOnePlusResultHyperDbl;
      stopwatch.Restart( );
      double result_hypergeom_num_dbl =
Hypergeometric.cdf_hypergeometric_num_dbl(
      k, n, K, N, bIsLeftSide, out bOutIsOnePlusResultHyperDbl);
      stopwatch.Stop( );
      long ICdfNumHypergeomDblElapsedMillisecs = stopwatch.ElapsedMilliseconds;
      System.Console.WriteLine(″Num. Hypergeom. Dbl. ″ +
      (bIsLeftSide ? ″L. CDF(k<=″ : ″R. CDF(k>=″) + k.ToString( ) +
      ″, n=″ + n.ToString( ) + ″, K=″ + K.ToString( ) + ″, N=″ + N.ToString( ) + ″) = ″);
      System.Console.WriteLine((bOutIsOnePlusResultHyperDbl ? ″1″ : ″0″) +
      ″ + ″ + result_hypergeom_num_dbl.ToString( ) +
      ″ = ″ + ((bOutIsOnePlusResultHyperDbl ? 1 : 0) +
      result_hypergeom_num_dbl).ToString( ) + ″;″ +
      ″ Time: ″+ ICdfNumHypergeomDblElapsedMillisecs.ToString( ) + ″ ms.″);
      stopwatch.Restart( );
      double result_normal = Hypergeometric.cdf_normal(k, n, K, N, bIsLeftSide);
      stopwatch.Stop( );
      long ICdfNormElapsedMillisecs = stopwatch.ElapsedMilliseconds;
      if (bIsLeftSide)
      System.Console.Write(″Normal L. CDF(k<=″ + (k + 0.5).ToString( ));
      else
      System.Console.Write(″Normal R. CDF(k>=″ + (k - 0.5).ToString( ));
      // mu = n*K/N; sigma = (n*K/N*(1-K/N))\hat{ }0.5;
      System.Console.WriteLine(″, mu=″ + mu.ToString( ) + ″, sigma=″ +
sigma.ToString( ) + ″)=″);
      System.Console.WriteLine(result_normal.ToString( ) + ″;″ +
      ″ Time: ″ + ICdfNormElapsedMillisecs.ToString( ) + ″ ms.″);
      bool bOutIsOnePlusResultNormDbl;
      stopwatch.Restart( );
      double result_normal_dbl = Hypergeometric.cdf_normal_dbl(k, n, K N,
      bIsLeftSide, out bOutIsOnePlusResultNormDbl);
      stopwatch.Stop( );
      long ICdfNormDblElapsedMillisecs = stopwatch.ElapsedMilliseconds;
      if (bIsLeftSide)
        System.Console.Write(″Normal Dbl. L. CDF(k<=″ + (k + 0.5).ToString( ));
      else
        System.Console.Write(″Normal Dbl. R. CDF(k>=″ + (k - 0.5).ToString( ));
      // mu = n*K/N; sigma = (n*K/N*(1-K/N))\hat{ }0.5;
      System.Console.WriteLine(″ , mu=″ + mu.ToString( ) +
      ″, sigma=″ + sigma.ToString( ) + ″) = ″);
      System.Console.WriteLine((bOutIsOnePlusResultNormDbl ? ″1″ : ″0″) + ″ + ″ +
      result_normal_dbl.ToString( ) + ″ = ″ + ((bOutIsOnePlusResultNormDbl ? 1 : 0) +
      result_normal_dbl).ToString( ) + ″;″ +
      ″ Time; ″ + ICdfNormDblElapsedMillisecs.ToString( ) + ″ ms.″);
      // If bOutIsOnePlusResult = true, then CDF = 1.0 + ″result″,
      // else CDF = 0 + ″result″
      // This is done to preserve precision.
      bool bOutIsOnePlusResultHypExct;
      stopwatch.Restart( );
      double result_hypergeom_exact = Hypergeometric.cdf_hypergeometric_exact(
      k, n, K, N, bIsLeftSide, out bOutIsOnePlusResultHypExct);
      stopwatch.Stop( );
      long ICdfExactHypergeomElapsedMillisecs = stopwatch.ElapsedMilliseconds;
      process_result(k, n, K, N, bIsLeftSide, true, bOutIsOnePlusResultHypExct,
      result_hypergeom_exact, ICdfExactHypergeomElapsedMillisecs);
      bool bOutIsOnePlusResultHypAppr;
      stopwatch.Restart( );
      double result_hypergeom_approx =
Hypergeometric.cdf_hypergeometric_approx(
      k, n, K, N, bIsLeftSide, 1000000000, out bOutIsOnePlusResultHypAppr);
      stopwatch.Stop( );
      long ICdfApproxHypergeomElapsedMillisecs = stopwatch.ElapsedMilliseconds;
      process_result(k, n, K, N, bIsLeftSide, false, bOutIsOnePlusResultHypAppr,
      result_hypergeom_approx, ICdfApproxHypergeomElapsedMillisecs);
      System.Console.WriteLine( );
    }
    static void Main( )
    {
      test_hypergeometric_cdf(0, 1000, 400000, 1000000, true);
      test_hypergeometric_cdf(1, 1000, 400000, 1000000, true);
      test_hypergeometric_cdf(400, 1000, 400000, 1000000, true);
      test_hypergeometric_cdf(400, 1000, 400000, 1000000, false);
      test_hypergeometric_cdf(930, 1000, 400000, 1000000, true);
      test_hypergeometric_cdf(930, 1000, 400000, 1000000, false);
      test_hypergeometric_cdf(929, 1000, 400000, 1000000, true);
      test_hypergeometric_cdf(931, 1000, 400000, 1000000, false);
      System.Console.ReadKey( );
    }
  }
}
```

### Appendix #3

Console Output from C#implementation of Hypergeometric Cumulative Distribution Function Usage.

Sim. Hypergeom. L. CDF(k<=0, n=1000, K=400000, N=1000000)=0; Num. of Trials: 10000.
Num. Hypergeom. Dbl. L. CDF(k<=0, n=1000, K=400000, N=1000000)=0+1.01508334801765E-222=1.01508334801765E-222; Time: 0 ms.
Normal L. CDF(k<=0.5, mu=400, sigma=15.4919333848297)=0; Time: 0 ms.
Normal Dbl. L. CDF(k<=0.5, mu=400, sigma=15.4919333848297)=0+6.10529760868578E-147=6.10529760868578E-147; Time: 0 ms.
Exact Hypergeom. L. CDF(k<=0, n=1000, K=400000, N=1000000)=0+1.0150833470957E-222=1.0150833470957E-222; Time: 44 ms.
Approx. Hypergeom. L. CDF(k<=0, n=1000, K=400000, N=1000000)=0+1.01508334801765E-222=1.01508334801765E-222; Time: 0 ms.
Sim. Hypergeom. L. CDF(k<=1, n=1000, K=400000, N=1000000)=0; Num. of Trials: 10000.
Num. Hypergeom. Dbl. L. CDF(k<=1, n=1000, K=400000, N=1000000)=0+6.78865936797889E-220=6.78865936797889E-220; Time: 0 ms.
Normal L. CDF(k<=1.5, mu=400, sigma=15.4919333848297)=0; Time: 0 ms.
Normal Dbl. L. CDF(k<=1.5, mu=400, sigma=15.4919333848297)=0+3.22705684544305E-146=3.22705684544305E-146; Time: 0 ms.
Exact Hypergeom. L. CDF(k<=1, n=1000, K=400000, N=1000000)=0+6.7886593641457E-220=6.7886593641457E-220; Time: 86 ms.
Approx. Hypergeom. L. CDF(k<=1, n=1000, K=400000, N=1000000)=0+6.78865936797889E-220=6.78865936797889E-220; Time: 0 ms.
Sim. Hypergeom. L. CDF(k<=400, n=1000, K=400000, N=1000000)=0.5085; Num. of Trials: 10000.
Num. Hypergeom. Dbl. L. CDF(k<=400, n=1000, K=400000, N=1000000)=0+0.513735012161896=0.513735012161896; Time: 0 ms.
Normal L. CDF(k<=400.5, mu=400, sigma=15.4919333848297)=0.512873571700228; Time: 0 ms.
Normal Dbl. L. CDF(k<=400.5, mu=400, sigma=15.4919333848297)=1+−0.487126428299772=0.512873571700228; Time: 0 ms.
Exact Hypergeom. L. CDF(k<=400, n=1000, K=400000, N=1000000)=1+−0.486264988456921=0.513735011543079; Time: 16258 ms.
Approx. Hypergeom. L. CDF(k<=400, n=1000, K=400000, N=1000000)=0+0.513735012161896=0.513735012161896; Time: 0 ms.
Sim. Hypergeom. R. CDF(k>=400, n=1000, K=400000, N=1000000)=0.5123; Num. of Trials: 10000.
Num. Hypergeom. Dbl. R. CDF(k>=400, n=1000, K=400000, N=1000000)=1+−0.487977311292077=0.512022688707923; Time: 0 ms.
Normal R. CDF(k>=399.5, mu=400, sigma=15.4919333848297)=0.512873571700228; Time: 0 ms.
Normal Dbl. R. CDF(k>=399.5, mu=400, sigma=15.4919333848297)=1+−0.487126428299772=0.512873571700228; Time: 0 ms.
Exact Hypergeom. R. CDF(k>=400, n=1000, K=400000, N=1000000)=1+−0.487977310676732=0.512022689323268; Time: 24298 ms.
Approx. Hypergeom. R. CDF(k>=400, n=1000, K=400000, N=1000000)=1+−0.487977311292077=0.512022688707923; Time: 0 ms.
Sim. Hypergeom. L. CDF(k<=930, n=1000, K=400000, N=1000000)=1; Num. of Trials: 10000.
Num. Hypergeom. Dbl. L. CDF(k<=930, n=1000, K=400000, N=1000000)=1+−5.02173136052967E-279=1; Time: 0 ms.
Normal L. CDF(k<=930.5, mu=400, sigma=15.4919333848297)=1; Time: 0 ms.
Normal Dbl. L. CDF(k<=930.5, mu=400, sigma=15.4919333848297)=1+−2.71300821115275E-257=1; Time: 0 ms.
Exact Hypergeom. L. CDF(k<=930, n=1000, K=400000, N=1000000)=1+−5.02173135812962E-279=1; Time: 2965 ms.
Approx. Hypergeom. L. CDF(k<=930, n=1000, K=400000, N=1000000)=1+−5.02173136052967E-279=1; Time: 0 ms.
Sim. Hypergeom. R. CDF(k>=930, n=1000, K=400000, N=1000000)=0; Num. of Trials: 10000.
Num. Hypergeom. Dbl. R. CDF(k>=930, n=1000, K=400000, N=1000000)=0+1.00486509377353E-277=1.00486509377353E-277; Time: 0 ms.
Normal R. CDF(k>=929.5, mu=400, sigma=15.4919333848297)=0; Time: 0 ms.
Normal Dbl. R. CDF(k>=929.5, mu=400, sigma=15.4919333848297)=0+2.47363785565014E-256=2.47363785565014E-256; Time: 0 ms.
Exact Hypergeom. R. CDF(k>=930, n=1000, K=400000, N=1000000)=0+1.00486509333641 E-277=1.00486509333641 E-277; Time: 3019 ms.
Approx. Hypergeom. R. CDF(k>=930, n=1000, K=400000, N=1000000)=0+1.00486509377353E-277=1.00486509377353E-277; Time: 0 ms.
Sim. Hypergeom. L. CDF(k<=929, n=1000, K=400000, N=1000000)=1; Num. of Trials: 10000.
Num. Hypergeom. Dbl. L. CDF(k<=929, n=1000, K=400000, N=1000000)=1+−1.00486509377353E-277=1; Time: 0 ms.
Normal L. CDF(k<=929.5, mu=400, sigma=15.4919333848297)=1; Time: 0 ms.
Normal Dbl. L. CDF(k<=929.5, mu=400, sigma=15.4919333848297)=1+−2.47363785565014E-256=1; Time: 0 ms.
Exact Hypergeom. L. CDF(k<=929, n=1000, K=400000, N=1000000)=1+−1.00486509333641 E-277=1; Time: 3047 ms.
Approx. Hypergeom. L. CDF(k<=929, n=1000, K=400000, N=1000000)=1+−1.00486509377353E-277=1; Time: 0 ms.
Sim. Hypergeom. R. CDF(k>=931, n=1000, K=400000, N=1000000)=0; Num. of Trials: 10000.
Num. Hypergeom. Dbl. R. CDF(k>=931, n=1000, K=400000, N=1000000)=0+5.02173136052967E-279=5.02173136052967E-279; Time: 0 ms.
Normal R. CDF(k>=930.5, mu=400, sigma=15.4919333848297)=0; Time: 0 ms.
Normal Dbl. R. CDF(k>=930.5, mu=400, sigma=15.4919333848297)=0+2.71300821115275E-257=2.71300821115275E-257; Time: 0 ms.
Exact Hypergeom. R. CDF(k>=931, n=1000, K=400000, N=1000000)=0+5.02173135812962E-279=5.02173135812962E-279; Time: 2861 ms.
Approx. Hypergeom. R. CDF(k>=931, n=1000, K=400000, N=1000000)=0+5.02173136052967E-279=5.02173136052967E-279; Time: 0 ms.

Conclusions: We have presented various methods of detecting potential election fraud in the election results. These methodologies have been implemented as a software product, and the candidates, election divisions of the responsible government entities, and voting integrity groups may use them for election results validations and certifications. All of these methods are unbiased to any election choice, county, precinct, or individual voter. All of them detect unusual and non-typical patterns in the election results that have concentrated effect on the ranking of election choices. The basic principles of these methods is that political preferences may change over time, geographically, and within various subsets of voters, but extreme, concentrated, and unusual changes and clusters may be detected and must be monitored, audited, and explained. One of the main advantages of this method is that it may be applied to both incomplete/small and full/large data sets. Another advantage is that this method does not require any internal change is the election process or vote counting, but it merely needs data with election results.

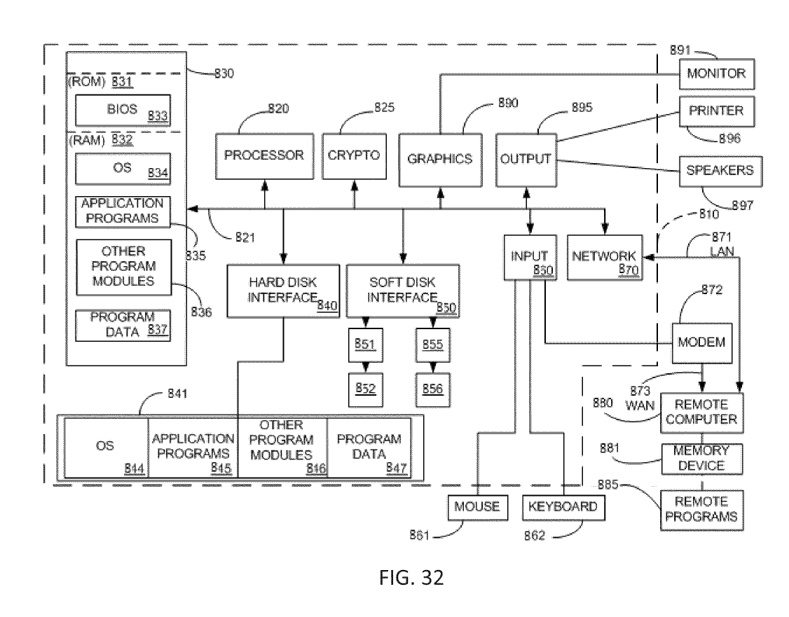

A skilled artisan will note that one or more of the aspects of the present invention may be performed on a computing device, including mobile devices. The skilled artisan will also note that a computing device may be understood to be any device having a processor, memory unit, input, and output. This may include, but is not intended to be limited to, cellular phones, smart phones, tablet personal computers (PCs), laptop computers, desktop computers, personal digital assistants (PDAs), etc. FIG. 32 illustrates a model computing device in the form of a computer 610, which is capable of performing one or more computer-implemented steps in practicing the method aspects of the present invention. Components of the computer 610 may include, but are not limited to, a processing unit 620, a system memory 630, and a system bus 621 that couples various system components including the system memory to the processing unit 620. The system bus 621 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI).

The computer 610 may also include a cryptographic unit 625. Briefly, the cryptographic unit 625 has a calculation function that may be used to verify digital signatures, calculate hashes, digitally sign hash values, and encrypt or decrypt data. The cryptographic unit 625 may also have a protected memory for storing keys and other secret data. In other embodiments, the functions of the cryptographic unit may be instantiated in software and run via the operating system.

A computer 610 typically includes a variety of computer readable media. Computer readable media can be any available media that can be accessed by a computer 610 and includes both volatile and nonvolatile media, removable and non-removable media. By way of example, and not limitation, computer readable media may include computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, FLASH memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by a computer 610. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared and other wireless media. Combinations of any of the above should also be included within the scope of computer readable media.

The system memory 630 includes computer storage media in the form of volatile and/or nonvolatile memory such as read only memory (ROM) 631 and random access memory (RAM) 632. A basic input/output system 633 (BIOS), containing the basic routines that help to transfer information between elements within computer 610, such as during start-up, is typically stored in ROM 631. RAM 632 typically contains data and/or program modules that are immediately accessible to and/or presently being operated on by processing unit 620. By way of example, and not limitation, FIG. 32 illustrates an operating system (OS) 634, application programs 635, other program modules 636, and program data 637.

The computer 610 may also include other removable/non-removable, volatile/nonvolatile computer storage media. By way of example only, FIG. 32 illustrates a hard disk drive 641 that reads from or writes to non-removable, nonvolatile magnetic media, a magnetic disk drive 651 that reads from or writes to a removable, nonvolatile magnetic disk 652, and an optical disk drive 655 that reads from or writes to a removable, nonvolatile optical disk 656 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 641 is typically connected to the system bus 621 through a non-removable memory interface such as interface 640, and magnetic disk drive 651 and optical disk drive 655 are typically connected to the system bus 621 by a removable memory interface, such as interface 650.

The drives, and their associated computer storage media discussed above and illustrated in FIG. 32, provide storage of computer readable instructions, data structures, program modules and other data for the computer 610. In FIG. 32, for example, hard disk drive 641 is illustrated as storing an OS 644, application programs 645, other program modules 646, and program data 647. Note that these components can either be the same as or different from OS 634, application programs 635, other program modules 636, and program data 637. The OS 644, application programs 645, other program modules 646, and program data 647 are given different numbers here to illustrate that, at a minimum, they may be different copies. A user may enter commands and information into the computer 610 through input devices such as a keyboard 662 and cursor control device 661, commonly referred to as a mouse, trackball or touch pad. Other input devices (not shown) may include a microphone, joystick, game pad, satellite dish, scanner, or the like. These and other input devices are often connected to the processing unit 620 through a user input interface 660 that is coupled to the system bus, but may be connected by other interface and bus structures, such as a parallel port, game port or a universal serial bus (USB). A monitor 691 or other type of display device is also connected to the system bus 621 via an interface, such as a graphics controller 690. In addition to the monitor, computers may also include other peripheral output devices such as speakers 697 and printer 696, which may be connected through an output peripheral interface 695.

The computer 610 may operate in a networked environment using logical connections to one or more remote computers, such as a remote computer 680. The remote computer 680 may be a personal computer, a server, a router, a network PC, a peer device or other common network node, and typically includes many or all of the elements described above relative to the computer 610, although only a memory storage device 681 has been illustrated in FIG. 32. The logical connections depicted in FIG. 32 include a local area network (LAN) 671 and a wide area network (WAN) 673, but may also include other networks. Such networking environments are commonplace in offices, enterprise-wide computer networks, intranets and the Internet.

When used in a LAN networking environment, the computer 610 is connected to the LAN 671 through a network interface or adapter 670. When used in a WAN networking environment, the computer 610 typically includes a modem 672 or other means for establishing communications over the WAN 673, such as the Internet. The modem 672, which may be internal or external, may be connected to the system bus 621 via the user input interface 660, or other appropriate mechanism. In a networked environment, program modules depicted relative to the computer 610, or portions thereof, may be stored in the remote memory storage device. By way of example, and not limitation, FIG. 32 illustrates remote application programs 685 as residing on memory device 681.

The communications connections 670 and 672 allow the device to communicate with other devices. The communications connections 670 and 672 are an example of communication media. The communication media typically embodies computer readable instructions, data structures, program modules or other data in a modulated data signal such as a carrier wave or other transport mechanism and includes any information delivery media. A “modulated data signal” may be a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Computer readable media may include both storage media and communication media.

In accordance with embodiments of the present invention, the components, process steps, and/or data structures may be implemented using various types of operating systems, computing platforms, computer programs, and/or general purpose machines. In addition, after having the benefit of this disclosure, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein.

The computer program, according to an embodiment of the present invention, is a computerized system that requires the performance of one or more steps to be performed on or in association with a computerized device, such as, but not limited to, a server, a computer (i.e., desktop computer, laptop computer, netbook, or any machine having a processor), a dumb terminal that provides an interface with a computer or server, a personal digital assistant, mobile communications device, such as an cell phone, smart phone, or other similar device that provides computer or quasi-computer functionality, a mobile reader, such as an electronic document viewer, which provides reader functionality that may be enabled, through either internal components or connecting to an external computer, server, or global communications network (such as the Internet), to take direction from or engage in processes which are then delivered to the mobile reader. It may be readily apparent to those of skill in the art, after reviewing the materials disclosed herein, that other types of devices, individually or in conjunction with an overarching architecture, associated with an internal or external system, may be utilized to provide the “computerized” environment necessary for the at least one process step to be carried out in a machine/system/digital environment. It may be noted that the method aspects of the present invention are preferably computer-implemented methods and, more particularly, at least one step is preferably carried out using a computerized device.

While the above description contains much specificity, these should not be construed as limitations on the scope of any embodiment, but as exemplifications of the presented embodiments thereof. Many other ramifications and variations are possible within the teachings of the various embodiments. While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include all embodiments falling within the description of the invention. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

Thus the scope of the invention should be determined by the appended claims and their legal equivalents, and not by the examples given.

That which is claimed is:

1. A computer program product embodied in a non-transitory computer-readable storage medium for detecting non-negligible election fraud, and comprising:
a fraud detection server comprising a processor, a database, and a plurality of subsystems including data management subsystem, a data analysis subsystem, and data reporting subsystem;
wherein the data management subsystem is configured to
receive election results data, and
aggregate the election results data into a plurality of subsets;
wherein the data analysis subsystem is configured to
calculate a respective hypergeometric cumulative distribution function (CDF) score to define an outlier impact magnitude for each of the plurality of subsets, and
rank the plurality of subsets using the respective hypergeometric CDF score for each of the plurality of subsets, to define an audit priority;
wherein the data reporting subsystem is configured to create an election report including the audit priority.

2. The computer program product according to claim 1 wherein the election results data further comprises a vote count.

3. The computer program product according to claim 2 wherein the election results data further comprises at least one of a results disclosure time, a results revision time, and a missing data set indicator.

4. The computer program product according to claim 1 wherein the plurality of subsystems further includes an access control subsystem comprising an interface; wherein the access control subsystem is configured to
receive, using the interface, a computer program product access request, and
match the computer program product access request to an election analyst registration stored in the database, and
operate at least one of the plurality of subsystems to include enforcing role-based permissions associated with the election analyst registration and selected from the group consisting of an analyst role.

5. The computer program product according to claim 1 further comprising an election analyst client configured in data communication with the fraud detection server via a network; wherein the election analyst client is further configured to transmit the election results data to the fraud detection server.

6. The computer program product according to claim 1 wherein the access control subsystem is further configured to receive an election audit access request, to match the election audit access request to a user registration stored in the database, and to enforce role-based permissions associated with the user registration and selected from the group consisting of an official role, a partisan role, and a non-partisan role.

7. The computer program product according to claim 1 further comprising a user client configured in data communication with the fraud detection server via a network; wherein the user client is configured to display the election report.

8. The computer program product according to claim 1 wherein the election results data further comprises political party data selected from the group consisting of an internal poll date, an internal poll sample size, and an internal poll result.

9. The computer program product according to claim 1 wherein the election results data further comprises government pre-election data selected from the group consisting of a voter registration count, a party affiliation count, and a redistricting rule.

10. The computer program product according to claim 1 wherein the election results data further comprises demographic data selected from the group consisting of a vote-eligible population, a population density, a geographic area, a geographic location, a land area, a voting equipment configuration, and a redistricting impact.

11. A method for detecting non-negligible election fraud using a computer program product that includes a fraud detection server comprising a processor, a database, and a plurality of subsystems including a data management subsystem, a data analysis subsystem, and a data reporting subsystem, the method comprising:
receiving, using the data management subsystem, election results data;
aggregating, using the data analysis subsystem, the election results data into a plurality of subsets;
calculating, using the data analysis subsystem, a respective hypergeometric cumulative distribution function (CDF) score to define an outlier impact magnitude for each of the plurality of subsets;
ranking, using the data analysis subsystem, the plurality of subsets using the respective hypergeometric CDF score for each of the plurality of subsets, to collectively define an audit priority;
displaying, using the reporting subsystem, an election report including the audit priority.

12. The method according to claim 11 wherein the election results data further comprises a vote count.

13. The method according to claim 12 wherein the election results data further comprises at least one of a results disclosure time, a results revision time, and a missing data set indicator.

14. The method according to claim 11 wherein the plurality of subsystems further includes an access control subsystem comprising an interface; and the method further comprising:
receiving, using the access control subsystem, a computer program product access request,
matching, using the access control subsystem, the computer program product access request to an election analyst registration stored in the database, and
operating at least one of the plurality of subsystems to include
enforcing, using the access control subsystem, role-based permissions associated with the election analyst registration and selected from the group consisting of a an analyst role.

15. The method according to claim 11 wherein the computer program product further comprises a user client configured in data communication with the fraud detection server via a network; and wherein displaying the election report further comprises generating a graphical representation of the audit priority to the user client.

16. The method according to claim 11 wherein the election results data further comprises political party data selected from the group consisting of an internal poll date, an internal poll sample size, and an internal poll result.

17. The method according to claim 11 wherein the election results data further comprises government pre-election data selected from the group consisting of a voter registration count, a party affiliation count, and a redistricting rule.

18. The method according to claim 11 wherein the election results data further comprises demographic data selected from the group consisting of a vote-eligible population, a population density, a geographic area, a geographic location, a land area, a voting equipment configuration, and a redistricting impact.

19. A computer-implemented method for detecting non-negligible election fraud using a computer program product that includes a fraud detection server comprising a processor and a database, the method comprising:
receiving election results data;
aggregating the election results data into a plurality of subsets;
calculating a respective hypergeometric cumulative distribution function (CDF) score to define an outlier impact magnitude for each of the plurality of subsets;
ranking the plurality of subsets using the respective hypergeometric CDF score for each of the plurality of subsets, to collectively define an audit priority;
displaying an election report including the audit priority.

20. The method according to claim 19 wherein the election results data further comprises a vote count.
